(19) United States
(12) Patent Application Publication
(10) Pub. No.: US 2025/0026768 A1
(43) Pub. Date: Jan. 23, 2025

(54) METHOD FOR THE SYNTHESIS OF AXIALLY CHIRAL ORGANOBORON COMPOUNDS

(71) Applicant: Laboratory for Synthetic Chemistry and Chemical Biology Limited, Hong Kong (HK)

(72) Inventors: Yifan PING, Hong Kong (HK); Chi-Ming CHE, Hong Kong (HK)

(21) Appl. No.: 18/752,825

(22) Filed: Jun. 25, 2024

Related U.S. Application Data
(60) Provisional application No. 63/511,224, filed on Jun. 30, 2023.

(51) Int. Cl. C07F 5/02

(52) U.S. Cl. CPC C07F 5/027

(57) ABSTRACT

A highly efficient and atroposelective Rh-catalyzed [2+2+2] cycloaddition for the synthesis of axially chiral aryboron compounds is developed. The reactions of diynes and alkynylborons smoothly occur in an atom-economical manner, affording a variety of C—B atropisomers in excellent yields and enantioselectivities. The protocol features mild conditions, broad substrate scope, and good functional tolerance. The obtained C—B atropisomers show powerful synthetic applications in terms of producing novel chiral phosphine ligands.

### CROSS-REFERENCE TO RELATED APPLICATIONS

The present application claims priority from U.S. provisional patent application Ser. No. 63/511,224 filed Jun. 30, 2023, and the disclosures of which are incorporated by reference in their entireties.

### FIELD OF THE INVENTION

The present invention generally relates to a method for the synthesis of axially chiral compound. More specifically the present invention relates to a method for the synthesis of axially chiral organoboron compound.

### BACKGROUND OF THE INVENTION

As a special type of stereoisomerism, atropisomerism arising from the restricted rotation around a single bond, represents a crucial chirality element in nature. Axial chirality abundantly presents in a myriad of natural products, pharmaceuticals, and bioactive molecules. In addition, axially chiral frameworks have been exploited for the development of advanced materials, such as fluorescent sensors, chiroptical switches, and molecular machines. Moreover, axially chiral scaffolds also constitute a wide range of privileged chiral catalysts and ligands in asymmetric catalysis, taking advantage of their relatively rigid three-dimensional structures that create fabulous environment for stereochemical control (FIG. 1A). Owing to their significance, the asymmetric construction of axially chiral compounds has become a meaningful topic in synthetic chemistry.

To date, various approaches have been developed to address this issue. Most of the established methods have been focused on the synthesis of C—C biaryl atropisomers as categorized by different strategies, including asymmetric cross-coupling, enantioselective de novo arene formation, dynamic kinetic resolution or desymmetrization of preexisting biaryls, central-to-axial chirality conversion, etc. Apart from C—C biaryl atropisomers, atropisomers bearing C—X (X=heteroatom) axis have emerged as new types of axially chiral skeletons that have gained much research interests in recent years. The introduction of a heteroatom on the stereogenic axis can provide new opportunities for the discovery of promising drugs, materials, and chiral ligands by modulating their physical and chemical properties. In this context, significant progress has been made for the asymmetric preparation of C—N atropisomers, whereas the development of synthetic methodology for other types of C—X (X≠N) atropisomers is still in its infancy. The lack of efficient synthetic tools also restricted the exploration of these C—X (X≠N) atropisomers in many areas (FIG. 1B).

Boron is an important element with unique features in nature. The incorporation of boron atoms in organic molecules has gained remarkable achievements in organic synthesis, optoelectronic materials, and drug discovery. As such, great interest has been attracted for the synthesis of chiral organoboron compounds. Because of the planar structural characteristic of neutral sp² hybridized boron unit, a vast majority of investigations have been focused on the centrally chiral alkylboron compounds in which boron is directly or indirectly linked to the asymmetric tetrahedral carbon. Nevertheless, axially chiral arylboron compounds with a C—B stereogenic axis connecting two perpendicular planes are rarely explored. Compared to C—C or C—N axial chirality, the construction of C—B axial chirality is more challenging due to the longer bond length of Csp²-B bond (1.58 A) versus Csp²-Csp² bond (1.48 A) and Csp²-N bond (1.44 A), resulting in lower configurational stability with lower rotational barrier (FIG. 1B).

Due to the foreseeable challenge, only a few reports have been disclosed so far (FIG. 1C). While there has been attempts, including a palladium-catalyzed atroposelective Miyaura borylation to directly form the stereogenic C—B axis, and a desymmetrization strategy to construct C—B axial chirality through CPA-catalyzed electrophilic aromatic substitution reaction, the development of novel synthetic methods that can generally access a wide range of axially chiral arylboron compounds from simple starting materials is still highly sought after in the field.

### SUMMARY OF THE INVENTION

In view of the above demand, provided herein is an improvement to the method of atroposelective synthesis of axially chiral aromatic organoboron compounds through rhodium-catalyzed [2+2+2] cycloaddition, which is achieved through readily available synthetic feedstocks as reactants and mild synthesis conditions. The method also ensures stable yield and high enantioselectivity. Further, novel phosphine ligands can be synthesized from the axially chiral aromatic organoboron compounds as obtained above.

In a first aspect of the present invention, a novel phosphine ligand is provided herewith, represented by the following formula:

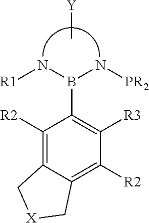

wherein R is selected from phenyl or cyclohexyl;
wherein X is selected from N-tosyl,

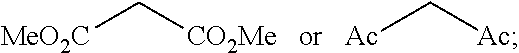

wherein R1 is selected from substituted or unsubstituted (C₁₋₄)alkyl, benzyl,

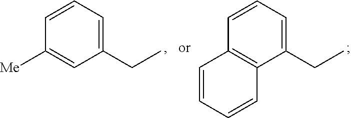

wherein R2 is selected from methyl or ethyl;
wherein R3 is selected from substituted or unsubstituted (C₁₋₅)alkyl, substituted or unsubstituted (C₁₋₅)alkenyl, phenyl, or cyclopropane; and
wherein Y is selected from or

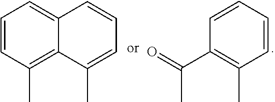

In an embodiment of the first aspect of the present invention, the compounds are represented by the following formula:

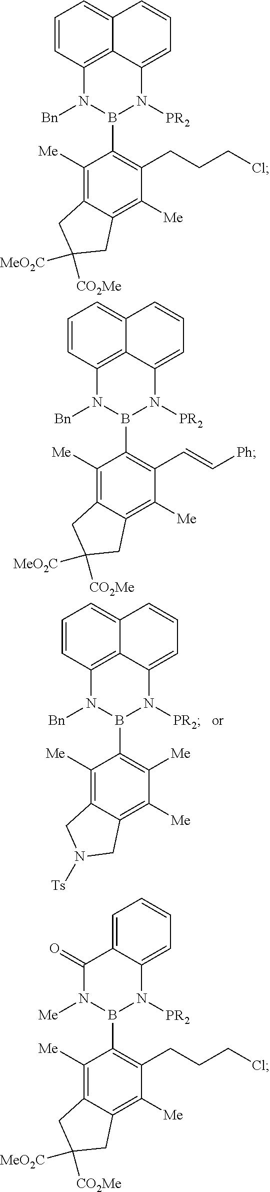

wherein R is selected from phenyl or cyclohexyl.

In another embodiment, a method of preparing the above compounds is provided, comprising: preparing an axially chiral aromatic organoboron compound represented by the following formula:

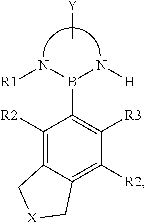

wherein R1 is selected from substituted or unsubstituted (C₁₋₄)alkyl, benzyl,

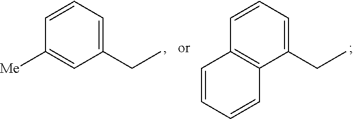

R2 is selected from methyl or ethyl; R3 is selected from substituted or unsubstituted (C₁₋₅)alkyl, substituted or unsubstituted (C₁₋₅)alkenyl, phenyl, or cyclopropane; and Y is selected from

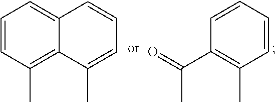

reacting the axially chiral organoboron compound with lithium bis(trimethylsilyl)amide (LiHDMS) in the presence of tetrahydrofuran for 8-12 minutes under room temperature to obtain an intermediate; and
reacting the intermediate with phosphine chloride with a formula of Cl-PR₂ for 1 hour under room temperature, wherein R is selected from phenyl or cyclohexyl.

In a further embodiment, the above method has a yield of at least 70%.

In yet a further embodiment, the enantiomeric excess of the compounds obtained is at least 90%.

In a second aspect of the present invention, an improvement to a method for synthesizing axially chiral aromatic organoboron compounds is provided, the improvement comprising reacting a boron-containing organic precursor material and a branched unsaturated linear organic precursor material in the presence of a rhodium catalyst and a chiral ligand.

In an embodiment of the second aspect of the present invention, the reacting the boron-containing organic precursor material and a branched unsaturated linear organic precursor material in the presence of a rhodium catalyst and a chiral ligand is conducted in an organic solvent at 55° C. to 65° C. for approximately 20 hours.

In another embodiment of the second aspect, the branched unsaturated linear organic precursor material is a diyne represented by the following formula:

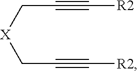

wherein R2 is selected from methyl or ethyl.

In other embodiment, the axially chiral aromatic organoboron compound represented by the following formula:

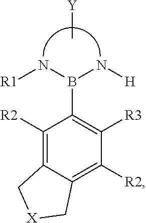

wherein R1 is selected from substituted or unsubstituted (C₁₋₄)alkyl, benzyl,

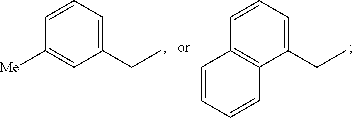

wherein R2 is selected from methyl or ethyl;
wherein R3 is selected from substituted or unsubstituted (C₁₋₅)alkyl, substituted or unsubstituted (C₁₋₅)alkenyl, phenyl, or cyclopropane; and
wherein Y is selected from or

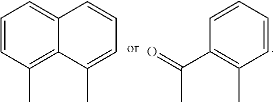

In yet another embodiment, the improved method has a yield of at least 50%.

In yet other embodiment, the enantiomeric excess of the axially chiral aromatic organoboron compounds obtained from the improved method is at least 85%.

### BRIEF DESCRIPTION OF THE DRAWINGS

Embodiments of the invention are described in more details hereinafter with reference to the drawings, in which:

FIGS. 1A to 1D illustrate the significance of axially chiral chemistry and strategies for C—B atropisomers synthesis. FIG. 1A shows representative applications of atropisomers. FIG. 1B shows previous challenges faced in C—B atropisomers synthesis. FIG. 1C shows previous strategies for C—B atropisomers synthesis. FIG. 1D shows a strategy of the present invention for C—B atropisomers synthesis: atroposelective [2+2+2] cycloaddition.

FIGS. 2A and 2B shows preparation of alkynylboron and optimization of [2+2+2] cycloaddition. FIG. 2A shows a preparation of alkynylboron. FIG. 2B shows an optimization of [2+2+2] cycloaddition. Reaction conditions: the reaction is performed with 1a (0.1 mmol), 2a (0.1 mmol), catalyst (5 mol %) and ligand (10 mol %) in solvent (1 mL) at indicated temperature for 20 h. Isolated yield is provided and ee is determined by chiral HPLC analysis. ^{a}L6 (5 mol %) is used. ^{b}2a (0.15 mmol, 1.5 equiv) is used. ^{c}Rh(cod)₂OTf (1 mol %) and L6 (1 mol %) are used. ^{d}1a (0.2 mmol) and 2a (0.3 mmol) are used.

FIG. 3 shows substrate scope of diynes. Reaction conditions: the reaction is performed with 1 (0.2 mmol), 2a (0.3 mmol), Rh(cod)₂OTf (5 mol %) and L6 (5 mol %) in toluene (2 mL) at 60° C. for 20 h. Isolated yield is provided and ee is determined by chiral HPLC analysis. ^{a}diyne (0.2 mmol in 2 mL toluene) is added dropwise for 3 h.

FIGS. 4A and 4B shows substrate scope of alkynyl Bdans. Reaction conditions: the reaction is performed with 1 (0.2 mmol), 2 (0.3 mmol), Rh(cod)₂OTf (5 mol %) and L6 (5 mol %) in toluene (2 mL) at 60° C. for 20 h. Isolated yield is provided and ee is determined by chiral HPLC analysis. FIG. 4A shows variation of alkyne substituents. FIG. 4B shows variation of Bdan substituents.

FIG. 5 shows substrate scope of alkynyl Baams. Reaction conditions: the reaction is performed with 1 (0.2 mmol), 2 (0.3 mmol), Rh(cod)₂OTf (5 mol %) and L6 (5 mol %) in toluene (2 mL) at 60° C. for 20 h. Isolated yield is provided and ee is determined by chiral HPLC analysis.

FIGS. 6A to 6C shows synthetic utility of the developed methodology. FIG. 6A shows late-stage modification of drug; FIG. 6B shows Gram-scale synthesis; FIG. 6C shows basic functional group transformations on the axially chiral arylboron scaffolds. (a) X=Cl, NaSPh (2 equiv), DMF, rt, 2 h. (b) X=OTs, NaI (2 equiv), acetone, 60° C., 24 h. (c) HP(O)Ph₂ (2 equiv), K₂CO₃ (2 equiv), TBAI (20 mol %), DMF, 70° C., 15 h. (d) NaN₃ (2 equiv), DMF, 60° C., 3 h. (e) Phenylacetylene (2 equiv), CuSO₄ (5 mol %), sodium ascorbate (20 mol %), ^{t}BuOH/H₂O (1/1), 60° C., 15 h.

FIGS. 7A to 7D shows synthetic applications of the obtained C—B atropisomers. FIG. 7A shows synthesis of tetra-ortho-substituted axially chiral arylboron compounds. Employed electrophiles: ^{a}MeI, ^{b}TMSCl, ^{c}BzCl, ^{d}Cl-PPh₂, ^{e}Cl-PCy₂, ^{f}Cl-PⁱPr₂. FIG. 7B shows construction of a novel chiral phosphine ligand library. FIG. 7C shows application of new synthesized chiral ligand in Pd-catalyzed asymmetric allylic alkylation. FIG. 7D shows intramolecular cyclization for the construction of bridged C—B atropisomers.

FIGS. 8A to 8C shows mechanistic studies. FIG. 8A shows determination of rotational barrier of 4a.

FIG. 8B shows non-linear effect experiment. FIG. 8C shows proposed reaction mechanism.

FIG. 9 illustrates the preparation of unsymmetrically substituted 1,8-diaminonaphthalene (dan).

FIG. 10 illustrates the preparation of unsymmetrically substituted anthranilamide (aam).

FIG. 11A illustrates the preparation of alkynyl Bdan compounds from normal terminal alkynes; FIG. 11B illustrates the preparation of alkynyl Bdan compounds from terminal alkynes bearing sensitive functionalities and FIG. 11C illustrates the preparation of alkynyl Bdan compounds from Grignard reagents.

FIG. 12A illustrates the preparation of alkynyl Baam compounds from normal terminal alkynes; and FIG. 12B illustrates the preparation of alkynyl Baam compounds from Grignard reagents.

FIG. 13A shows the 6 chiral MOP ligands utilized for the synthesis of the exemplary axially chiral aromatic organoboron compounds. FIG. 13B shows the schematics for the modified synthesis route of L6.

FIG. 14 shows the general schematic of the rhodium-catalyzed [2+2+2] cycloaddition reaction of a series of diyne 1 with a fixed species of 2a.

FIG. 15 shows the general schematic of the rhodium-catalyzed [2+2+2] cycloaddition reaction of a fixed species of diyne 1 with a series of alkynyl Bdans 2a.

FIG. 16 shows the general schematic of the rhodium-catalyzed [2+2+2] cycloaddition reaction of a fixed species of diyne 1 with a series of alkynyl Baams 2.

FIG. 17 shows an illustration of a schematic of the application of the rhodium-catalyzed [2+2+2]cycloaddition reaction in late-stage drug modification.

FIG. 18 shows the general schematic of the synthesis of tetra-ortho-substituted axially chiral arylboron compounds.

FIG. 19 shows the general schematic of the synthesis of various chiral phosphine ligands from the axially chiral arylboron compounds.

FIG. 20 shows the general schematic of the synthesis of bridged C—B atropisomers from the axially chiral arylboron compounds.

FIG. 21 shows the general schematic of Pd-catalyzed asymmetric allylic alkylation, further catalyzed by the novel chiral phosphine ligands provided in the present invention, and the species of novel chiral phosphine ligands applicable to the Pd-catalyzed asymmetric allylic alkylation.

FIG. 22 shows the general schematic of Pd-catalyzed asymmetric Suzuki coupling, further catalyzed by the novel chiral phosphine ligands provided in the present invention, and the species of novel chiral phosphine ligands applicable to the Pd-catalyzed asymmetric allylic alkylation.

### DETAILED DESCRIPTION

Axial chirality, as discussed above, has been well exploited in multiple fields of application, ranging from chiral sensors, material science (e.g. nonlinear optics and liquid crystals), chiral catalysis and numerous ular-level uses, to pharmaceutical and biomedical applications, in which axial chirality plays a particularly significant, due to the biological activity of the drugs being highly dependent on their stereochemistry.

The incorporation of boron into organic molecules, on the other hand, is also gaining more attention due to its wide range of applications in organic synthesis, optoelectronics and pharmaceuticals; and its axially chiral variants are also being explored despite difficulties in its construction due to configurational instability and rotational barrier.

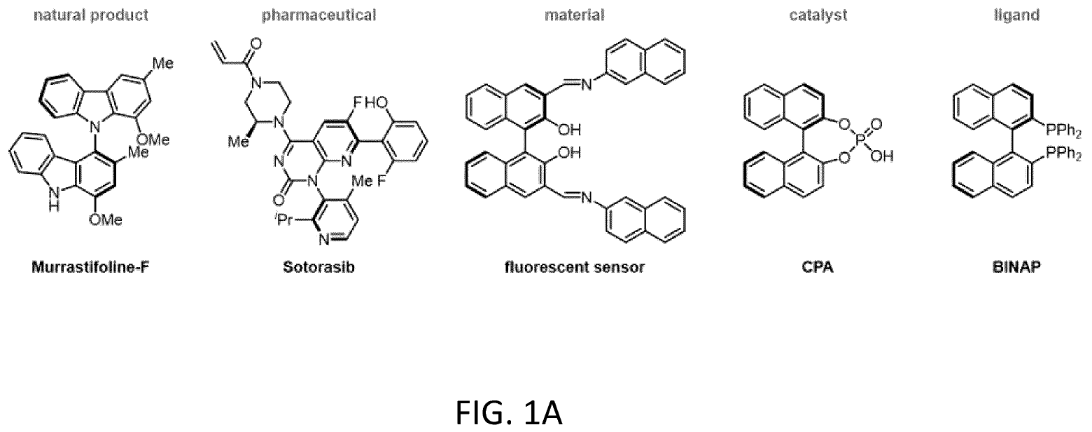

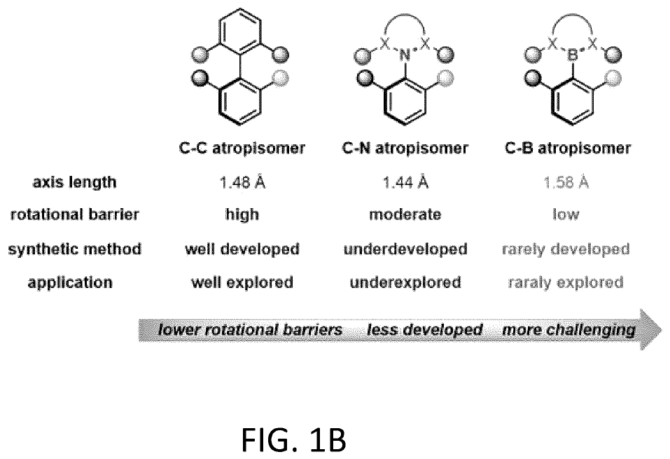

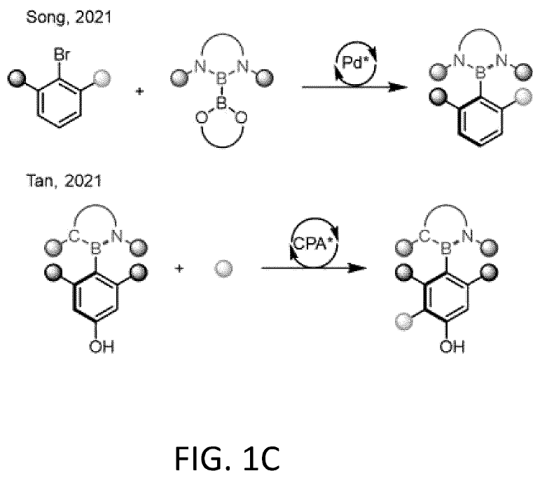

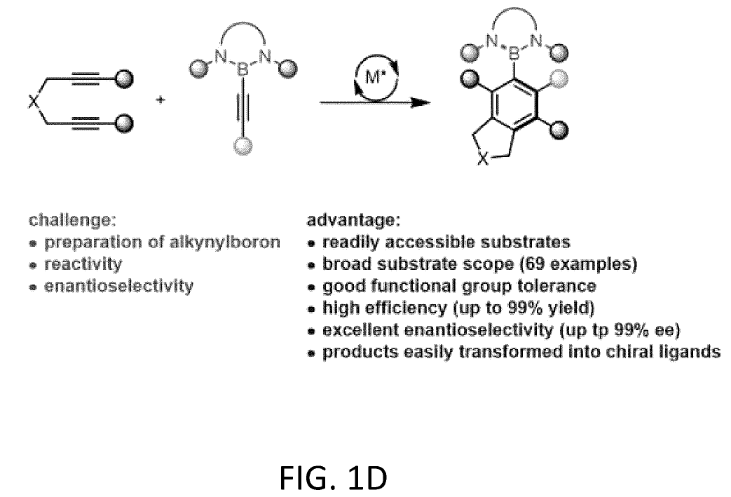

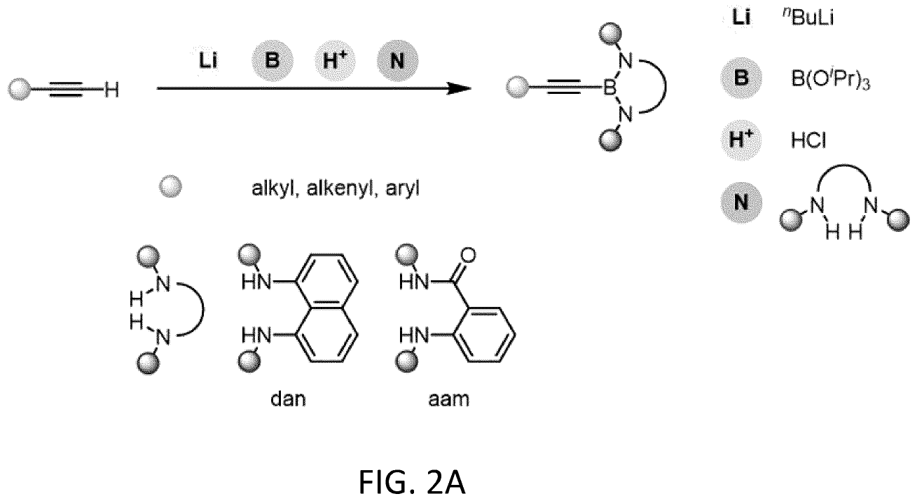

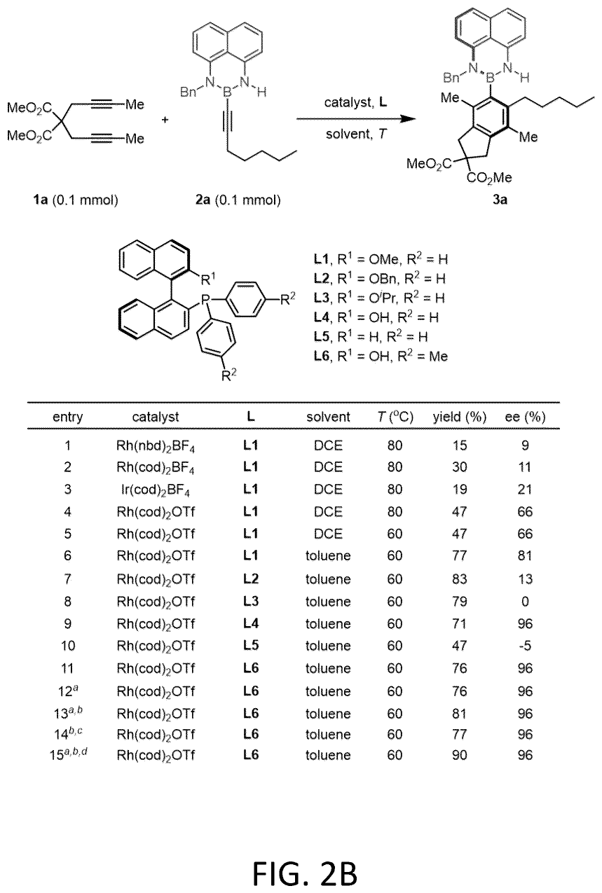

Alkynes are readily available synthetic feedstocks with versatile reactivity. Recently, alkynes have also been utilized for the asymmetric construction of atropisomers. One of the representative examples is transition-metal-catalyzed atroposelective [2+2+2] cycloaddition that can efficiently afford atropisomers via de novo arene formation in an atom-economical manner. This approach has been successful for the generation of various C—C and C—N atropisomers. Inspired by this chemistry, the [2+2+2] cycloaddition between alkynylboron and diyne could be promising for the construction of C—B atropisomers (FIG. 1D).

However, some challenges are foreseeable to achieve such a scenario. First, in order to install C—B axial chirality (stable enough for isolation), an appropriate sterically bulky boron protecting group is essential for this process. Thus, an efficient preparation method for these specific assembled alkynylboron substrates needs to be developed.

Second, both alkynylboron and diyne should be internal alkynes to ensure at least three ortho-groups present in the product to lock C—B stereogenic axis, while the reactivity may be diminished due to the enormous steric hindrance resulting from the formation of a fully substituted arene.

Third, when considering the low configurational stability of C—B atropisomers, a suitable chiral ligand with the combination of a transition-metal catalyst needs to be identified to achieve both good reactivity and enantioselectivity under mild conditions.

Herein, a practical and efficient method for atroposelective synthesis of axially chiral arylboron compounds through rhodium-catalyzed [2+2+2] cycloaddition is provided. Crucially, the use of chiral MOP ligand enables both good reactivity and excellent enantioselectivity control under mild conditions. The reaction features broad substrate scope and good functional group tolerance, affording a wide range of C—B atropisomers in excellent yields and enantiocontrol. The alkynylboron substrates could be readily accessed from terminal alkynes, providing a general platform for diverse synthesis from simple feedstocks. Furthermore, the obtained axially chiral arylboron products could be leveraged as valuable precursors for the straightforward generation of new chiral phosphine ligands that have shown potential abilities in asymmetric catalysis.

In the following description, method for the synthesis of axially chiral organoboron compound and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

### Results

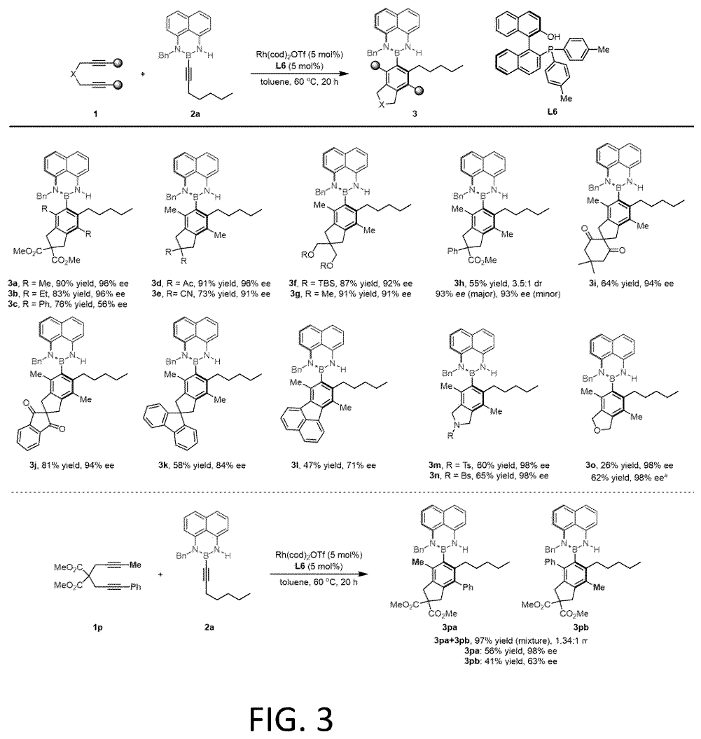

At the outset, a general method is developed for the preparation of alkynylboron substrates. After several trials, a series of alkynylboron compounds are found possible to be readily synthesized from terminal alkynes in good yields through lithiation-borylation-acidification-amination procedure (FIG. 3). This protocol is simple and could be performed in one-pot without the isolation of any intermediate products. Because terminal alkynes are widely accessible feedstocks, this protocol allows the straightforward synthesis of alkynylboron compounds with a broad range of substituents on the alkyne moiety, such as alkyl, alkenyl, and aryl groups. 1,8-Diaminonaphthalene (dan) or anthranilamide (aam) could be employed as efficient boron-protecting groups, and at least one substituent at nitrogen atom is indispensable to produce axial chirality. In contrast to commonly studied alkynyl Bpin compounds required isolation through distillation and storage under nitrogen, these alkynyl Bdan and Baam compounds are less Lewis acidic that could be readily obtained from silica gel chromatography or recrystalization. Moreover, these compounds are air-stable solids and could be easily handled.

Diyne 1a and 1-heptynyl Bdan 2a are chosen as the model substrates to examine the reaction (FIG. 3). Preliminary experiments are carried out by the investigation of several chiral ligands with Rh(nbd)₂BF₄ as the catalyst. While biphosphine ligands and other monophosphine ligands are ineffective, MOP ligand L1 could promote the reaction to generate axially chiral arylboron product 3a in 15% yield and 9% ee (entry 1). With L1 as the ligand, other Rh(I) and Ir(I) catalysts (entries 1-4) are explored. To our delight, Rh(cod)₂OTf could dramatically improve both reactivity and enantioselectivity (entry 4). This result revealed that both olefin ligand and counterion of the catalyst had a significant impact on this reaction. The parameters of temperature and solvent are then evaluated, and the reaction could perform better at 60° C. with toluene as the solvent, affording 3a in 77% yield and 81% ee (entry 6). Considering that ligand might be crucial for the reaction, other MOP ligands L2-L6 (entries 7-11) are investigated. While increasing the steric hindrance of alkyloxy substituents led to dramatic decline of enantioselectivity (entries 7 and 8), employing smaller hydroxyl group further improved the enantioselectivity to 96% ee, along with a satisfactory yield of 71% (entry 9). Further removal of hydroxyl group resulted in inferior enantiocontrol (entry 10), whereas introducing a para-methyl group into the phenyl moiety could slightly improve the yield to 76% with retention of high enantioselectivity (entry 11). With L6 as the ligand, additional parameters with respect to catalyst/ligand ratio and the equivalent of 2a are optimized (entries 12-15). While lowering the catalyst/ligand ratio from 1:2 to 1:1 didn't affect the reaction efficiency and enantioselectivity (entry 12), increasing the equivalent of 2a could further improve the yield (entry 13). It is notable that the loading of both catalyst and ligand could be reduced to 1 mol % without significant erosion of yield and enantioselectivity (entry 14). Finally, when the reaction is performed in 0.2 mmol scale, axially chiral arylboron 3a could be obtained in 90% isolated yield and 96% ee (entry 15).

With the optimized reaction conditions in hand, the substrate scope is next to explore. An assortment of diynes with different alkyne termini and tethers are first evaluated (FIG. 3). Most of them could react smoothly with 2a to afford the corresponding axially chiral arylboron products in good yields and enantioselectivities (3a-o). Variation of alkyne termini showed that Me and Et termini could be well tolerated, affording the products 3a, 3b in excellent yields and enantioselectivities, whereas Ph termini resulted in moderate enantioselectivity (3c), presumably because its larger steric hinderance is detrimental to the enantiocontrol in the enantiodetermining step. A series of diynes with different tethers also performed well to deliver the products 3d-o in moderate to good yields and enantioselectivities. A broad range of functional groups are compatible with the reaction conditions, including esters (3a-c, 3h), ketones (3d, 3i, 3j), ethers (3g, 3o), protected alcohol (3f), and nitrile (3e). The reaction of diyne containing both phenyl and ester substituents at the quaternary tether carbon would generate product 3h with a central chirality and an axial chirality. In this case, moderate diastereoselectivity is observed, while enantioselectivity is still good for each pair of enantiomers. Diynes derived from cyclic frameworks could be used as well, giving products 3i-k with spiro units in satisfactory yields and enantioselectivities. The reaction could also be realized for the construction of polycyclic aromatic compound, delivering 3l with a C—B axially chiral scaffold in moderate yield and enantioselectivity. Notably, nitrogen- or oxygen-tethered diynes are also applicable, providing the corresponding products 3m-o with moderate yields and excellent enantioselectivities. In the case of 3o, it is found that slow addition of diyne could effectively inhibit the self-dimerization of diyne and further improve the yield without the erosion of enantioselectivity. Finally, unsymmetrical diyne bearing two different alkyne termini (Me and Ph) is investigated. The reaction worked well to afford a pair of regioisomers 3pa, 3pb in high yield, albeit with low regioselectivity. Excellent enantioselectivity is observed for major product 3pa, whereas moderate enantioselectivity is shown for minor product 3pb.

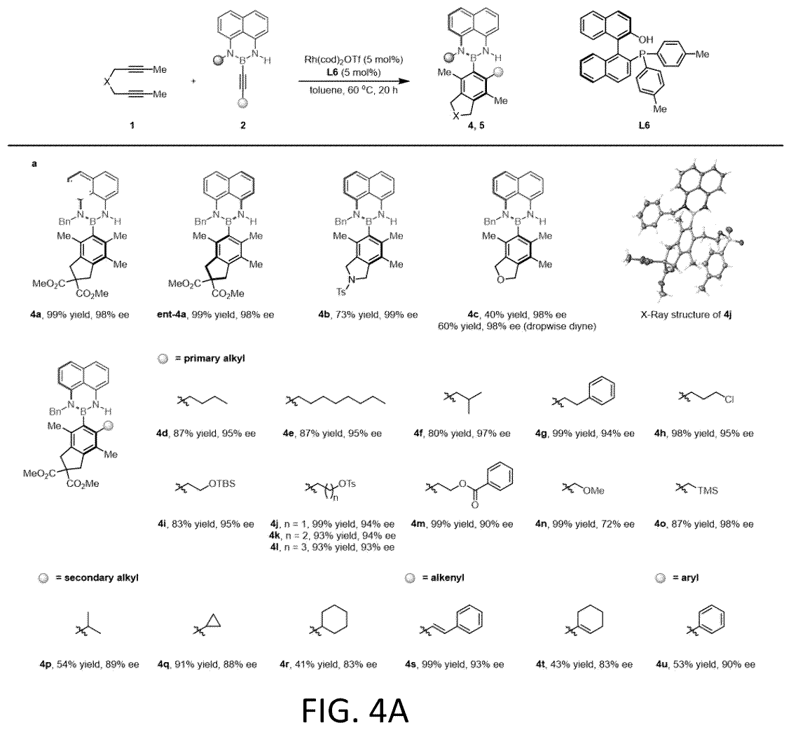

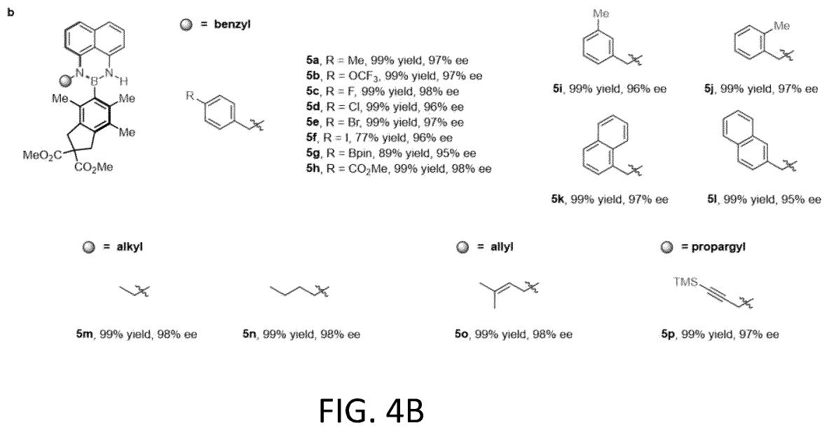

Next, the generality of this reaction is examined by adopting a series of alkynyl Bdan compounds (FIG. 4). A myriad of alkynyl Bdan compounds with diverse alkyne substituents could be successfully applied to this protocol, affording the corresponding axially chiral arylboron products in high efficiency and good enantioselectivities (FIG. 4A, 4a-u). Owing to broad substrate scope and easy access of alkynylboron compounds from prevalent terminal alkynes, structural variation of axially chiral arylboron scaffolds could be extensively realized. Methyl-substituted alkynyl Bdan smoothly underwent the cycloaddition with several diynes, providing the products 4a-c in good yields and enantioselectivities. The enantiomer of 4a could be readily prepared by using (S)-L6 as the ligand (ent-4a). Primary alkyl groups with different chain length or substitution pattern could be incorporated as the alkyne substituents to give the products 4d-o in excellent yields and enantioselectivities. Functional groups such as alkyl chloride (4h), silyl ether (4i), sulfonate (4j-l), ester (4m), and silicon group (4o), could be well tolerated. The use of alkynyl Bdan with methoxy at the proparglic position afforded the product 4o in high yield but diminished enantioselectivity, probably due to the harmful coordination between methoxy and rhodium catalyst. Notably, the reaction efficiency and enantioselectivity are in connection with the steric environment of the alkyne substituents. When employing secondary alkyl-substituted alkynyl Bdans, the reaction also successfully proceeded to afford the products 4p-r in moderate yields and slightly diminished enantioselectivities. The larger steric hindrance of the alkyne substituents resulted in enhanced self-dimerization of diynes as well as lower enantiocontrol in the enantiodetermining step. Alkynyl Bdan compounds generated from terminal 1,3-enynes or phenylacetylene are competent substrates as well. Accordingly, the product 4s with a sterically small styrene substituent is obtained in high yield and enantioselectivity, while the products 4t, 4u with sterically large cyclohexyl or phenyl substituents are produced in moderate efficiency and enantiocontrol. The absolute configuration of 4j is unambiguously determined by X-Ray crystallographic analysis and other aryl Bdan products are assigned by analogy.

Furthermore, alkynyl Bdan compounds with various Bdan substituents are investigated (FIG. 4B). The reaction could tolerate a variety of benzyl groups with different para-, meta-, or ortho-substituents, affording the corresponding products 5a-j in quantitative yields and excellent enantioselectivities. Some active functional groups, like bromide (5e), iodide (5f), and boronate (5g), are compatible, providing promising opportunities for further transformations. Polycyclic aromatic substrates could also be applied to give the products 5k, 5l in high yields and enantioselectivities. Moreover, alkyl-substituted aryl Bdan products 5m, 5n could be effectively formed through this protocol in excellent enantioselectivities. The robustness of this method is further demonstrated by employing substrates bearing additional unsaturated moieties. Perfect chemoselectivities are observed as the cycloaddition exclusively occurred at the boron-activated alkyne moiety. Additionally, the products 5o-p are generated in high yields and enantioselectivities.

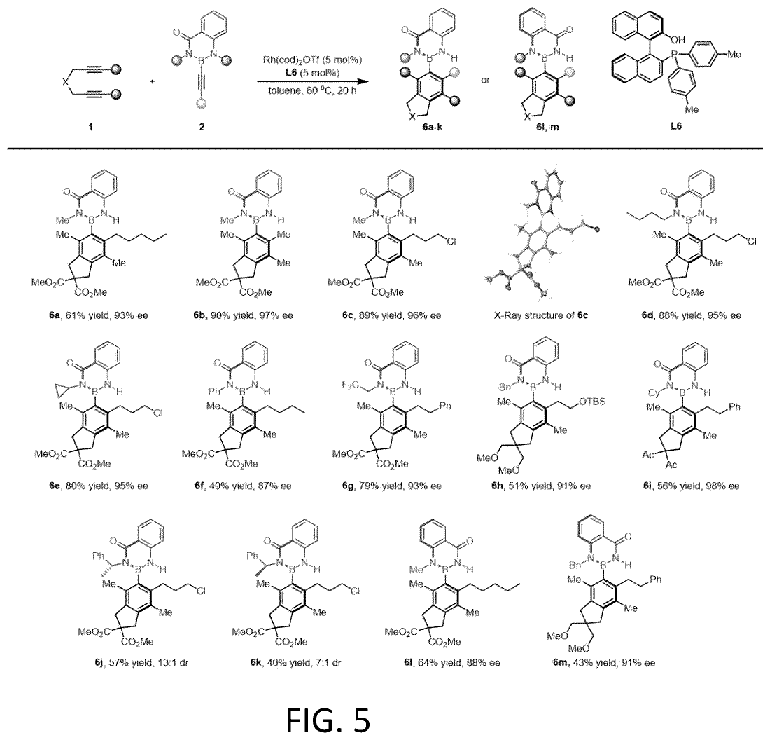

Encouraged by the wide scope of this approach for the generation of axially chiral aryl Bdan scaffolds, it is expected to apply this reaction to build other types of axially chiral arylboron compounds. Since Baam has the similar planar framework with all sp² atoms constituted, the construction of axially chiral aryl Baam compounds is next to explore. The previous investigation of aryl Baam compounds mainly focused on the transition-metal-catalyzed cross-coupling reactions⁶, while their axial chirality remained unprecedented. A series of axially chiral aryl Baam compounds could be successfully built by the reaction of alkynyl Baam compounds with diynes (FIG. 5). The generality of the reaction is sufficiently evaluated by the variation of alkyne substituents, Baam substituents, and diynes. An assortment of aryl Baam compounds could be synthesized in moderate to good yields and excellent enantioselectivities (6a-i, 6l, 6m). Substrates bearing an existing chiral center are also compatible to afford the corresponding products 6j, 6k in satisfactory diastereoselectivities. The absolute configuration of 6c is unambiguously determined by X-Ray crystallographic analysis and other aryl Baam products are assigned by analogy.

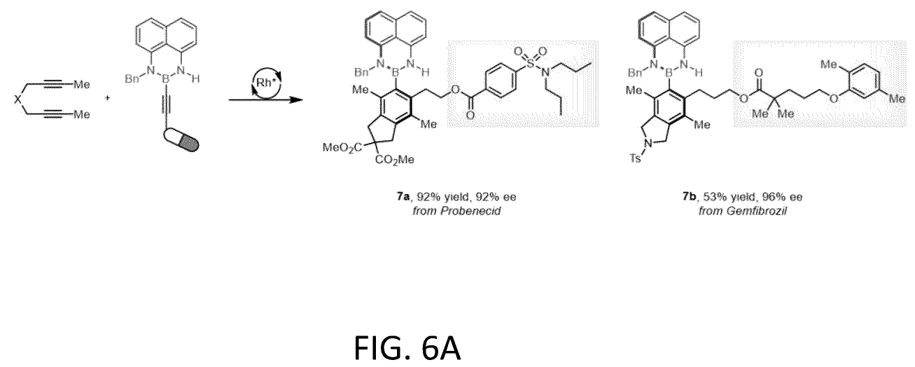

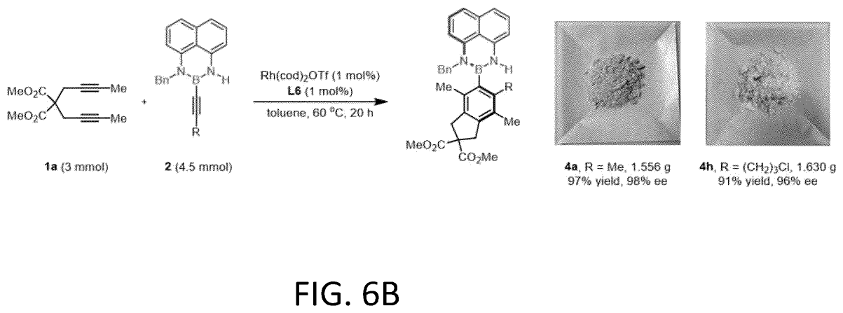

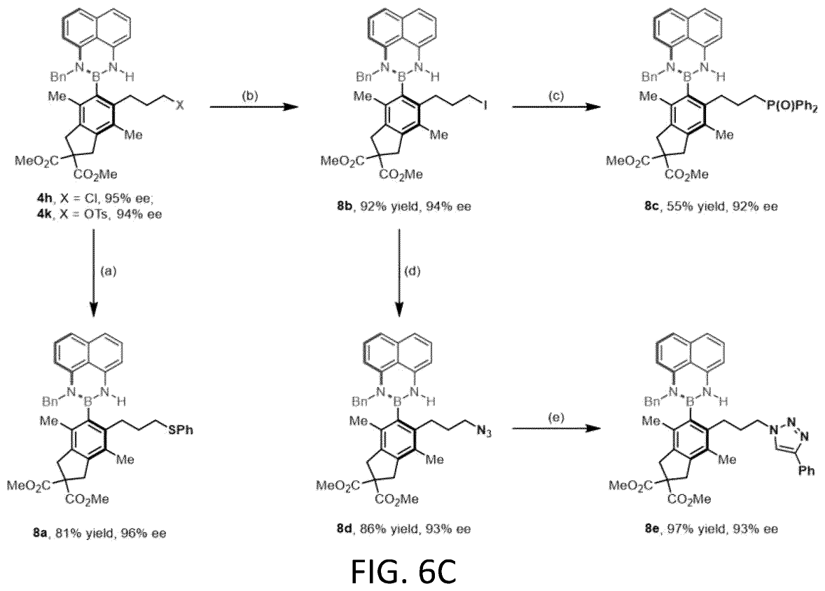

To demonstrate the synthetic utility of this methodology, several investigations are. First, the reaction could be utilized for the late-stage modification of drugs, giving the corresponding axially chiral arylboron derivatives from Probenecid and Gemfibrozil in good yields and excellent enantioselectivities (FIG. 6A, 7a, 7b). Second, the reaction could be performed in gram-scale, affording 4a or 4h in high yields and enantioselectivities by using only 1% of Rh(cod)₂OTf and 1% of L6 under otherwise identical conditions (FIG. 6B). Notably, the excess amount of alkynylboron substrates could also be recovered after the reaction. Third, some basic functional group transformations are explored based on axially chiral arylboron scaffolds 4h or 4k. As shown in FIG. 6C, alkyl chloride is transformed into alkyl sulfide (8a), while alkyl iodine (8b) is prepared from alkyl tosylate. The obtained alkyl iodine 8b underwent further nucleophilic substitutions to generate alkyl phosphine oxide 8c and alkyl azide 8d. Afterwards, an efficient Click reaction is performed with 8d and phenylacetylene to afford triazole 8e. Notably, all of these transformations could be efficiently realized with high retention of enantiopurity.

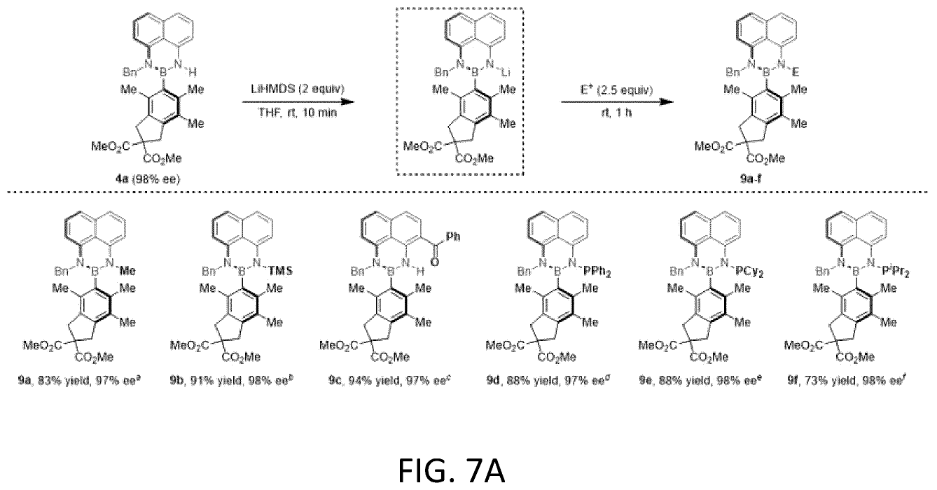

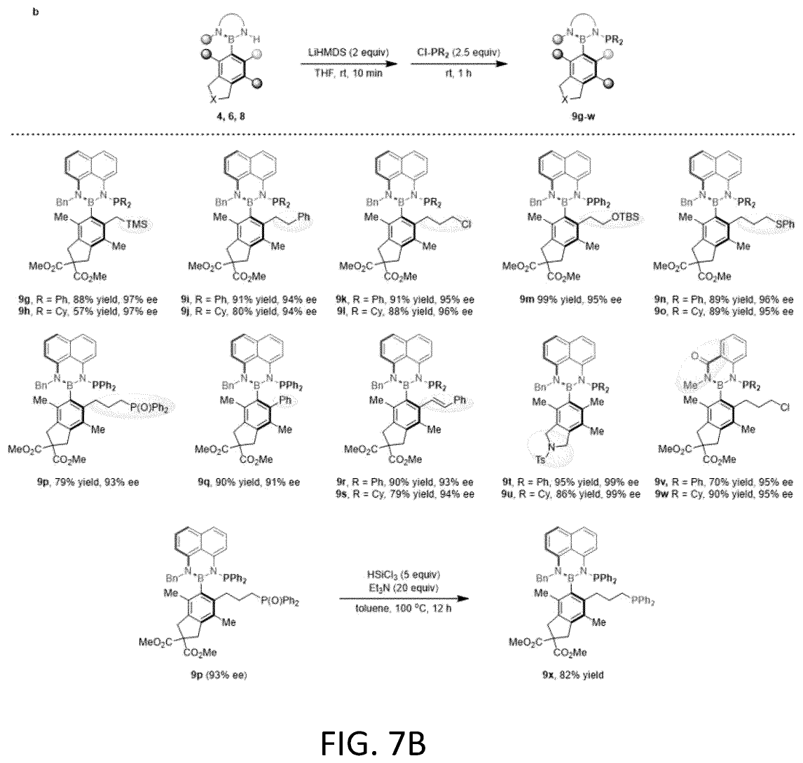

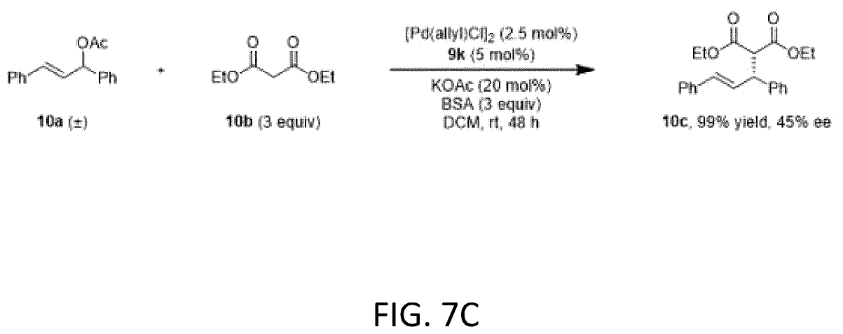

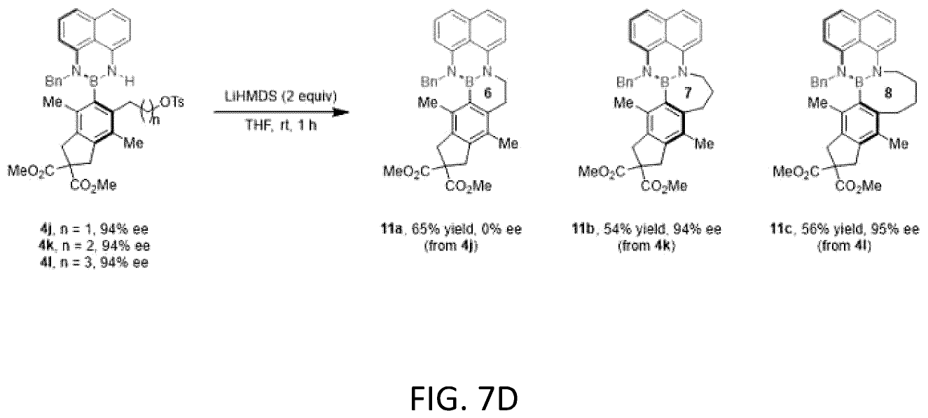

As in the developed methodology of the present invention afforded an assortment of axially chiral arylboron compounds, the synthetic applications of these obtained atropisomers are further explored. First, all of the above obtained C—B atropisomers are tri-ortho-substituted scaffolds possessing an active N—H bond on the Bdan or Baam moiety. The deprotonation of this N—H bond could occur in the presence of LiHMDS as the base, generating lithium amide intermediate that could be trapped by a series of electrophiles. Consequently, various tetra-ortho-substituted axially chiral arylboron compounds could be formed. As shown in FIG. 7A, the reactions of 4a with different electrophiles are investigated. The use of iodomethane enabled methylation (9a), while assembly of silyl group is accomplished by trimethylsilyl chloride (9b). Interestingly, when benzoyl chloride is employed as the electrophile, the benzoylation exclusively occurred at the ortho-naphthalene site to form tri-ortho-substituted product 9c. The unusual regioselectivity might benefit from a more stable six-member-ring transition state formed during the nucleophilic attack with an additional interaction between lithium and benzoyl oxygen. Moreover, the reactions of 4a with different phosphine electrophiles could conveniently produce a series of chiral phosphine ligands 9d-f. It is noteworthy that all of these transformations exhibited high efficiency and excellent enantioretention. Because of the importance of chiral phosphine ligands in asymmetric catalysis, the successful synthesis of 9d-f motivated us to build a novel chiral phosphine ligand library from various obtained axially chiral arylboron scaffolds (FIG. 7B). The synthesis scheme is quite general, enabling rapid synthesis of a wide range of new chiral phosphine ligands in good yields and high enantiopurities (9g-w). Many functionalities including silicon group (9g, 9h), alkyl chloride (9k, 9l, 9v, 9w), silyl ether (9m), sulfide (9n, 9o), phosphine oxide (9p), and olefin (9r, 9s), are well tolerated. Some chiral cooperative ligands, such as phosphine-sulfide ligand (9n, 9o), biphosphine monoxide ligand (9p), and phosphine-olefin ligand (9r, 9s) could also be smoothly prepared. Notably, biphosphine monoxide ligand 9p could further undergo reduction to afford chiral biphosphine ligand 9x. With the novel chiral phosphine ligand library in hand, the utility of these chiral ligands is evaluated in Pd-catalyzed asymmetric allylic alkylation (FIG. 7C). By employing 9k as the ligand, the reaction of racemic 10a and 10b proceeded smoothly to afford product 10c in 99% yield and 45% ee, demonstrating the potential competence of these chiral ligands in asymmetric catalysis. Finally, when treating axially chiral arylboron compounds 4j-l with LiHMDS, intramolecular cyclization could occur to furnish bridged C—B atropisomers 11a-c (FIG. 7d). This is because the terminal alkyl tosylate could be regarded as intramolecular electrophile that can efficiently trap the generated lithium amide intermediate. The configurational stability of these bridged C—B atropisomers is dependent on the ring size. While six-membered ring 11a is configurationally unstable that could undergo racemization at room temperature, seven-membered ring 11b and eight-membered ring 11c are stable enough to be isolated in high enantiopurities. Despite the high abundance of bridged atropisomers in bioactive natural products and drugs, existing synthetic methodology mainly focused on bridged C—C biaryl, whereas bridge C—X atropisomers still lacked efficient synthetic approach.

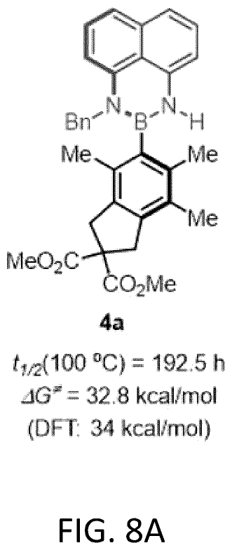

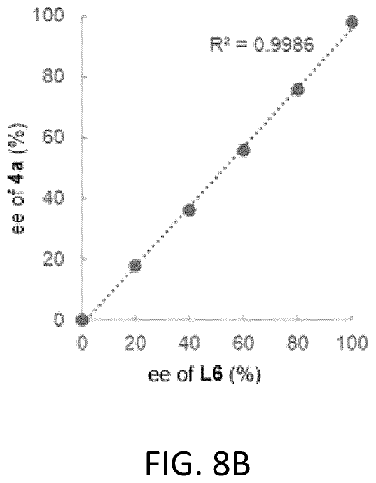

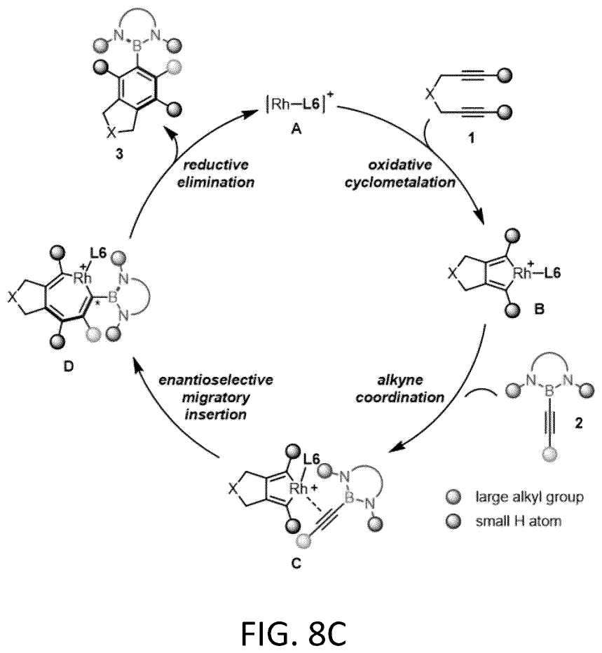

Several investigations are implemented. First, racemization experiment and DFT calculation are carried out to examine the configurational stability of the obtained C—B atropisomers, as exemplified by determination of 4a (FIG. 8A). Racemization experiment is performed by heating 4a in toluene at 100° C. The rotational barrier of 4a is determined to be 32.8 kcal/mol and half-life time is 192.5 h (8 days) at 100° C. DFT calculation is conducted through a rotational scan of C—B bond and the calculated rotational barrier is 34 kcal/mol. Compared with the previous reported C—B atropisomers, the obtained C—B atropisomers in this study had higher configurational stability. The fully-substituted aryl ring might increase the steric hindrance around C—B axis, leading to a more stable configuration. Second, non-linear effect experiments are performed to investigate the catalytic active species in this reaction⁴⁹. The reactions of 1a and 2b are conducted by using a series of L6 with different ee and the ee of 4a are determined by chiral HPLC analysis. As shown in FIG. 8B, the ee of 4a had a linear relationship with the ee of L6, which indicated that the Rh/L6 ratio of catalytic active species is 1/1. Finally, a plausible reaction mechanism (FIG. 8C) is proposed. The reaction started with oxidative cyclometalation between catalytic active species Rh(I) species A and diyne 1 to generate Rh(III) intermediate B. Then, B accepted the coordination of alkynylboron 2 to form complex C. After that, an enantioselective migratory insertion occurred to give intermediate D and produce the axial chirality. In this step, chiral ligand L6 could efficiently distinguish two ortho-substituents on the boron group by steric hindrance and make this process enantioselective. At last, enantioretentive reductive elimination of D could furnish axially chiral arylboron product 3 and regenerate A to realize the catalytic cycle.

### Examples

### 1. Atroposelective Construction of Carbon-Boron Axial Chirality Through Catalyzed [2+2+2] Cycloaddition

### 1.1 General Information

All the chemical reagents are purchased from Macklin, Aladdin, Bidepharm, Sigma-Aldrich, and TCI. Solvents are purchased from Duksan, Labscan, and Anaqua (Hong Kong). Anhydrous solvents are purchased from Acros and Alfa Aesar. All the rhodium-catalyzed reactions are performed by standard Schlenk techniques in oven-dried Schlenk tubes or flasks under nitrogen atmosphere. Flash column chromatography is carried out using silica gel (SiliCycle, SiliaFlash P60, 40-63 □m). Thin-layer chromatography (TLC) is conducted using silica gel plates (Merck Silica gel 60 F254). Compounds are visualized under UV light or by staining with an ethanolic solution of phosphomolybdic acid. All NMR spectra are recorded on Bruker 600 NMR spectrometers at 600 MHz (¹H NMR), 150 MHz (¹³C NMR), 193 MHz (¹¹B NMR), 565 MHz (¹⁹F NMR) and 243 MHz (³¹P NMR). Chemical shifts are reported in parts per million (ppm) and referenced to tetramethylsilane (0 ppm) for ¹H NMR or CDCl₃ (77 ppm) for ¹³C NMR. Coupling constants (J) are reported in Hertz (Hz). Abbreviations are given as follows: s (singlet), d (doublet), t (triplet), q (quartet), p (quintet), h (sextet), m (multiplet), br (broad). ¹H NMR spectra are reported as follows: chemical shift (multiplicity, coupling constants, number of protons). ¹³C NMR, ¹¹B NMR, ¹⁹F NMR, and ³¹P NMR spectra are reported in terms of chemical shift. The carbon attached to boron is usually not observed in ¹³C NMR spectra. High resolution mass spectra (HRMS) are recorded on Agilent 6546 LC/Q-TOF spectrometer. Enantiomeric excess (ee) values are determined by chiral HPLC (Agilent 1290 Infinity II) equipped with Daciel chiral columns (IA, IA-3, IB-3, IC-3, ID-3) using n-Hexane and IPA as eluents.

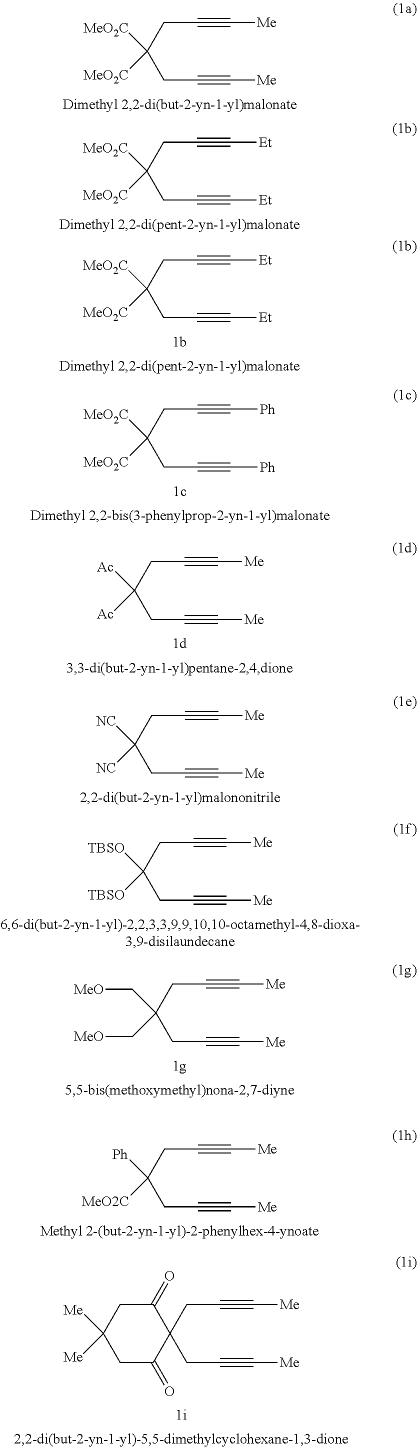

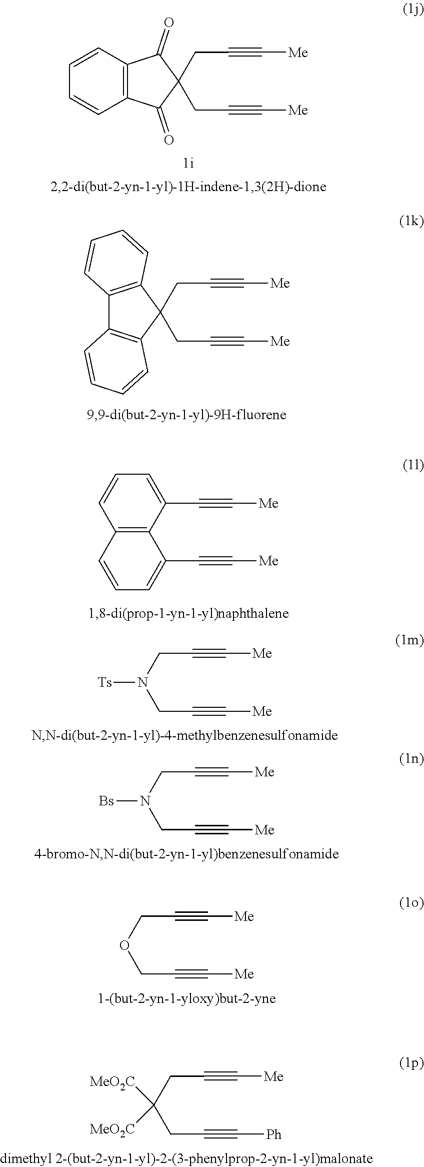

### 1.2 Preparation of Alkynylboron Compounds

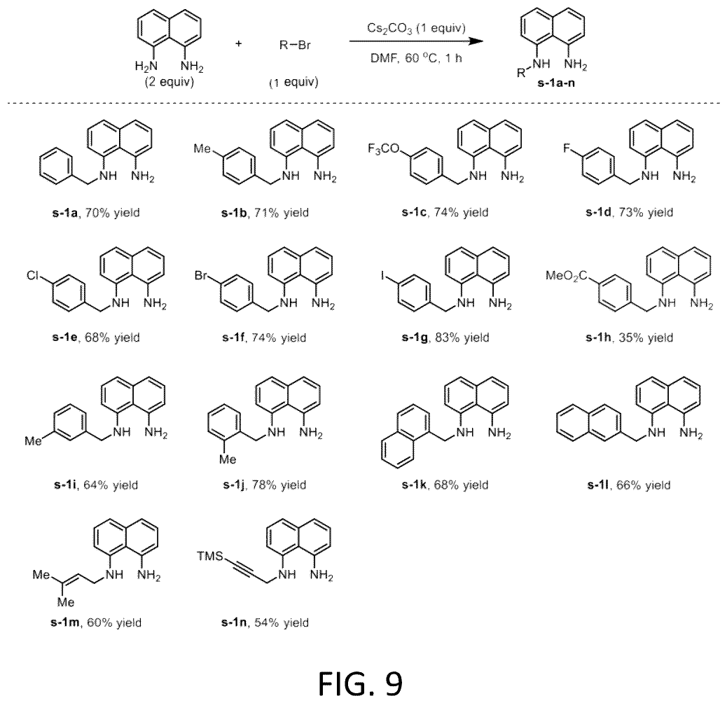

Procedure A: 1,8-Diaminonaphthalene (2 equiv), Cs₂CO₃ (1 equiv), and DMF (0.5 M) are added to ar. The mixture is stirred at rt for 30 minutes. Then, alkyl bromide (1 equiv) is added at rt. The reaction is stirred at 60° C. for 1 hour. After the reaction is completed, the mixture is filtered through a pad of silica gel and washed with EtOAc. The filtrate is concentrated under reduced pressure at 60° C. The residue is purified by silica gel column chromatography to afford unsymmetrically substituted 1,8-diaminonaphthalene product (s-1a-n, see FIG. 9).

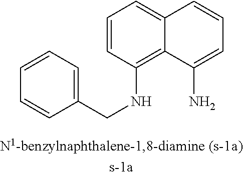 [SMILES: Nc1cccc2cccc(NCc3ccccc3)c12]

Following the above procedure A, s-1a is prepared from 1,8-diaminonaphthalene (9.492 g, 60 mmol) and benzyl bromide (3.6 mL, 30 mmol). Purified by silica gel column chromatography (n-Hexane/EA=20/1-5/1), s-1a is obtained as a pink oil (5.231 g, 70% yield).

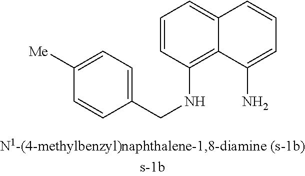 [SMILES: Cc1ccc(CNc2cccc3cccc(N)c23)cc1]

Following the above procedure A, s-1b is prepared from 1,8-diaminonaphthalene (1.898 g, 12 mmol) and 4-methylbenzyl bromide (1.111 g, 6 mmol). Purified by silica gel column chromatography (n-Hexane/EA=20/1-5/1), s-1b is obtained as a pink oil (1.120 g, 71% yield).

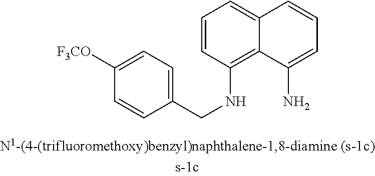 [SMILES: Nc1cccc2cccc(NCc3ccc(OC(F)(F)F)cc3)c12]

Following the above procedure A, s-1c is prepared from 1,8-diaminonaphthalene (1.582 g, 10 mmol) and 4-(trifluoromethoxy)benzyl bromide (0.8 mL, 5 mmol). Purified by silica gel column chromatography (n-Hexane/EA=20/1-7/1), s-1c is obtained as a pink oil (1.219 g, 74% yield).

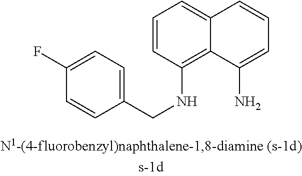 [SMILES: Nc1cccc2cccc(NCc3ccc(F)cc3)c12]

Following the above procedure A, s-1d is prepared from 1,8-diaminonaphthalene (1.582 g, 10 mmol) and 4-fluorobenzyl bromide (0.62 mL, 5 mmol). Purified by silica gel column chromatography (n-Hexane/EA=20/1-5/1), s-1d is obtained as a pink oil (0.976 g, 73% yield).

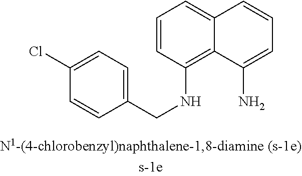 [SMILES: Nc1cccc2cccc(NCc3ccc(Cl)cc3)c12]

Following the above procedure A, s-1e is prepared from 1,8-diaminonaphthalene (1.582 g, 10 mmol) and 4-chlorobenzyl bromide (1.028 g, 5 mmol). Purified by silica gel column chromatography (n-Hexane/EA=20/1-5/1), s-1e is obtained as a pink oil (0.960 g, 68% yield).

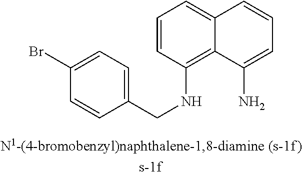 [SMILES: Nc1cccc2cccc(NCc3ccc(Br)cc3)c12]

Following the above procedure A, s-1f is prepared from 1,8-diaminonaphthalene (1.582 g, 10 mmol) and 4-bromobenzyl bromide (1.25 g, 5 mmol). Purified by silica gel column chromatography (n-Hexane/EA=20/1-5/1), s-1f is obtained as a pink oil (1.217 g, 74% yield).

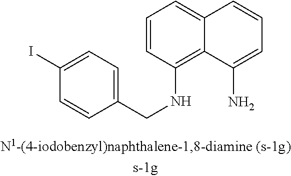 [SMILES: Nc1cccc2cccc(NCc3ccc(I)cc3)c12]

Following the above procedure A, s-1g is prepared from 1,8-diaminonaphthalene (1.898 g, 12 mmol) and 4-iodobenzyl bromide (1.782 g, 6 mmol). Purified by silica gel column chromatography (n-Hexane/EA=20/1-5/1), s-1g is obtained as a pink oil (1.866 g, 83% yield).

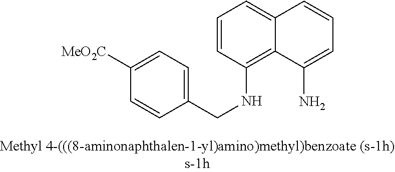 [SMILES: COC(=O)c1ccc(CNc2cccc3cccc(N)c23)cc1]

Following the above procedure A, s-1h is prepared from 1,8-diaminonaphthalene (1.582 g, 10 mmol) and methyl 4-(bromomethyl)benzoate (1.146 g, 5 mmol). Purified by silica gel column chromatography (n-Hexane/EA=10/1-4/1), s-1h is obtained as an orange oil (0.541 g, 35% yield).

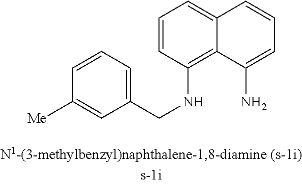 [SMILES: Cc1cccc(CNc2cccc3cccc(N)c23)c1]

Following the above procedure A, s-1i is prepared from 1,8-diaminonaphthalene (1.582 g, 10 mmol) and 3-methylbenzyl bromide (0.68 mL, 5 mmol). Purified by silica gel column chromatography (n-Hexane/EA=20/1-5/1), s-1i is obtained as a pink oil (0.846 g, 64% yield).

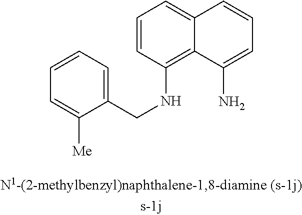 [SMILES: Cc1ccccc1CNc1cccc2cccc(N)c12]

Following the above procedure A, s-1j is prepared from 1,8-diaminonaphthalene (1.582 g, 10 mmol) and 2-methylbenzyl bromide (0.67 mL, 5 mmol). Purified by silica gel column chromatography (n-Hexane/EA=20/1-5/1), s-1j is obtained as a pink oil (1.021 g, 78% yield).

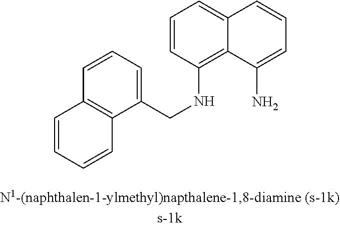 [SMILES: Nc1cccc2cccc(NCc3cccc4ccccc34)c12]

Following the above procedure A, s-1k is prepared from 1,8-diaminonaphthalene (3.164 g, 20 mmol) and 1-(bromomethyl)naphthalene (2.211 g, 10 mmol). Purified by silica gel column chromatography (n-Hexane/EA=15/1-5/1), s-1k is obtained as a pink solid (2.028 g, 68% yield).

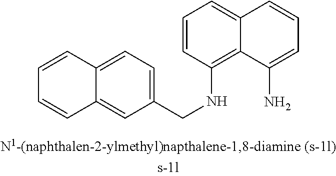 [SMILES: Nc1cccc2cccc(NCc3ccc4ccccc4c3)c12]

Following the above procedure A, s-1l is prepared from 1,8-diaminonaphthalene (1.582 g, 10 mmol) and 2-(bromomethyl)naphthalene (1.106 g, 5 mmol). Purified by silica gel column chromatography (n-Hexane/EA=15/1-5/1), s-1l is obtained as a red solid (0.988 g, 66% yield).

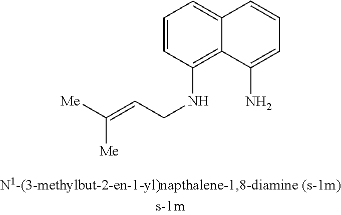 [SMILES: CC(C)=CCNc1cccc2cccc(N)c12]

Following the above procedure A, s-1m is prepared from 1,8-diaminonaphthalene (1.582 g, 10 mmol) and 3,3-dimethylallyl bromide (0.58 mL, 5 mmol). Purified by silica gel column chromatography (n-Hexane/EA=15/1-10/1), s-1m is obtained as a pink oil (0.678 g, 60% yield).

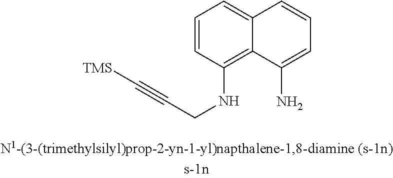 [SMILES: C[Si](C)(C)C#CCNc1cccc2cccc(N)c12]

Following the above procedure A, s-1n is prepared from 1,8-diaminonaphthalene (1.582 g, 10 mmol) and 3-bromo-1-(trimethylsilyl)-1-propyne (0.82 mL, 5 mmol). Purified by silica gel column chromatography (n-Hexane/EA=20/1-7/1), s-1n is obtained as a red solid (0.722 g, 54% yield).

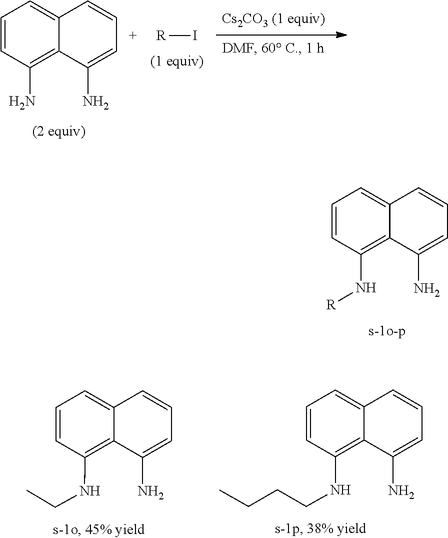

Procedure B: 1,8-Diaminonaphthalene (2 equiv), Cs₂CO₃ (1 equiv), and DMF (0.5 M) are added to a round-bottom flask. The mixture is stirred at rt for 30 minutes. Then, alkyl iodide (1 equiv) is added at rt. The reaction is stirred at 60° C. for 1 hour. After the reaction is completed, the mixture is filtered through a pad of silica gel and washed with EtOAc. The filtrate is concentrated under reduced pressure at 60° C. The residue is purified by silica gel column chromatography to afford unsymmetrically substituted 1,8-diaminonaphthalene product (s-1o-p).

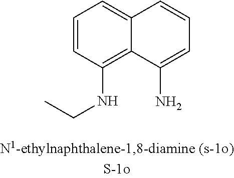

Following the above procedure B, s-1o is prepared from 1,8-diaminonaphthalene (3.164 g, 20 mmol) and iodoethane (0.8 mL, 10 mmol). Purified by silica gel column chromatography (n-Hexane/EA=30/1-10/1), s-1o is obtained as a pink oil (0.834 g, 45% yield).

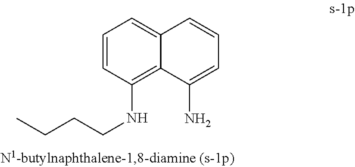 [SMILES: CCCCNc1cccc2cccc(N)c12]

Following the above procedure B, s-1p is prepared from 1,8-diaminonaphthalene (3.164 g, 20 mmol) and 1-iodobutane (1.14 mL, 10 mmol). Purified by silica gel column chromatography (n-Hexane/EA=30/1-10/1), s-1p is obtained as a pink oil (0.810 g, 38% yield).

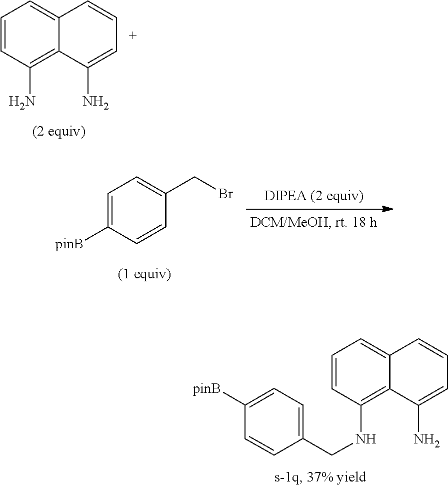

Procedure C: 1,8-Diaminonaphthalene (1.582 g, 10 mmol), DIPEA (1.74 mL, 10 mmol), DCM (25 mL), and MeOH (5 mL) are added to a 100 mL round-bottom flask. Then, 4-(bromomethyl)benzeneboronic acid pinacol ester (1.485 g, 5 mmol) is slowly added at rt. The reaction is stirred at room temperature for 18 hours. After the reaction is completed, the solvent is removed under reduced pressure. The residue is dissolved in EtOAc and washed with H₂O. The aqueous phase is extracted with ethyl acetate three times. The combined organic phase is further washed with brine, dried over Na₂SO₄, filtered, and concentrated under reduced pressure. The residue is purified by silica gel column chromatography (n-Hexane/EA=10/1-5/1) to afford unsymmetrically substituted 1,8-diaminonaphthalene product s-1q.

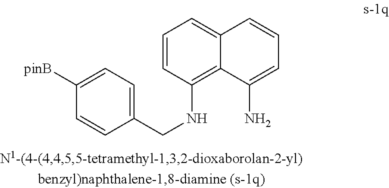

Following the above procedure C, s-1p is obtained as a red solid (0.696 g, 37% yield).

### 1.3 Preparation of Unsymmetrically Substituted Anthranilamide (Aam)

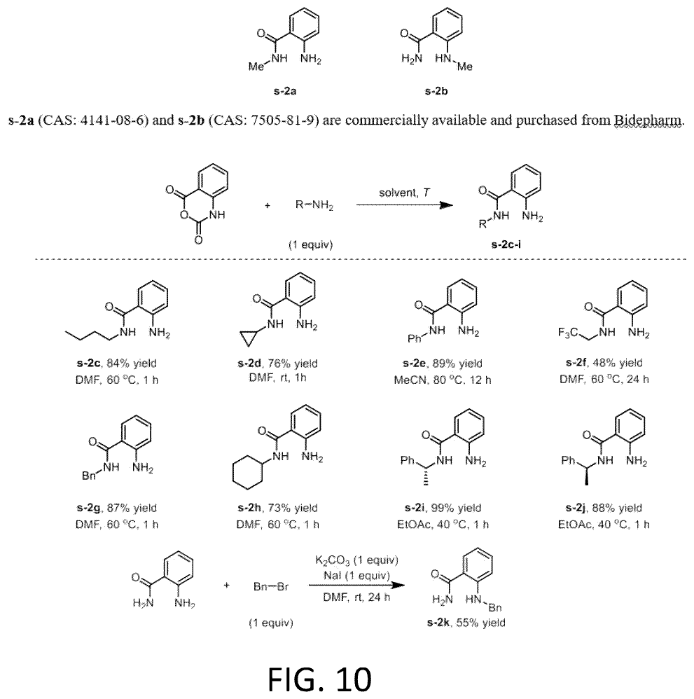

Procedure: Isatoic anhydride (5 mmol), amine (5 mmol), and indicated solvent (10 mL) are added to a 50 mL round-bottom flask. The mixture is stirred at indicated temperature for indicated time. After the reaction is completed, the reaction mixture is quenched with H₂O (10 mL) and EtOAc (10 mL). The layers are separated and the aqueous phase is extracted with EtOAc (3×10 mL). The combined organic phase is washed with brine (2×10 mL) and dried over anhydrous Na₂SO₄, and then filtered. The filtrate is concentrated under reduced pressure and the residue is further purified by silica gel column chromatography to afford unsymmetrically substituted anthranilamide product s-2c-j. See FIG. 10.

### 1.4 Preparation of Alkynyl Bdan Compounds

### Method A: From Normal Terminal Alkynes

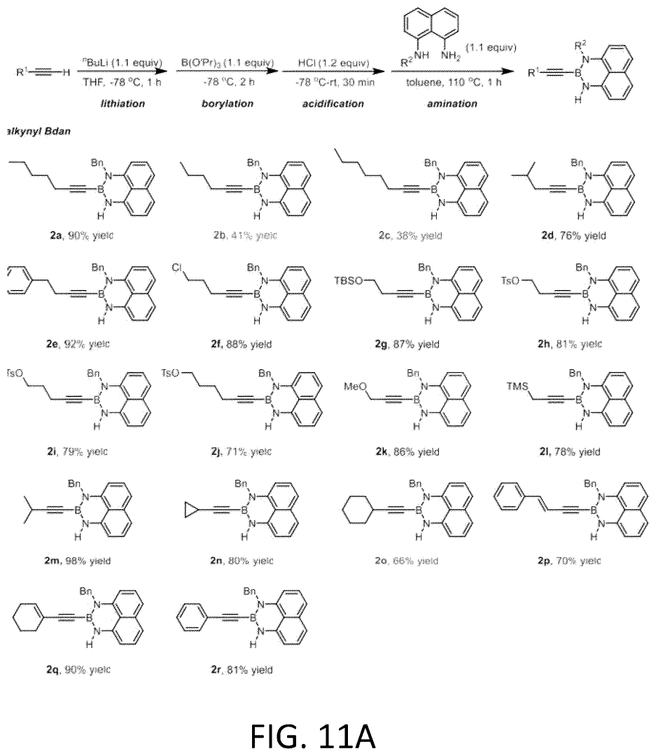

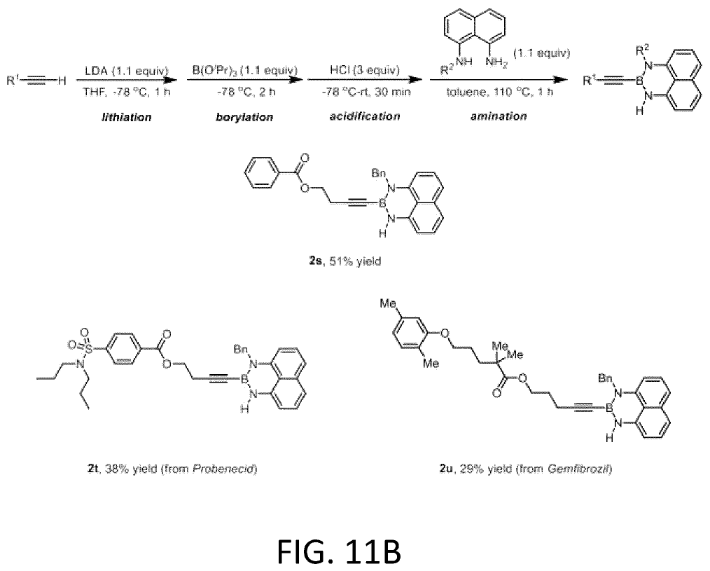

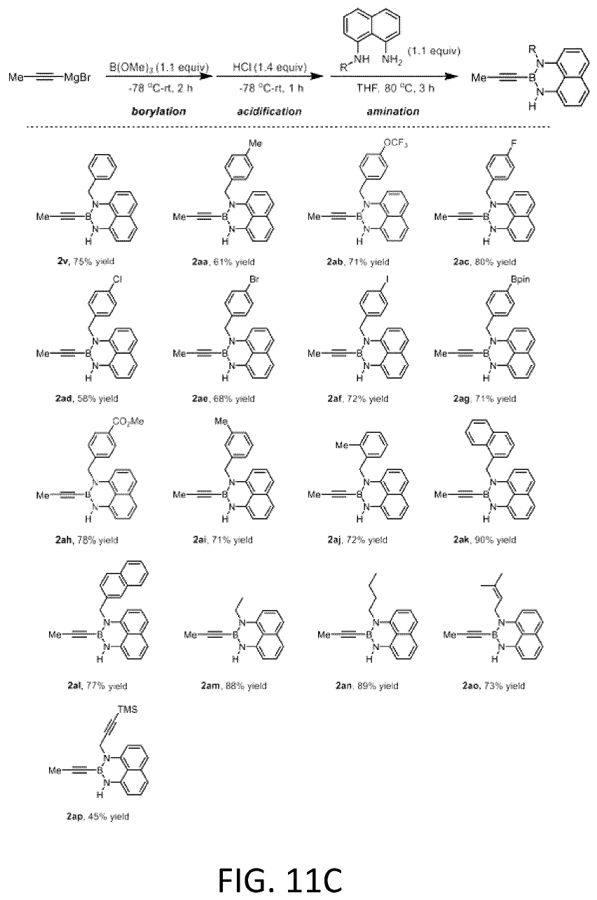

Procedure A: Under nitrogen gas atmosphere, terminal alkyne (5 mmol, 1 equiv) and dry THF (10 mL, 0.5 M) are added by syringe to a flame-dried 100 mL Schlenk flask. The mixture is cooled down to −78° C. and ⁿBulLi (2.2 mL, 2.5 M in hexanes, 1.1 equiv) is added dropwise. Afterwards, the reaction is stirred at −78° C. for 1 hour (step 1, lithiation). Then, triisopropylborate (1.27 mL, 5.5 mmol, 1.1 equiv) is slowly added by syringe to the mixture and the reaction is stirred at −78° C. for 2 hours. A white slurry is formed during this stage, indicating the successful formation of tetra-substituted boron complex (step 2, borylation). Next, HCl solution in diethyl ether (3 mL, 2 M, 1.2 equiv) is slowly added by syringe to the mixture at −78° C. and the reaction is allowed to warm to room temperature with stirring for 30 minutes. The white slurry disappeared and a clear solution is formed during this stage, indicating the successful formation of neutral tri-substituted alkynylboronate (step 3, acidification). After that, the solution is transferred into a 100 mL round-bottom flask (rinsing with diethyl ether) and concentrated under reduced pressure. The residue is dissolved in 10 mL toluene and the solution of unsymmetrically substituted 1,8-diaminonaphthalene (5.5 mmol, 1.1 equiv) in 10 mL toluene is added. The reaction is stirred at 110° C. in an open-flask for 1 hour before TLC of the crude mixture showed full conversion (step 4, amination). The reaction mixture is quenched with H₂O (10 mL) and EtOAc (10 mL). The layers are separated and the organic phase is washed with H₂O twice to remove inorganic salt LiCl. The combined aqueous phase is extracted with EA once. The combined organic phase is further washed with brine, dried over Na₂SO₄, filtered, and concentrated under reduced pressure to afford a crude product, which is purified by silica gel column chromatography or wash with n-Hexane to afford the pure alkynyl Bdan product. The obtained alkynyl Bdan could be stored under air at room temperature for several months without significant degradation. See FIG. 11A.

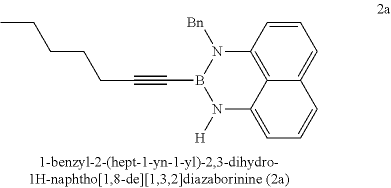 [SMILES: CCCCCC#CB1Nc2cccc3cccc(c23)N1Cc1ccccc1]

Following the above procedure A, 2a is prepared from 1-heptyne (0.68 mL, 5.2 mmol) and s-1a (1.425 g, 5.74 mmol). Purified by silica gel column chromatography (n-Hexane/EA=30/1), 2a is obtained as a purple solid (1.653 g, 90% yield).

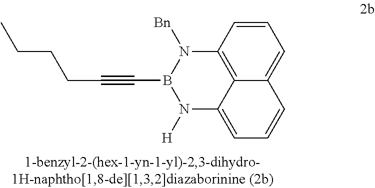 [SMILES: CCCCC#CB1Nc2cccc3cccc(c23)N1Cc1ccccc1]

Following the above procedure A, 2b is prepared from 1-hexyne (0.57 mL, 5 mmol) and s-1a (5.5 mmol). Purified by silica gel column chromatography (n-Hexane/EA=30/1), 2b is obtained as a purple solid.

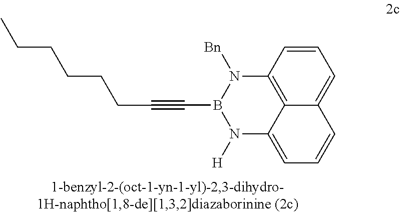 [SMILES: CCCCCCC#CB1Nc2cccc3cccc(c23)N1Cc1ccccc1]

Following the above procedure A, 2c is prepared from 1-octyne (1.08 mL, 6 mmol) and s-1a (6.6 mmol). Purified by silica gel column chromatography (n-Hexane/EA=30/1), 2c is obtained as a purple solid.

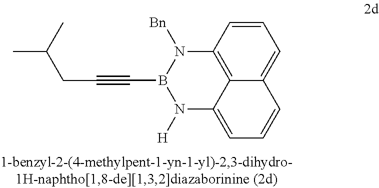 [SMILES: CC(C)CC#CB1Nc2cccc3cccc(c23)N1Cc1ccccc1]

Following the above procedure A, 2d is prepared from 4-methyl-1-pentyne (0.48 mL, 4.1 mmol) and s-1a (1.117 g, 4.5 mmol). Purified by silica gel column chromatography (n-Hexane/EA=30/1), 2d is obtained as a purple solid (1.053 g, 76% yield).

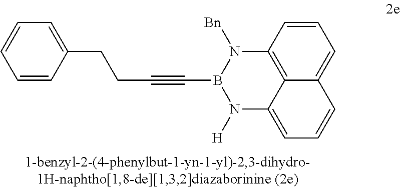 [SMILES: C(#CB1Nc2cccc3cccc(c23)N1Cc1ccccc1)CCc1ccccc1]

Following the above procedure A, 2e is prepared from 4-phenyl-1-butyne (0.65 mL, 4.6 mmol) and s-1a (1.266 g, 5.1 mmol). Purified by silica gel column chromatography (n-Hexane/EA=30/1), 2e is obtained as a purple solid (1.633 g, 92% yield).

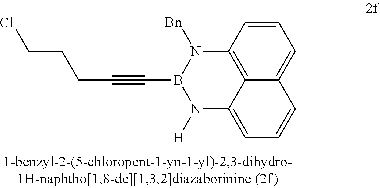 [SMILES: ClCCCC#CB1Nc2cccc3cccc(c23)N1Cc1ccccc1]

Following the above procedure A, 2f is prepared from 5-chloro-1-pentyne (0.64 mL, 6 mmol) and s-1a (1.639 g, 6.6 mmol). Purified by wash of crude product with n-Hexane, 2f is obtained as a pink solid (1.904 g, 88% yield).

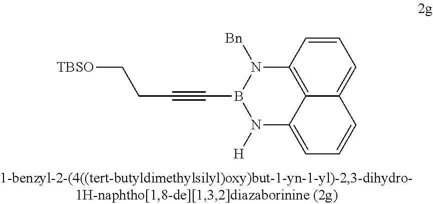 [SMILES: CC(C)(C)[Si](C)(C)OCCC#CB1Nc2cccc3cccc(c23)N1Cc1ccccc1]

Following the above procedure A, 2g is prepared from 4-(tert-butyldimethylsilyloxy)-1-butyne (0.83 mL, 4 mmol) and s-1a (1.093 g, 4.4 mmol). Purified by silica gel column chromatography (n-Hexane/EA=30/1), 2g is obtained as a pink oil (1.527 g, 87% yield).

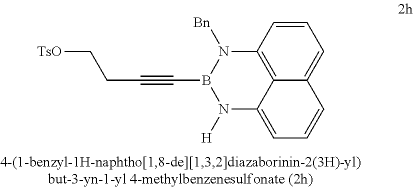 [SMILES: Cc1ccc(S(=O)(=O)OCCC#CB2Nc3cccc4cccc(c34)N2Cc2ccccc2)cc1]

Following the above procedure A, 2h is prepared from but-3-yn-1-yl 4-methylbenzenesulfonate (1.750 g, 7.8 mmol) and s-1a (2.135 g, 8.6 mmol). Purified by silica gel column chromatography (n-Hexane/EA=3/1), 2h is obtained as a pink solid (3.019 g, 81% yield).

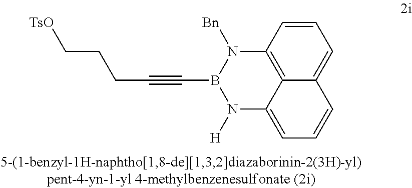 [SMILES: Cc1ccc(S(=O)(=O)OCCCC#CB2Nc3cccc4cccc(c34)N2Cc2ccccc2)cc1]

Following the above procedure A, 2i is prepared from pent-4-yn-1-yl 4-methylbenzenesulfonate (2.264 g, 9.5 mmol) and s-1a (2.607 g, 10.5 mmol). Purified by silica gel column chromatography (n-Hexane/EA=3/1), 2i is obtained as a pink solid (3.701 g, 79% yield).

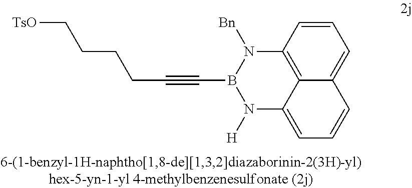 [SMILES: Cc1ccc(S(=O)(=O)OCCCCC#CB2Nc3cccc4cccc(c34)N2Cc2ccccc2)cc1]

Following the above procedure A, 2j is prepared from hex-5-yn-1-yl 4-methylbenzenesulfonate (1.153 g, 4.6 mmol) and s-1a (1.242 g, 5.0 mmol). Purified by silica gel column chromatography (n-Hexane/EA=3/1), 2j is obtained as a pink solid (1.658 g, 71% yield).

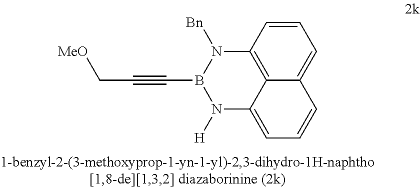 [SMILES: COCC#CB1Nc2cccc3cccc(c23)N1Cc1ccccc1]

Following the above procedure A, 2k is prepared from methyl propargyl ether (0.32 mL, 3.8 mmol) and s-1a (1.018 g, 4.1 mmol). Purified by silica gel column chromatography (n-Hexane/EA=10/1-5/1), 2k is obtained as a pink solid (1.051 g, 86% yield).

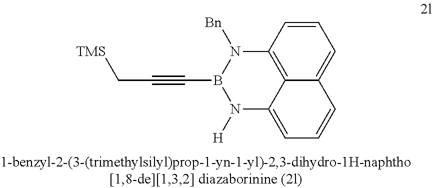 [SMILES: C[Si](C)(C)CC#CB1Nc2cccc3cccc(c23)N1Cc1ccccc1]

Following the above procedure A, 2l is prepared from propargyltrimethylsilane (0.65 mL, 4 mmol) and s-1a (1.093 g, 4.4 mmol). Purified by silica gel column chromatography (n-Hexane/EA=50/1-20/1), 2l is obtained as a black solid (1.145 g, 78% yield).

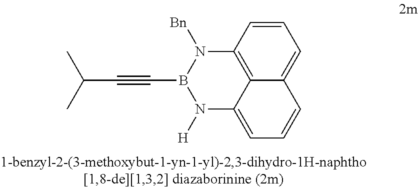 [SMILES: CC(C)C#CB1Nc2cccc3cccc(c23)N1Cc1ccccc1]

Following the above procedure A, 2m is prepared from 3-methyl-1-butyne (0.54 mL, 5.3 mmol) and s-1a (1.440 g, 5.8 mmol). Purified by silica gel column chromatography (n-Hexane/EA=40/1-20/1), 2m is obtained as a pink solid (1.686 g, 98% yield).

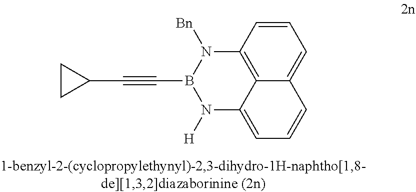 [SMILES: C(#CC1CC1)B1Nc2cccc3cccc(c23)N1Cc1ccccc1]

Following the above procedure A, 2n is prepared from cyclopropylacetylene (0.36 mL, 4.2 mmol) and s-1a (1.142 g, 4.6 mmol). Purified by silica gel column chromatography (n-Hexane/EA=40/1), 2n is obtained as a purple solid (1.086 g, 80% yield).

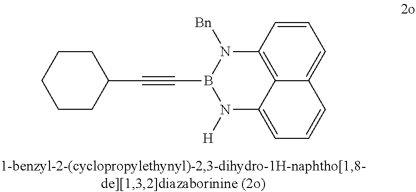 [SMILES: C(#CC1CCCCC1)B1Nc2cccc3cccc(c23)N1Cc1ccccc1]

Following the above procedure A, 2o is prepared from cyclohexylacetylene (0.78 mL, 6 mmol) and s-1a (1.638 g, 6.6 mmol). Purified by silica gel column chromatography (n-Hexane/EA=40/1-20/1), 2o is obtained as a pink solid (1.435 g, 66% yield).

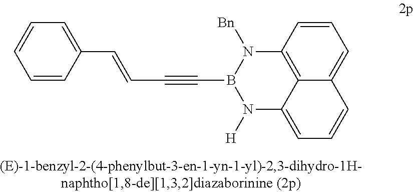 [SMILES: C(#CB1Nc2cccc3cccc(c23)N1Cc1ccccc1)/C=C/c1ccccc1]

Following the above procedure A, 2p is prepared from (E)-but-1-en-3-yn-1-ylbenzene (1.256 g, 9.8 mmol) and s-1a (2.682 g, 10.8 mmol). Purified by silica gel column chromatography (n-Hexane/EA/DCM=20/1/1), 2p is obtained as an orange solid (2.625 g, 70% yield).

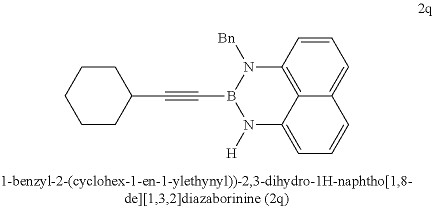 [SMILES: C(#CC1CCCCC1)B1Nc2cccc3cccc(c23)N1Cc1ccccc1]

Following the above procedure A, 2q is prepared from 1-ethynylcyclohexene (0.58 mL, 4.9 mmol) and s-1a (1.341 g, 5.4 mmol). Purified by silica gel column chromatography (n-Hexane/EA=40/1-20/1), 2q is obtained as a pink solid (1.596 g, 90% yield).

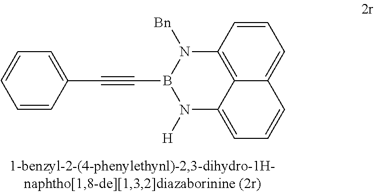 [SMILES: C(#Cc1ccccc1)B1Nc2cccc3cccc(c23)N1Cc1ccccc1]

Following the above procedure A, 2r is prepared from phenylacetylene (0.44 mL, 4 mmol) and s-1a (1.093 g, 4.4 mmol). Purified by silica gel column chromatography (n-Hexane/EA=15/1-12/1), 2r is obtained as a pink solid (1.158 g, 81% yield).

### Method B: From Terminal Alkynes Bearing Sensitive Functionalities

Procedure B: Under nitrogen gas atmosphere, terminal alkyne (4.5 mmol, 1 equiv) and dry THF (9 mL, 0.5 M) are added by syringe to a flame-dried 100 mL Schlenk flask. The mixture is cooled down to −78° C. and LDA (2.5 mL, 2 M in THF/hexanes, 1.1 equiv) is added dropwise. Afterwards, the reaction is stirred at −78° C. for 1 hour (step 1, lithiation). Then, triisopropylborate (1.16 mL, 5 mmol, 1.1 equiv) is slowly added by syringe to the mixture and the reaction is stirred at −78° C. for 2 hours. A yellow slurry is formed during this stage, indicating the successful formation of tetra-substituted boron complex (step 2, borylation). Next, HCl solution in diethyl ether (6.75 mL, 2 M, 3 equiv) is slowly added by syringe to the mixture at −78° C. and the reaction is allowed to warm to room temperature with stirring for 30 minutes. In this procedure, the yellow slurry still presented because of the generation of insolvable ammonium salt ⁱPr₂NH·HCl (step 3, acidification). After that, the solution is filtered through a pad of celite to remove large amount of ammonium salt ⁱPr₂NH·HCl and the filtrate is concentrated under reduced pressure. The residue is suspended in diethyl ether and the suspension is further filtered through a pad of celite to remove remaining ammonium salt ⁱPr₂NH·HCl and inorganic salt LiCl. The filtrate is concentrated under reduced pressure and transferred into a 100 mL round-bottom flask. The residue is dissolved in 10 mL toluene and the solution of unsymmetrically substituted 1,8-diaminonaphthalene (5 mmol, 1.1 equiv) in 10 mL toluene is added. The reaction is stirred at 110° C. in an open-flask for 1 hour before TLC of the crude mixture showed full conversion (step 4, amination). The reaction mixture is quenched with H₂O (10 mL) and EtOAc (10 mL). The layers are separated and the organic phase is washed with H₂O twice. The combined aqueous phase is extracted with EA once. The combined organic phase is further washed with brine, dried over Na₂SO₄, filtered, and concentrated under reduced pressure to afford a crude product, which is purified by silica gel column chromatography to afford the pure alkynyl Bdan product. The obtained alkynyl Bdan could be stored under air at room temperature for several months without significant degradation. See FIG. 11B.

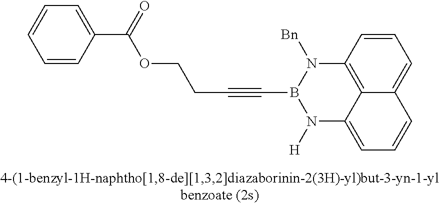 [SMILES: O=C(OCCC#CB1Nc2cccc3cccc(c23)N1Cc1ccccc1)c1ccccc1]

Following the above procedure B, 2s is prepared from but-3-yn-1-yl benzoate (0.784 g, 4.5 mmol) and s-1a (1.242 g, 5 mmol). Purified by silica gel column chromatography (n-Hexane/EA=15/1-7/1), 2s is obtained as a pink solid (0.985 g, 51% yield).

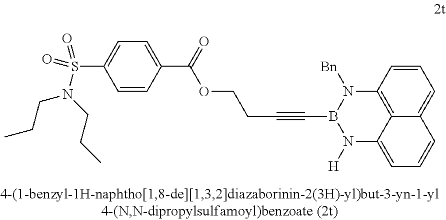 [SMILES: CCCN(CCC)S(=O)(=O)c1ccc(C(=O)OCCC#CB2Nc3cccc4cccc(c34)N2Cc2ccccc2)cc1]

2t is derived from Probenecid. First, alkyne-2t is prepared according to the literature¹⁴.

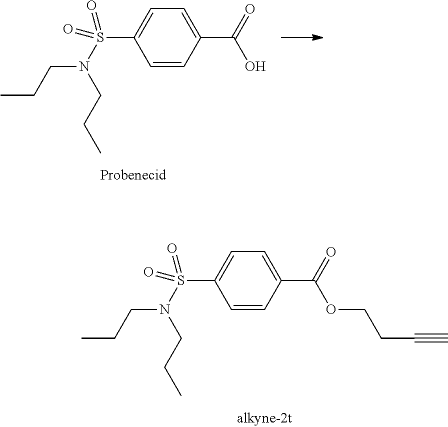 [SMILES: CCCN(CCC)S(=O)(=O)c1ccc(C(=O)O)cc1 ; C#CCCOC(=O)c1ccc(S(=O)(=O)N(CCC)CCC)cc1]

Then, following the above procedure B, 2t is prepared from alkyne-2t (1.123 g, 3.3 mmol) and s-1a (0.901 g, 3.6 mmol). Purified by silica gel column chromatography (n-Hexane/EA=5/1-2/1), 2t is obtained as a white solid (0.752 g, 38% yield).

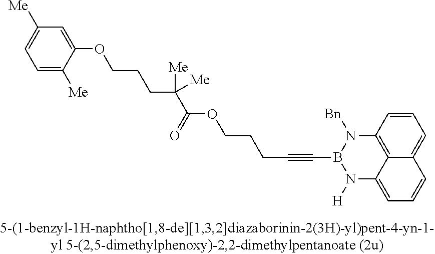 [SMILES: Cc1ccc(C)c(OCCCC(C)(C)C(=O)OCCCC#CB2Nc3cccc4cccc(c34)N2Cc2ccccc2)c1]

2u is derived from Gemfibrozil. First, alkyne-2u is prepared.

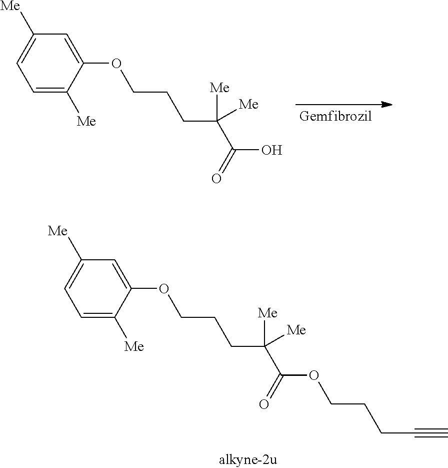 [SMILES: Cc1ccc(C)c(OCCCC(C)(C)C(=O)O)c1 ; C#CCCCOC(=O)C(C)(C)CCCOc1cc(C)ccc1C]

Then, following the above procedure B, 2u is prepared from alkyne-2u (0.814 g, 2.57 mmol) and s-1a (0.703 g, 2.83 mmol). Purified by silica gel column chromatography (n-Hexane/EA=20/1-10/1), 2u is obtained as a pink oil (0.420 g, 29% yield).

### Method C: From Grignard Reagent

Procedure C: Under nitrogen gas atmosphere, trimethyl borate (0.63 mL, 5.5 mmol, 1.1 equiv) and dry THF (10 mL, 0.5 M) are added by syringe to a flame-dried 50 mL Schlenk flask. The mixture is cooled down to −78° C. and 1-propynylmagnesium bromide (10 mL, 0.5 M in THF, 1 equiv) is added dropwise. Afterwards, the reaction is allowed to warm to room temperature with stirring for 2 hours. A white slurry is formed during this stage, indicating the successful formation of tetra-substituted boron complex (step 1, borylation). Next, the mixture is again cooled down to −78° C. and HCl solution in diethyl ether (3.5 mL, 2 M, 1.4 equiv) is slowly added by syringe. The reaction is allowed to warm to room temperature with stirring for 1 hour. The white slurry disappeared and a clear solution is formed during this stage, indicating the successful formation of neutral tri-substituted alkynylboronate (step 2, acklification). After that, the stopper is removed and the solution of unsymmetrically substituted 1,8-diaminonaphthalene (5.5 mmol, 1.1 equiv) in 5 mL THF is added. The reaction is stirred at 80° C. in the opened Schlenk flask for 3 hours before TLC of the crude mixture showed full conversion (step 3, amination). The reaction mixture is quenched with H₂O (10 mL) and EtOAc (10 mL). The layers are separated and the organic phase is washed with H₂O twice to remove inorganic salts MgCl₂, MgBr₂. The combined aqueous phase is extracted with EA once. The combined organic phase is further washed with brine, dried over Na₂SO₄, filtered, and concentrated under reduced pressure to afford a crude product, which is purified by silica gel column chromatography or wash with n-Hexane to afford the pure alkynyl Bdan product. The obtained alkynyl Bdan could be stored under air at room temperature for several months without significant degradation. See FIG. 11C.

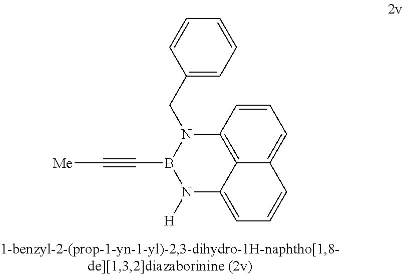 [SMILES: CC#CB1Nc2cccc3cccc(c23)N1Cc1ccccc1]

Following the above procedure C, 2v is prepared from 1-propynylmagnesium bromide (20 mL, 10 mmol) and s-1a (2.731 g, 11 mmol). Purified by wash with n-Hexane, 2v is obtained as a pink solid (2.232 g, 75% yield).

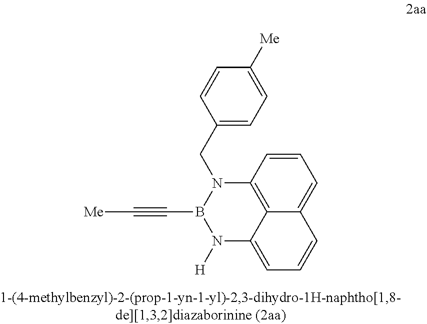 [SMILES: CC#CB1Nc2cccc3cccc(c23)N1Cc1ccc(C)cc1]

Following the above procedure C, 2aa is prepared from 1-propynylmagnesium bromide (7.4 mL, 3.7 mmol) and s-1b (1.076 g, 4.1 mmol). Purified by wash with n-Hexane, 2aa is obtained as a pink solid (0.700 g, 61% yield).

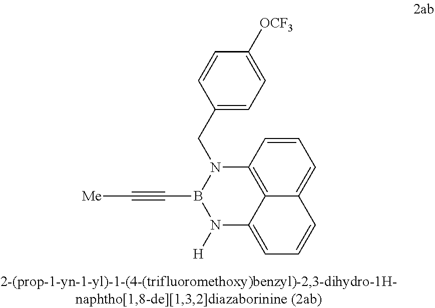 [SMILES: CC#CB1Nc2cccc3cccc(c23)N1Cc1ccc(OC(F)(F)F)cc1]

Following the above procedure C, 2ab is prepared from 1-propynylmagnesium bromide (6.6 mL, 3.3 mmol) and s-1c (1.196 g, 3.6 mmol). Purified by wash with n-Hexane, 2ab is obtained as a pink solid (0.887 g, 71% yield).

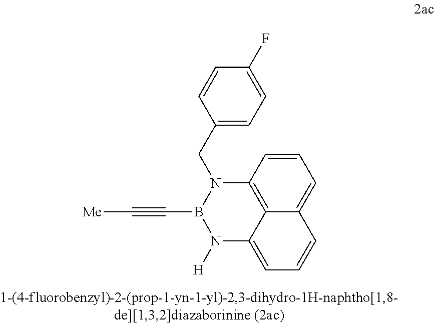 [SMILES: CC#CB1Nc2cccc3cccc(c23)N1Cc1ccc(F)cc1]

Following the above procedure C, 2ac is prepared from 1-propynylmagnesium bromide (6.6 mL, 3.3 mmol) and s-1d (0.959 g, 3.6 mmol). Purified by wash with n-Hexane, 2ac is obtained as a pink solid (0.826 g, 80% yield).

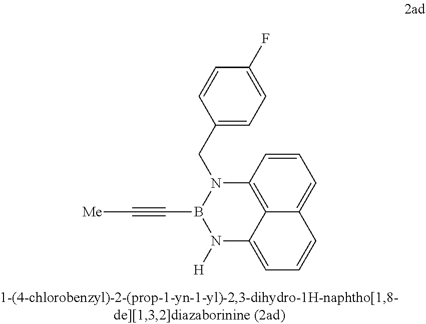 [SMILES: CC#CB1Nc2cccc3cccc(c23)N1Cc1ccc(F)cc1]

Following the above procedure C, 2ad is prepared from 1-propynylmagnesium bromide (6 mL, 3 mmol) and s-1e (0.933 g, 3.3 mmol). Purified by wash with n-Hexane, 2ad is obtained as a pink solid (0.571 g, 58% yield).

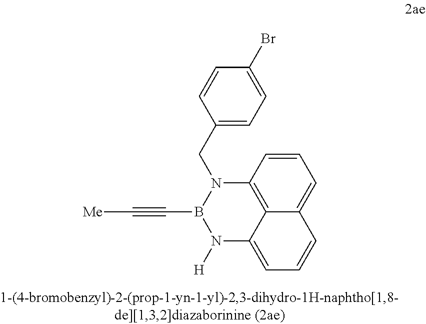 [SMILES: CC#CB1Nc2cccc3cccc(c23)N1Cc1ccc(Br)cc1]

Following the above procedure C, 2ae is prepared from 1-propynylmagnesium bromide (6.6 mL, 3.3 mmol) and s-1f (1.178 g, 3.6 mmol). Purified by wash with n-Hexane, 2ae is obtained as a pink solid (0.836 g, 68% yield).

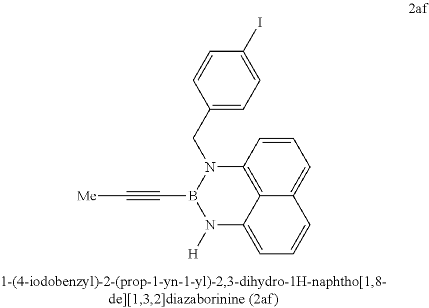 [SMILES: CC#CB1Nc2cccc3cccc(c23)N1Cc1ccc(I)cc1]

Following the above procedure C, 2af is prepared from 1-propynylmagnesium bromide (8.9 mL, 4.45 mmol) and s-1g (1.834 g, 4.9 mmol). Purified by wash with n-Hexane, 2af is obtained as a pink solid (1.343 g, 72% yield).

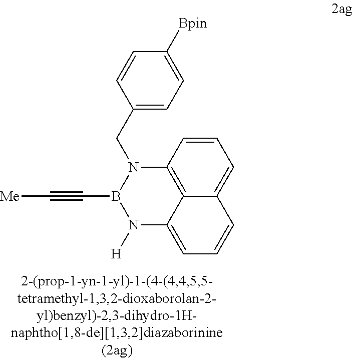

Following the above procedure C, 2ag is prepared from 1-propynylmagnesium bromide (4.7 mL, 2.35 mmol) and s-1q (0.973 g, 2.6 mmol). Purified by wash with n-Hexane, 2ag is obtained as a pink solid (0.712 g, 71% yield).

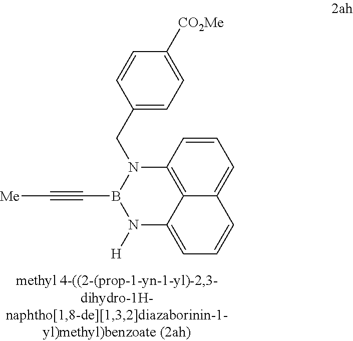 [SMILES: CC#CB1Nc2cccc3cccc(c23)N1Cc1ccc(C(=O)OC)cc1]

Following the above procedure C, 2ah is prepared from 1-propynylmagnesium bromide (3.2 mL, 1.6 mmol) and s-1h (0.539 g, 1.76 mmol). Purified by wash with n-Hexane, 2ah is obtained as an orange solid (0.445 g, 78% yield).

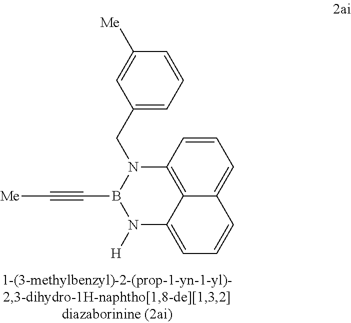 [SMILES: CC#CB1Nc2cccc3cccc(c23)N1Cc1cccc(C)c1]

Following the above procedure C, 2ai is prepared from 1-propynylmagnesium bromide (5.8 mL, 2.9 mmol) and s-1i (0.840 g, 3.2 mmol). Purified by wash with n-Hexane, 2ai is obtained as a purple solid (0.638 g, 71% yield).

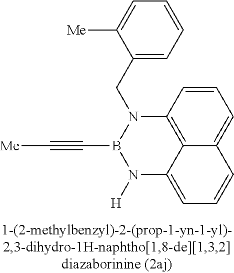 [SMILES: CC#CB1Nc2cccc3cccc(c23)N1Cc1ccccc1C]

Following the above procedure C, 2aj is prepared from 1-propynylmagnesium bromide (7.1 mL, 3.55 mmol) and s-1j (1.023 g, 3.9 mmol). Purified by wash with n-Hexane, 2aj is obtained as a pink solid (0.789 g, 72% yield).

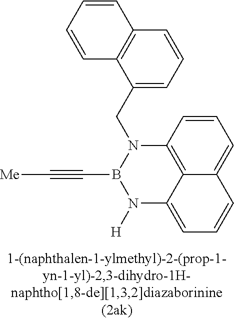 [SMILES: CC#CB1Nc2cccc3cccc(c23)N1Cc1cccc2ccccc12]

Following the above procedure C, 2ak is prepared from 1-propynylmagnesium bromide (6 mL, 3 mmol) and s-1k (0.985 g, 3.3 mmol). Purified by wash with n-Hexane, 2ak is obtained as a pink solid (0.933 g, 90% yield).

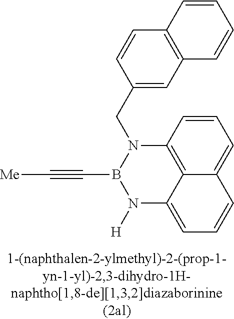 [SMILES: CC#CB1Nc2cccc3cccc(c23)N1Cc1ccc2ccccc2c1]

Following the above procedure C, 2al is prepared from 1-propynylmagnesium bromide (6 mL, 3 mmol) and s-1l (0.985 g, 3.3 mmol). Purified by wash with n-Hexane, 2al is obtained as a pink solid (0.804 g, 77% yield).

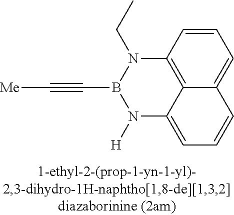 [SMILES: CC#CB1Nc2cccc3cccc(c23)N1CC]

Following the above procedure C, 2am is prepared from 1-propynylmagnesium bromide (6 mL, 3 mmol) and s-1o (0.615 g, 3.3 mmol). Purified by silica gel column chromatography (n-Hexane/EA=40/1), 2am is obtained as a pink solid (0.617 g, 88% yield).

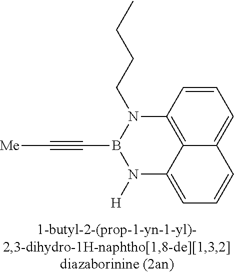 [SMILES: CC#CB1Nc2cccc3cccc(c23)N1CCCC]

Following the above procedure C, 2an is prepared from 1-propynylmagnesium bromide (4.2 mL, 2.1 mmol) and s-1p (0.493 g, 2.3 mmol). Purified by silica gel column chromatography (n-Hexane/EA=40/1), 2an is obtained as a pink solid (0.491 g, 89% yield).

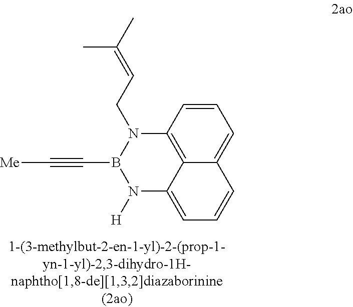 [SMILES: CC#CB1Nc2cccc3cccc(c23)N1CC=C(C)C]

Following the above procedure C, 2ao is prepared from 1-propynylmagnesium bromide (5.4 mL, 2.7 mmol) and s-1m (0.679 g, 3 mmol). Purified by silica gel column chromatography (n-Hexane/EA=40/1), 2ao is obtained as a pink solid (0.539 g, 73% yield).

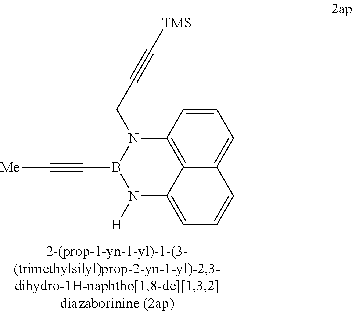 [SMILES: CC#CB1Nc2cccc3cccc(c23)N1CC#C[Si](C)(C)C]

Following the above procedure C, 2ap is prepared from 1-propynylmagnesium bromide (4.6 mL, 2.3 mmol) and s-1m (0.676 g, 2.5 mmol). Purified by silica gel column chromatography (n-Hexane/EA=40/1), 2ap is obtained as a pink solid (0.330 g, 45% yield).

### 1.5 Preparation of Alkynl Baam Compounds

### Method A: From Normal Terminal Alkynes

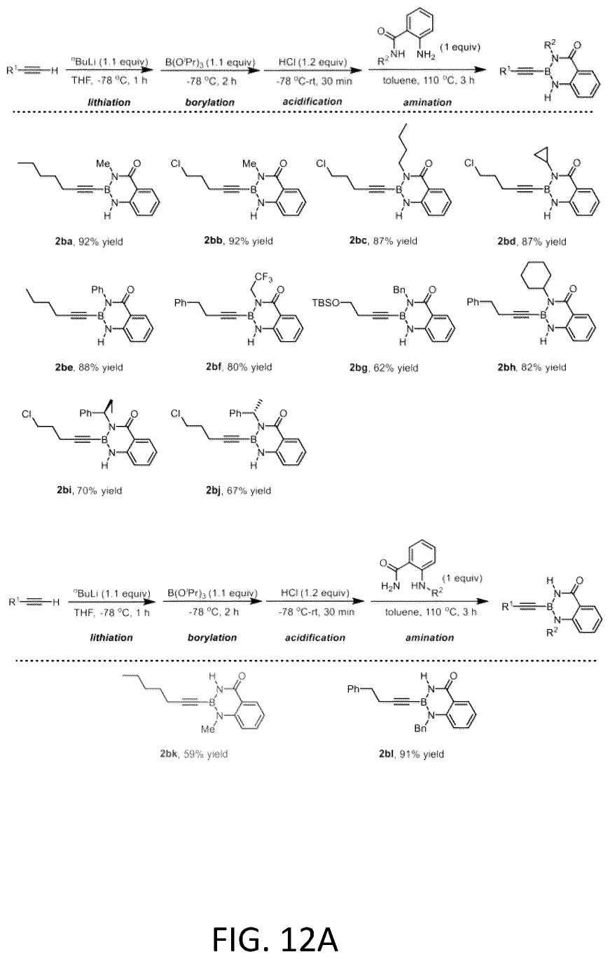

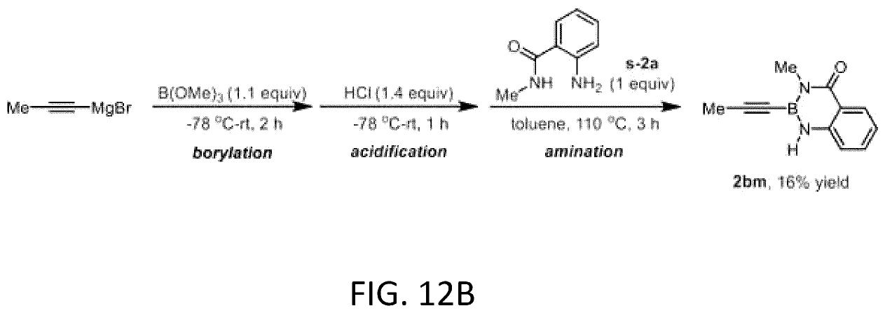

Procedure A: Under nitrogen gas atmosphere, terminal alkyne (5 mmol, 1 equiv) and dry THF (10 mL, 0.5 M) are added by syringe to a flame-dried 100 mL Schlenk flask. The mixture is cooled down to −78° C. and ⁿBuli (2.2 mL, 2.5 M in hexanes, 1.1 equiv) is added dropwise. Afterwards, the reaction is stirred at −78° C. for 1 hour (step 1, lithiation). Then, triisopropylborate (1.27 mL, 5.5 mmol, 1.1 equiv) is slowly added by syringe to the mixture and the reaction is stirred at −78° C. for 2 hours. A white slurry is formed during this stage, indicating the successful formation of tetra-substituted boron complex (step 2, borylation). Next, HCl solution in diethyl ether (3 mL, 2 M, 1.2 equiv) is slowly added by syringe to the mixture at −78° C. and the reaction is allowed to warm to room temperature with stirring for 30 minutes. The white slurry disappeared and a clear solution is formed during this stage, indicating the successful formation of neutral tri-substituted alkynylboronate (step 3, acidification). After that, the solution is transferred into a 100 mL round-bottom flask (rinsing with diethyl ether) and concentrated under reduced pressure. The residue is dissolved in 20 mL toluene and unsymmetrically substituted anthranilamide (5 mmol, 1 equiv) is added. The reaction is stirred at 110° C. in an open-flask for 3 hours before TLC of the crude mixture showed full conversion (step 4, amination). The reaction mixture is quenched with H₂O (10 mL) and EtOAc (10 mL). The layers are separated and the organic phase is washed with H₂O twice to remove inorganic salt LiCl. The combined aqueous phase is extracted with EA once. The combined organic phase is further washed with brine, dried over Na₂SO₄, filtered, and concentrated under reduced pressure to afford a crude product, which is purified by recrystallization or flash column chromatography to afford the pure alkynyl Baam product. The obtained alkynyl Baam could be stored under air at room temperature for several months without significant degradation. See FIG. 12A.

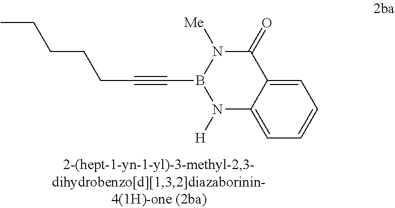 [SMILES: CCCCCC#CB1Nc2ccccc2C(=O)N1C]

Following the above procedure A, 2ba is prepared from 1-heptyne (0.66 mL, 5 mmol) and s-2a (0.751 g, 5 mmol). Purified by recrystallization from toluene (4 mL), 2ba is obtained as a white solid (1.167 g, 92% yield).

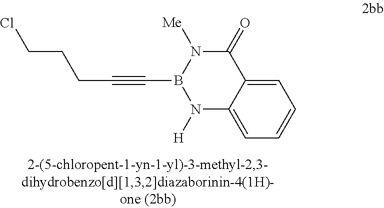 [SMILES: CN1B(C#CCCCCl)Nc2ccccc2C1=O]

Following the above procedure A, 2bb is prepared from 5-chloro-1-pentyne (0.64 mL, 6 mmol) and s-2a (0.9 g, 6 mmol). Purified by recrystallization from toluene (4 mL), 2bb is obtained as a white solid (1.431 g, 92% yield).

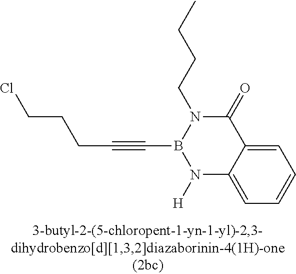 [SMILES: CCCCN1B(C#CCCCCl)Nc2ccccc2C1=O]

Following the above procedure A, 2bc is prepared from 5-chloro-1-pentyne (0.45 mL, 4.2 mmol) and s-2c (0.808 g, 4.2 mmol). Purified by recrystallization from toluene (2 mL), 2bc is obtained as a white solid (1.103 g, 87% yield).

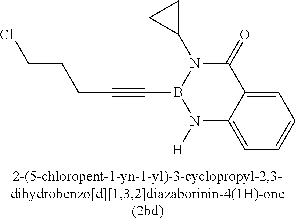 [SMILES: O=C1c2ccccc2NB(C#CCCCCl)N1C1CC1]

Following the above procedure A, 2bd is prepared from 5-chloro-1-pentyne (0.40 mL, 3.8 mmol) and s-2d (0.670 g, 3.8 mmol). Purified by recrystallization from toluene (4 mL), 2bd is obtained as a white solid (0.951 g, 87% yield).
R_{f}=0.38 (silica gel, n-Hexane/EA=3/1)

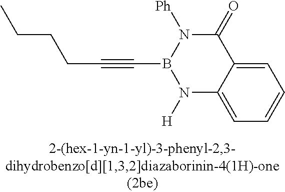 [SMILES: CCCCC#CB1Nc2ccccc2C(=O)N1c1ccccc1]

Following the above procedure A, 2be is prepared from 1-hexyne (0.46 mL, 4 mmol) and s-2e (0.849 g, 4 mmol). Purified by recrystallization from toluene (10 mL), 2be is obtained as a pale yellow solid (1.060 g, 88% yield).

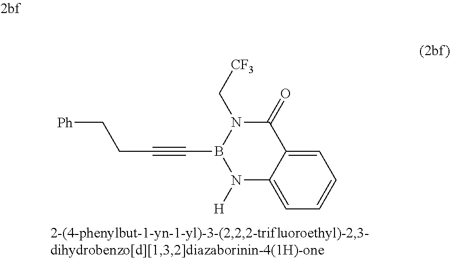 [SMILES: O=C1c2ccccc2NB(C#CCCc2ccccc2)N1CC(F)(F)F]

Following the above procedure A, 2bf is prepared from 4-phenyl-1-butyne (0.34 mL, 2.4 mmol) and s-2f (0.524 g, 2.4 mmol). Purified by recrystallization from toluene (4 mL), 2bf is obtained as a white solid (0.686 g, 80% yield).

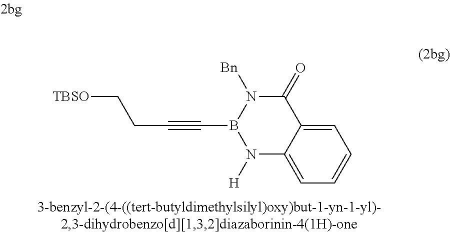 [SMILES: CC(C)(C)[Si](C)(C)OCCC#CB1Nc2ccccc2C(=O)N1Cc1ccccc1]

Following the above procedure A, 2bg is prepared from 4-(tert-butyldimethylsilyloxy)-1-butyne (0.89 mL, 4.3 mmol) and s-2g (0.973 g, 4.3 mmol). Purified by flash column chromatography (n-Hexane/EA=5/1), 2bg is obtained as a white solid (1.116 g, 62% yield).

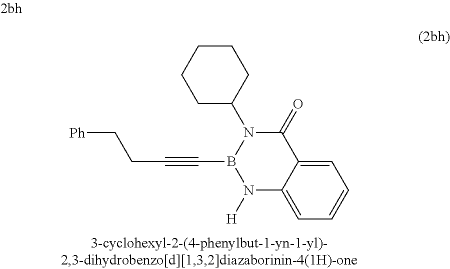 [SMILES: O=C1c2ccccc2NB(C#CCCc2ccccc2)N1C1CCCCC1]

Following the above procedure A, 2bh is prepared from 4-phenyl-1-butyne (0.46 mL, 3.3 mmol) and s-2h (0.786 g, 3.6 mmol). Purified by flash column chromatography (n-Hexane/EA=5/1), 2bh is obtained as a white solid (0.960 g, 82% yield).

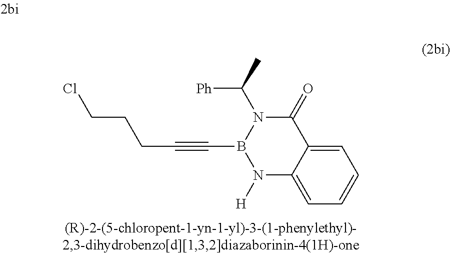 [SMILES: C[C@H](c1ccccc1)N1B(C#CCCCCl)Nc2ccccc2C1=O]

Following the above procedure A, 2bi is prepared from 5-chloro-1-pentyne (0.42 mL, 4 mmol) and s-2i (0.961 g, 4 mmol). Purified by flash column chromatography (n-Hexane/EA=10/1-5/1), 2bi is obtained as a white foam (0.986 g, 70% yield).

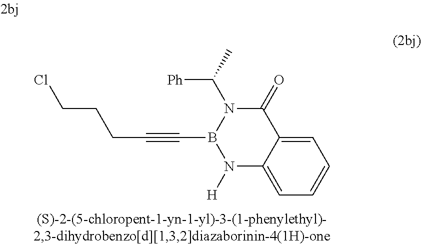 [SMILES: C[C@@H](c1ccccc1)N1B(C#CCCCCl)Nc2ccccc2C1=O]

Following the above procedure A, 2bj is prepared from 5-chloro-1-pentyne (0.47 mL, 4.4 mmol) and s-2j (1.057 g, 4.4 mmol). Purified by flash column chromatography (n-Hexane/EA=10/1-5/1), 2bj is obtained as a white foam (1.033 g, 67% yield).

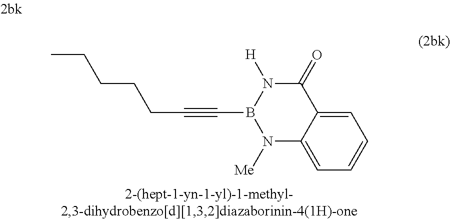 [SMILES: CCCCCC#CB1NC(=O)c2ccccc2N1C]

Following the above procedure A, 2bk is prepared from 1-heptyne (0.66 mL, 5 mmol) and s-2b (0.751 g, 5 mmol). Purified by recrystallization from toluene, 2bk is obtained as a white solid.

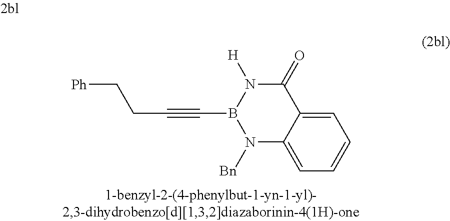 [SMILES: O=C1NB(C#CCCc2ccccc2)N(Cc2ccccc2)c2ccccc21]

Following the above procedure A, 2bl is prepared from 4-phenyl-1-butyne (0.38 mL, 2.7 mmol) and s-2k (0.611 g, 2.7 mmol). Purified by recrystallization from toluene (4 mL), 2bl is obtained as a white solid (0.892 g, 91% yield).

### Method B: From Grignard Reagent

Procedure B: Under nitrogen gas atmosphere, trimethyl borate (0.5 mL, 4.4 mmol, 1.1 equiv) and dry THF (8 mL, 0.5 M) are added by syringe to a flame-dried 50 mL Schlenk flask. The mixture is cooled down to −78° C. and 1-propynylmagnesium bromide (8 mL, 0.5 M in THF, 1 equiv) is added dropwise. Afterwards, the reaction is allowed to warm to room temperature with stirring for 2 hours. A white slurry is formed during this stage, indicating the successful formation of tetra-substituted boron complex (step 1, borylation). Next, the mixture is again cooled down to −78° C. and HCl solution in diethyl ether (2.8 mL, 2 M, 1.4 equiv) is slowly added by syringe. The reaction is allowed to warm to room temperature with stirring for 1 hour. The white slurry disappeared and a clear solution is formed during this stage, indicating the successful formation of neutral tri-substituted alkynylboronate (step 2, acidification). After that, the prepared alkynylboronate solution is added dropwise at 110° C. to another 100 ml round bottom flask charged with s-2a (0.601 g, 4 mmol, 1 equiv) and toluene (16 mL). After the addition is completed, the Schlenk flask is washed with 4 mL toluene and the washes is added to the mixture. The reaction is stirred at 110° C. in the opened flask for 3 hours (step 3, amination). The reaction mixture is quenched with H₂O (10 mL) and EtOAc (10 mL). The layers are separated and the organic phase is washed with H₂O twice to remove inorganic salts MgCl₂, MgBr₂. The combined aqueous phase is extracted with EA once. The combined organic phase is further washed with brine, dried over Na₂SO₄, filtered, and concentrated under reduced pressure to afford a crude product, which is purified by flash column chromatography (n-Hexane/EA=3/1) to afford the pure alkynyl Baam product 2bm (0.128 g, 16% yield). 2bm could be stored under air at room temperature for several months without significant degradation. See FIG. 12B.

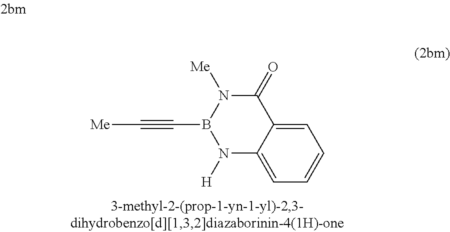 [SMILES: CC#CB1Nc2ccccc2C(=O)N1C]

Following the above procedure B, 2bm is prepared from 1-propynylmagnesium bromide (8 mL, 4 mmol) and s-2a (0.601 g, 4 mmol). Purified by flash column chromatography (n-Hexane/EA=3/1), 2bm is obtained as a white solid (0.128 g, 16% yield).

### 1.6 Preparation of Chiral MOP Ligands

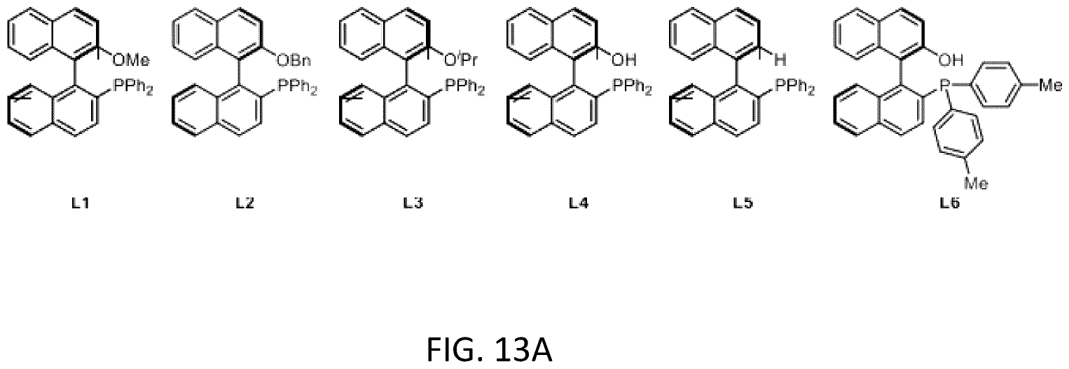

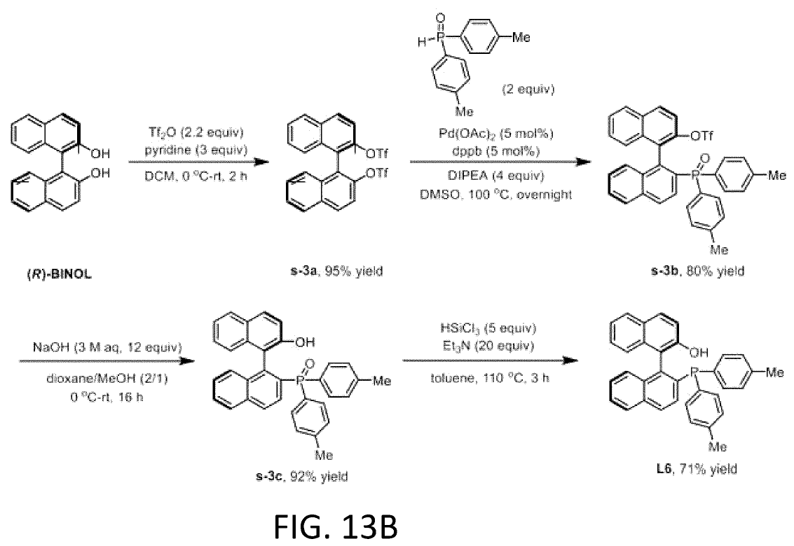

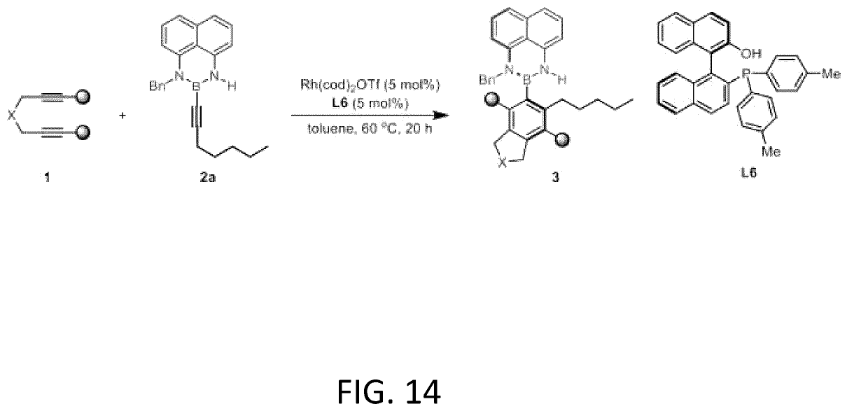

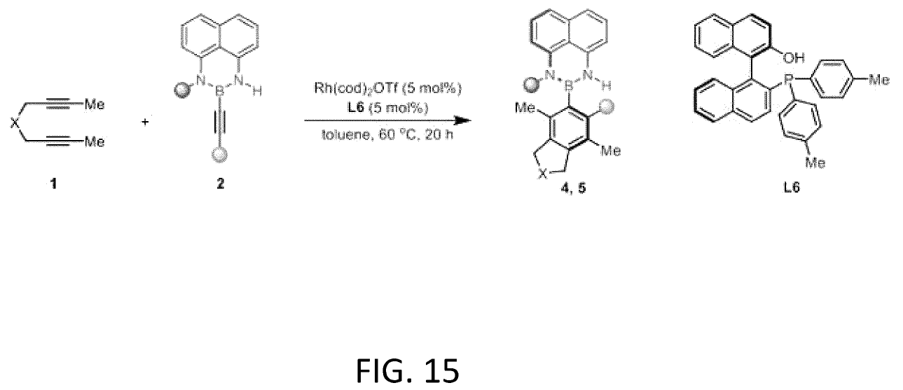

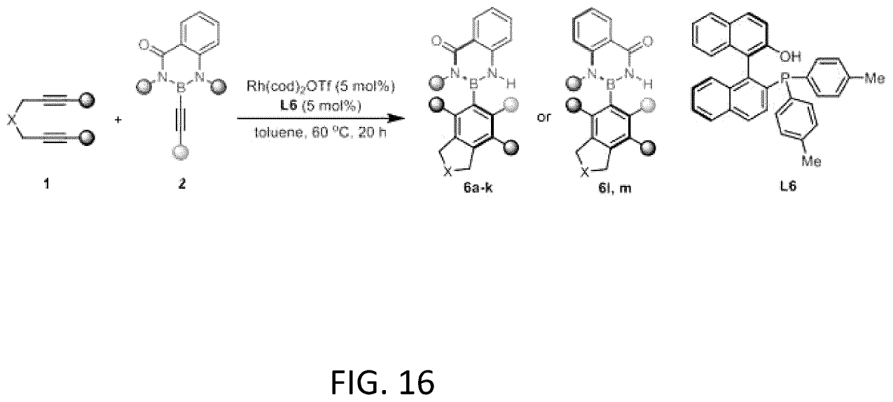

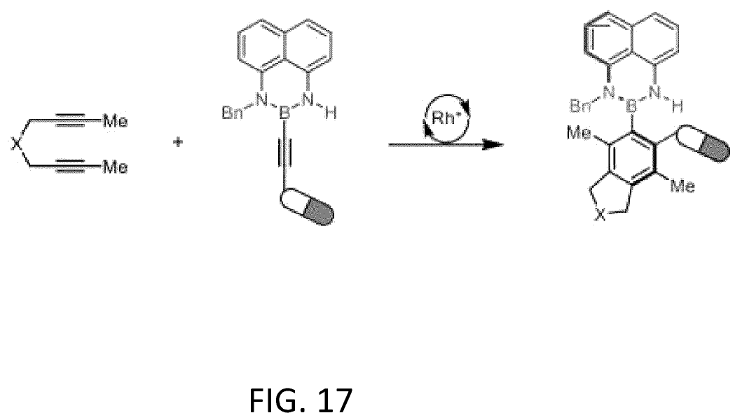

With reference to FIG. 13A, chiral MOP ligands L1-L5 are known chiral ligands. L6 is prepared analogously with a modified procedure (see FIG. 13B), as described below.

In a 100 mL round-bottom flask, (R)-BINOL (1.432 g, 5 mmol) is dissolved in DCM (20 mL). Pyridine (1.2 mL, 15 mmol, 3 equiv) is added by syringe to the solution. The mixture is cooled down to 0° C. and trifluoromethanesulfonic anhydride (1.85 mL, 11 mmol, 2.2 equiv) is added dropwise. The reaction is allowed to warm to room temperature and stirred for 2 hours. After the reaction is completed, water (10 mL) is slowly added to quench the reaction. The layers are separated and the aqueous phase is extracted with DCM three times. The combined organic phase is further washed with brine, dried over Na₂SO₄, filtered, and concentrated under reduced pressure to afford a crude product, which is purified by silica gel column chromatography (n-Hexane/EA=20/1) to afford s-3a as a colorless oil (2.627 g, 95% yield).

A 100 mL Schlenk flask equipped with a magnetic stir bar is charged with Pd(OAc)₂ (52.6 mg, 0.235 mmol, 5 mol %), dppb (100.2 mg, 0.235 mmol, 5 mol %), bis(p-tolyl)phosphine oxide (2.187 g, 9.5 mmol, 2 equiv). The flask is sealed with a rubber stopper, evacuated and filled with nitrogen gas three times. Then, s-3a (4.7 mmol) in DMSO (20 mL) and DIPEA (3.1 mL, 18.8 mmol, 4 equiv) are added by syringe. The reaction is stirred at 100° C. overnight. After the reaction is completed, water (20 mL) and EA (20 mL) are added to quench the reaction. The layers are separated and the organic phase is washed with water three times. The combined aqueous phase is extracted with EA once. The combined organic phase is further washed with brine, dried over Na₂SO₄, filtered, and concentrated under reduced pressure to afford a crude product, which is purified by silica gel column chromatography (n-Hexane/EA=1/1-1/2) to afford s-3b as a yellow foam (2.378 g, 80% yield).

In a 100 mL round-bottom flask, s-3b (3.7 mmol) is dissolved in dioxane (14 mL) and MeOH (7 mL). The mixture is cooled down to 0° C. and 3 M NaOH aqueous solution (14.8 mL, 44.4 mmol, 12 equiv) is added dropwise. The reaction is allowed to warm to room temperature and stirred for 16 hours. After the reaction is completed, water (10 mL) and EA (10 mL) are added to quench the reaction. The layers are separated and the aqueous phase is extracted with EA three times. The combined organic phase is further washed with brine, dried over Na₂SO₄, filtered, and concentrated under reduced pressure to afford a crude product, which is purified by silica gel column chromatography (n-Hexane/EA=1/1) to afford s-3c as a yellow solid (1.758 g, 92% yield).

A 100 mL Schlenk flask equipped with a magnetic stir bar is charged with s-3c (3.4 mmol). The flask is sealed with a rubber stopper, evacuated and filled with nitrogen gas three times. Then, dry toluene (34 mL) and triethylamine (9.45 mL, 68 mmol, 20 equiv) are added by syringe. The mixture is cooled down to 0° C. and trichlorosilane (1.7 mL, 17 mmol, 5 equiv) is added dropwise by syringe. After the addition is completed, the reaction is heated to 110° C. and stirred for 3 hours. After the reaction is finished, the reaction is cooled to room temperature and diluted with EA. Saturated NaHCO₃ aqueous solution is slowly added to quench the reaction. The resulting suspension is filtered and the filter cake is washed with EA. The filtrate is separated and the aqueous phase is extracted with EA three times. The combined organic phase is further washed with brine, dried over Na₂SO₄, filtered, and concentrated under reduced pressure to afford a crude product, which is purified by silica gel column chromatography (n-Hexane/EA=10/1-5/1) to afford L6 as a white solid (1.165 g, 71% yield).

ent-L6 (S configuration) is prepared from (S)-BINOL (CAS: 18531-99-2) through the same procedure.

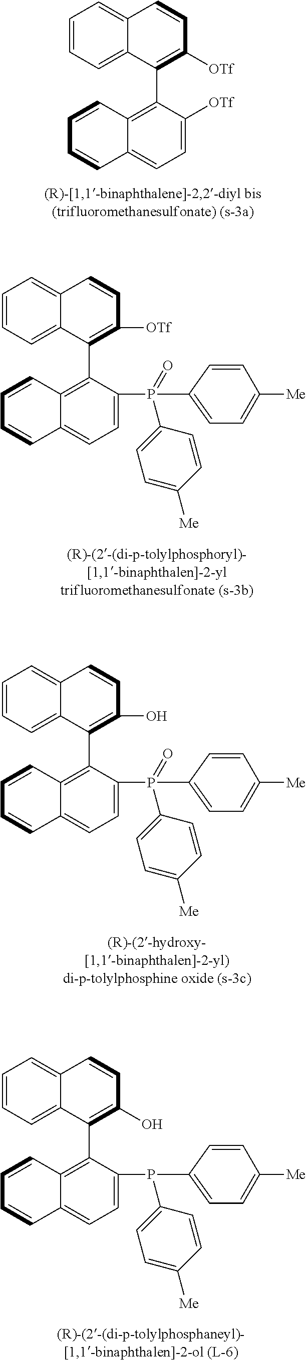

### 2. Rh-Catalyzed Atroposelective [2+2+2] Cycloaddition for the Synthesis of Axially Chiral Arylboron Compounds (Substrate Scope Study)

### 2.1 General Procedure for Chiral Synthesis

An oven-dried 10 mL Schlenk tube equipped with a magnetic stir bar is charged with Rh(cod)₂OTf (4.7 mg, 5 mol %), L6 (4.8 mg, 5 mol %), diyne 1 (if solid, 0.2 mmol), and alkynylboron 2 (0.3 mmol). The tube is sealed with a rubber stopper, evacuated and filled with nitrogen gas three times. Then, dry toluene (2 mL, 0.1 M) and diyne 1 (if liquid, 0.2 mmol) is added by syringe successively. The reaction is stirred at 60° C. for 20 hours unless otherwise noted, and TLC showed full conversion of diyne 1. After that, the mixture is filtered through a short pad of silica gel and rinsed with EA. The filtrate is concentrated under reduced pressure to afford a crude product, which is purified by silica gel column chromatography to afford axially chiral arylboron compound. The isolated yield is calculated and ee value is determined by chiral HPLC.

### 2.2 General Procedure for Racemic Synthesis

An oven-dried 10 mL Schlenk tube equipped with a magnetic stir bar is charged with Rh(cod)₂OTf (1.2 mg, 5 mol %), PPh₃ (1.3 mg, 10 mol %), diyne 1 (if solid, 0.05 mmol), and alkynylboron 2 (0.05 mmol). The tube is sealed with a rubber stopper, evacuated and filled with nitrogen gas three times. Then, dry toluene (0.5 mL, 0.1 M) and diyne 1 (if liquid, 0.05 mmol) is added by syringe successively. The reaction is stirred at 60° C. for 20 hours. After that, the mixture is filtered through a short pad of silica gel and rinsed with EA. The filtrate is concentrated under reduced pressure to afford a crude product, which is purified by preparative thin layer chromatography to afford racemic compound.

2.3 Products from Reactions of a Series of Diyne 1 with 2a

### (R)-dimethyl 5-(1-benzyl-1H-naphtho[1,8-de][1,3,2]diazaborinin-2(3H)-yl)-4,7-dimethyl-6-pentyl-1,3-dihydro-2H-indene-2,2-dicarboxylate (3a)

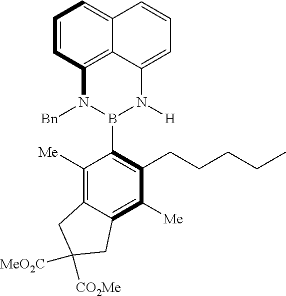

Following the general procedure, 3a is prepared from 1a (47.3 mg, 0.2 mmol) and 2a (105.7 mg, 0.3 mmol). Purified by silica gel column chromatography (n-Hexane/EA=15/1-10/1), 3a is obtained as a white solid (106.1 mg, 90% yield).

### (R)-dimethyl 5-(1-benzyl-1H-naphtho[1,8-de][1,3,2]diazaborinin-2(3H)-yl)-4,7-diethyl-6-pentyl-1,3-dihydro-2H-indene-2,2-dicarboxylate (3b)

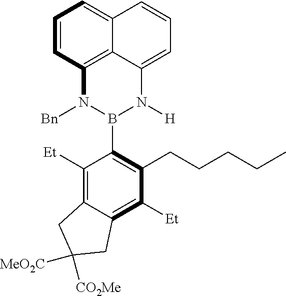

Following the general procedure, 3b is prepared from 1b (52.9 mg, 0.2 mmol) and 2a (105.7 mg, 0.3 mmol). Purified by silica gel column chromatography (n-Hexane/EA=15/1-10/1), 3b is obtained as a white solid (102.5 mg, 83% yield).

### (S)-dimethyl 5-(1-benzyl-1H-naphtho[1,8-de][1,3,2]diazaborinin-2(3H)-yl)-6-pentyl-4,7-diphenyl-1,3-dihydro-2H-indene-2,2-dicarboxylate (3c)

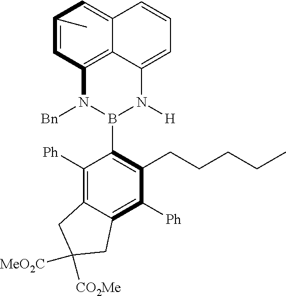

Following the general procedure, 3c is prepared from 1c (72.1 mg, 0.2 mmol) and 2a (105.7 mg, 0.3 mmol). In this case, the reaction time is 66 hours. Purified by silica gel column chromatography (n-Hexane/EA=15/1-9/1), 3c is obtained as a white solid (107.8 mg, 76% yield).

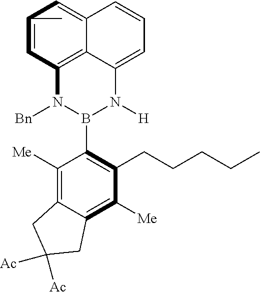

Following the general procedure, 3d is prepared from 1d (40.9 mg, 0.2 mmol) and 2a (105.7 mg, 0.3 mmol). Purified by silica gel column chromatography (n-Hexane/EA=15/1-8/1), 3d is obtained as a white solid (101.5 mg, 91% yield).

### (R)-5-(1-benzyl-1H-naphtho[1,8-de][1,3,2]diazaborinin-2(3H)-yl)-4,7-dimethyl-6-pentyl-1,3-dihydro-2H-indene-2,2-dicarbonitrile (3e)

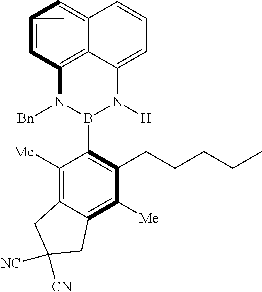

Following the general procedure, 3e is prepared from 1e (34.0 mg, 0.2 mmol) and 2a (105.7 mg, 0.3 mmol). Purified by silica gel column chromatography (n-Hexane/EA=15/1-10/1), 3e is obtained as a white solid (75.9 mg, 73% yield).

### (R)-1-benzyl-2-(2,2-bis(((tert-butyldimethylsilyl)oxy)methyl)-4,7-dimethyl-6-pentyl-2,3-dihydro-1H-inden-5-yl)-2,3-dihydro-1H-naphtho[1,8-de][1,3,2]diazaborinine (3f)

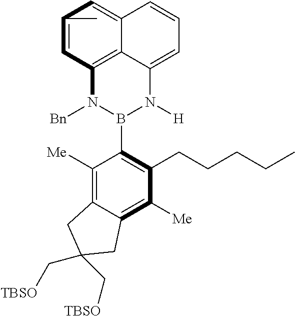

Following the general procedure, 3f is prepared from 1f (81.8 mg, 0.2 mmol) and 2a (105.7 mg, 0.3 mmol). First purification by silica gel column chromatography (n-Hexane/EA=100/1) afforded a crude product containing a few 2a, which is further purified by preparative thin layer chromatography (n-Hexane/EA=30/1) to afford pure 3f as a colorless oil (132.0 mg, 87% yield).

### (R)-1-benzyl-2-(2,2-bis(methoxymethyl)-4,7-dimethyl-6-pentyl-2,3-dihydro-1H-inden-5-yl)-2,3-dihydro-1H-naphtho[1,8-de][1,3,2]diazaborinine (3g)

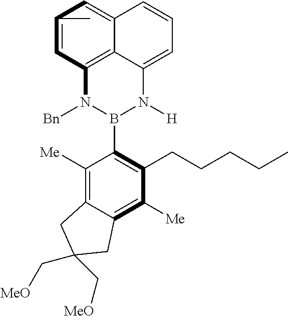

Following the general procedure, 3g is prepared from 1g (41.7 mg, 0.2 mmol) and 2a (105.7 mg, 0.3 mmol). Purified by silica gel column chromatography (n-Hexane/DCM=1/1), 3g is obtained as a white solid (102.1 mg, 91% yield).

### (R)-methyl 5-(1-benzyl-1H-naphtho[1,8-de][1,3,2]diazaborinin-2(3H)-yl)-4,7-dimethyl-6-pentyl-2-phenyl-2,3-dihydro-1H-indene-2-carboxylate (3h)

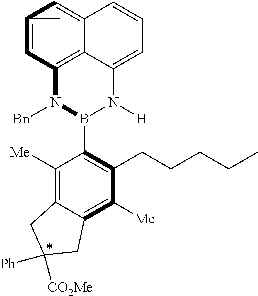

Following the general procedure, 3h is prepared from 1h (50.9 mg, 0.2 mmol) and 2a (105.7 mg, 0.3 mmol). Purified by silica gel column chromatography (n-Hexane/EA=20/1), 3h is obtained as a white solid (67.1 mg, 55% yield), containing a pair of diastereomers. ¹H-NMR analysis showed that diastereomeric ratio is 3/1.

### (R)-5′-(1-benzyl-1H-naphtho[1,8-de][1,3,2]diazaborinin-2(3H)-yl)-4,4,4′,7′-tetramethyl-6′-pentyl-1′,3′-dihydrospiro[cyclohexane-1,2′-indene]-2,6-dione (3i)

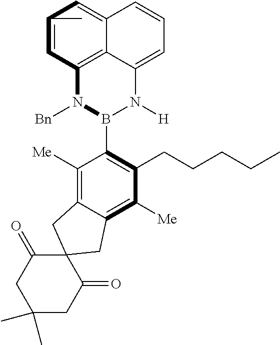

Following the general procedure, 3i is prepared from 11 (48.9 mg, 0.2 mmol) and 2a (105.7 mg, 0.3 mmol). Purified by silica gel column chromatography (n-Hexane/EA=15/1-9/1), 3i is obtained as a white solid (76.1 mg, 64% yield).

### (R)-5′-(1-benzyl-1H-naphtho[1,8-de][1,3,2]diazaborinin-2(3H)-yl)-4′,7′-dimethyl-6′-pentyl-1′,3′-dihydro-2,2′-spirobi[indene]-1,3-dione (3j)

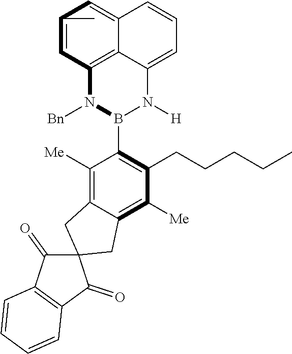

Following the general procedure, 3j is prepared from 1j (50.1 mg, 0.2 mmol) and 2a (105.7 mg, 0.3 mmol). Purified by silica gel column chromatography (n-Hexane/EA=15/1-8/1), 3j is obtained as a yellow solid (97.2 mg, 81% yield).

### (R)-1-benzyl-2-(4′,7′-dimethyl-5′-pentyl-1′,3′-dihydrospiro[fluorene-9,2′-inden]-6′-yl)-2,3-dihydro-1H-naphtho[1,8-de][1,3,2]diazaborinine (3k)

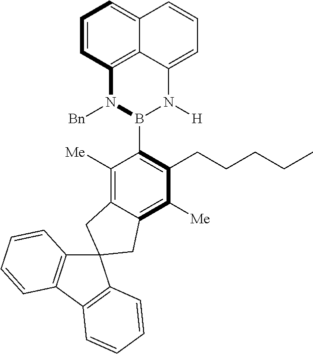

Following the general procedure, 3k is prepared from 1k (54.1 mg, 0.2 mmol) and 2a (105.7 mg, 0.3 mmol). First purification by silica gel column chromatography (n-Hexane/EA=100/1) afforded a crude product containing a few 2a, which is further purified by preparative thin layer chromatography (n-Hexane/EA=50/1) to afford pure 3k as an orange solid (72.0 mg, 58% yield).

### (R)-1-benzyl-2-(7,10-dimethyl-9-pentylfluoranthen-8-yl)-2,3-dihydro-1H-naphtho[1,8-de][1,3,2]diazaborinine (3l)

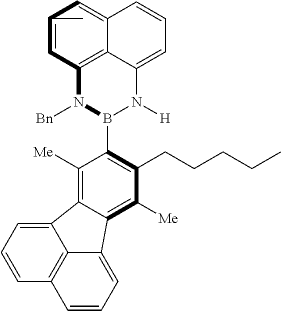

Following the general procedure, 3l is prepared from 1l (40.9 mg, 0.2 mmol) and 2a (105.7 mg, 0.3 mmol). First purification by silica gel column chromatography (n-Hexane/EA=200/1) afforded a crude product containing a few 2a, which is further purified by preparative thin layer chromatography (n-Hexane/EA=60/1) to afford pure 3l as an orange solid (52.8 mg, 47% yield).

### (R)-1-benzyl-2-(4,7-dimethyl-6-pentyl-2-tosylisoindolin-5-yl)-2,3-dihydro-1H-naphtho[1,8-de][1,3,2]diazaborinine (3m)

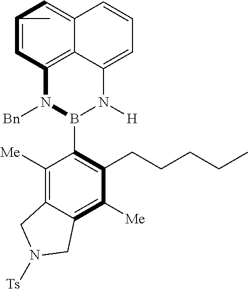

Following the general procedure, 3m is prepared from 1m (55.1 mg, 0.2 mmol) and 2a (105.7 mg, 0.3 mmol). Purified by silica gel column chromatography (n-Hexane/EA=12/1-8/1), 3m is obtained as a white solid (75.1 mg, 60% yield).

### (R)-1-benzyl-2-(2-((4-bromophenyl)sulfonyl)-4,7-dimethyl-6-pentylisoindolin-5-yl)-2,3-dihydro-1H-naphtho[1,8-de][1,3,2]diazaborinine (3n)

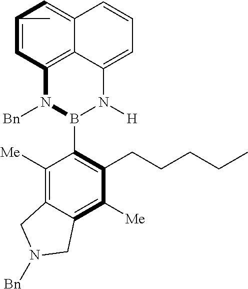

Following the general procedure, 3n is prepared from in (68.0 mg, 0.2 mmol) and 2a (105.7 mg, 0.3 mmol). Purified by silica gel column chromatography (n-Hexane/EA=20/1-10/1), 3n is obtained as a white solid (89.6 mg, 65% yield).

### (R)-1-benzyl-2-(4,7-dimethyl-6-pentyl-1,3-dihydroisobenzofuran-5-yl)-2,3-dihydro-1H-naphtho[1,8-de][1,3,2]diazaborinine (3o)

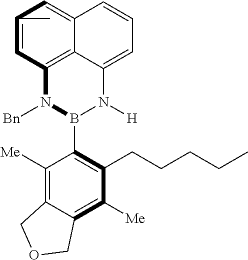

Following the general procedure, 3o is prepared from 1o (24.4 mg, 0.2 mmol) and 2a (105.7 mg, 0.3 mmol). Purified by silica gel column chromatography (n-Hexane/DCM=2/1-1/1), 3o is obtained as a white solid. When 1o is directly added to the reaction, 3o is obtained in 26% yield (24.6 mg). While 1o is dissolved in 2 mL dry toluene and the solution is added dropwise to the reaction for 3 hours, 3o is obtained in 62% yield (58.8 mg).

(R)-dimethyl 5-(1-benzyl-1H-naphtho[1,8-de][1,3,2]diazaborinin-2(3H)-yl)-4-methyl-6-pentyl-7-phenyl-1,3-dihydro-2H-indene-2,2-dicarboxylate (3pa)/(S)-dimethyl 5-(1-benzyl-1H-naphtho[1,8-de][1,3,2]diazaborinin-2(3H)-yl)-7-methyl-6-pentyl-4-phenyl-1,3-dihydro-2H-indene-2,2-dicarboxylate (3pb)

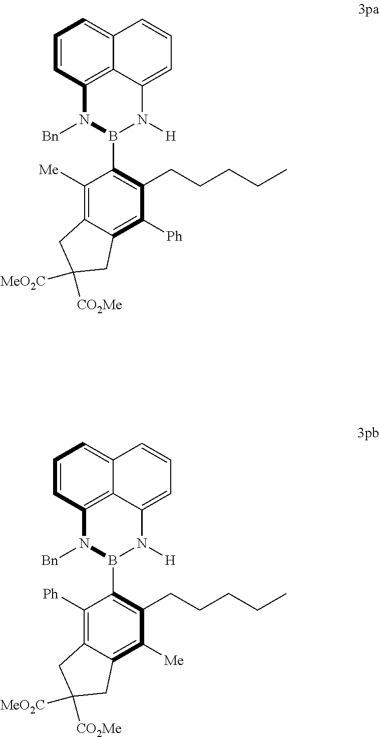

Following the general procedure, 3pa and 3pb is prepared from 1p (59.7 mg, 0.2 mmol) and 2a (105.7 mg, 0.3 mmol). The reaction afforded a pair of regioisomers (3pa, 3pb). Purification by silica gel column chromatography (n-Hexane/EA=20/1-10/1) afforded the mixture of 3pa and 3pb as a colorless oil in total 97% yield (126.8 mg). ¹H-NMR analysis showed that regiomeric ratio is 1.44/1 (3pa/3pb).
2.4 Products from Reactions with Diyne 1 and a Series of Alkynyl Bdans 2a

### (S)-dimethyl 5-(1-benzyl-1H-naphtho[1,8-de][1,3,2]diazaborinin-2(3H)-yl)-4,6,7-trimethyl-1,3-dihydro-2H-indene-2,2-dicarboxylate (4a)

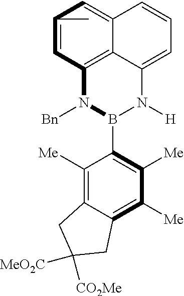

Following the general procedure, 4a is prepared from 1a (47.3 mg, 0.2 mmol) and 2v (88.9 mg, 0.3 mmol). Purified by silica gel column chromatography (n-Hexane/EA=20/1-10/1), 4a is obtained as a white solid (106.3 mg, 99% yield).

### (R)-dimethyl 5-(1-benzyl-1H-naphtho[1,8-de][1,3,2]diazaborinin-2(3H)-yl)-4,6,7-trimethyl-1,3-dihydro-2H-indene-2,2-dicarboxylate (ent-4a)

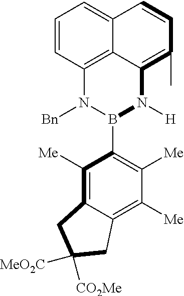

Following the general procedure, ent-4a is prepared from 1a (47.3 mg, 0.2 mmol) and 2v (88.9 mg, 0.3 mmol) by employing ent-L6 as the ligand. Purified by silica gel column chromatography (n-Hexane/EA=20/1-10/1), ent-4a is obtained as a white solid (106.2 mg, 99% yield).

### (S)-1-benzyl-2-(4,6,7-trimethyl-2-tosylisoindolin-5-yl)-2,3-dihydro-1H-naphtho[1,8-de][1,3,2]diazaborinine (4b)

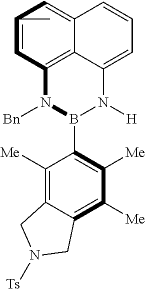

Following the general procedure, 4b is prepared from 1m (55.1 mg, 0.2 mmol) and 2v (88.9 mg, 0.3 mmol). Purified by silica gel column chromatography (n-Hexane/EA=9/1-5/1), 4b is obtained as a white solid (83.0 mg, 73% yield).

### (S)-1-benzyl-2-(4,6,7-trimethyl-1,3-dihydroisobenzofuran-5-yl)-2,3-dihydro-1H-naphtho[1,8-de][1,3,2]diazaborinine (4c)

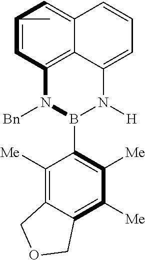

Following the general procedure, 4c is prepared from 1o (24.4 mg, 0.2 mmol) and 2v (88.9 mg, 0.3 mmol). Purified by silica gel column chromatography (n-Hexane/EA=30/1-20/1), 4c is obtained as a white solid. When 1o is directly added to the reaction, 4c is obtained in 40% yield (33.6 mg). While 1o is dissolved in 2 mL dry toluene and the solution is added dropwise to the reaction for 3 hours, 4c is obtained in 60% yield (50.5 mg).

### (R)-dimethyl 5-(1-benzyl-1H-naphtho[1,8-de][1,3,2]diazaborinin-2(3H)-yl)-6-butyl-4,7-dimethyl-1,3-dihydro-2H-indene-2,2-dicarboxylate (4d)

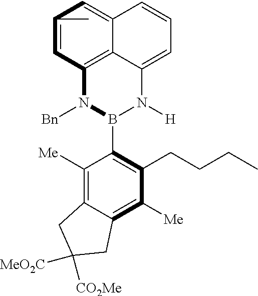

Following the general procedure, 4d is prepared from 1a (47.3 mg, 0.2 mmol) and 2b (101.5 mg, 0.3 mmol). Purified by silica gel column chromatography (n-Hexane/EA=15/1-10/1), 4d is obtained as a white solid (99.6 mg, 87% yield).

### (R)-dimethyl 5-(1-benzyl-1H-naphtho[1,8-de][1,3,2]diazaborinin-2(3H)-yl)-4,7-dimethyl-6-octyl-1,3-dihydro-2H-indene-2,2-dicarboxylate (4e)

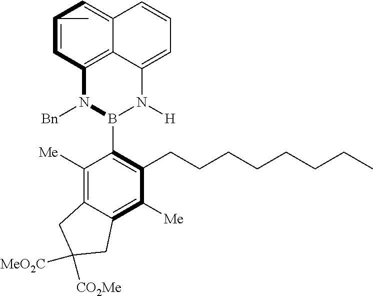

Following the general procedure, 4e is prepared from 1a (47.3 mg, 0.2 mmol) and 2c (101.5 mg, 0.3 mmol). Purified by silica gel column chromatography (n-Hexane/EA=15/1-10/1), 4e is obtained as a white solid (109.4 mg, 87% yield).

### (R)-dimethyl 5-(1-benzyl-1H-naphtho[1,8-de][1,3,2]diazaborinin-2(3H)-yl)-6-isobutyl-4,7-dimethyl-1,3-dihydro-2H-indene-2,2-dicarboxylate (4f)

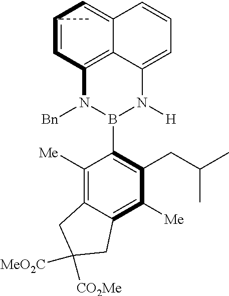

Following the general procedure, 4f is prepared from 1a (47.3 mg, 0.2 mmol) and 2d (101.5 mg, 0.3 mmol). Purified by silica gel column chromatography (n-Hexane/EA=20/1-10/1), 4f is obtained as a white solid (91.8 mg, 80% yield).

### (R)-dimethyl 5-(1-benzyl-1H-naphtho[1,8-de][1,3,2]diazaborinin-2(3H)-yl)-4,7-dimethyl-6-phenethyl-1,3-dihydro-2H-indene-2,2-dicarboxylate (4g)

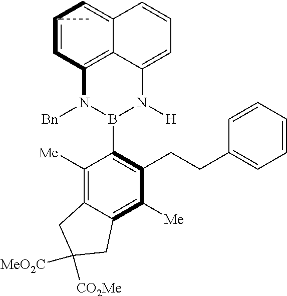

Following the general procedure, 4g is prepared from 1a (47.3 mg, 0.2 mmol) and 2e (115.9 mg, 0.3 mmol). Purified by silica gel column chromatography (n-Hexane/EA=15/1-8/1), 4g is obtained as a white solid (123.6 mg, 99% yield).

### (R)-dimethyl 5-(1-benzyl-1H-naphtho[1,8-de][1,3,2]diazaborinin-2(3H)-yl)-6-(3-chloropropyl)-4,7-dimethyl-1,3-dihydro-2H-indene-2,2-dicarboxylate (4h)

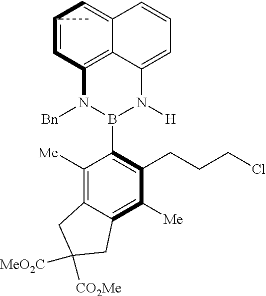

Following the general procedure, 4h is prepared from 1a (47.3 mg, 0.2 mmol) and 2t (107.6 mg, 0.3 mmol). Purified by silica gel column chromatography (n-Hexane/EA=20/1-10/1), 4h is obtained as a white solid (117.0 mg, 98% yield).

### (R)-dimethyl 5-(1-benzyl-1H-naphtho[1,8-de][1,3,2]diazaborinin-2(3H)-yl)-6-(2-((tert-butyldimethylsilyl)oxy)ethyl)-4,7-dimethyl-1,3-dihydro-2H-indene-2,2-dicarboxylate (4i)

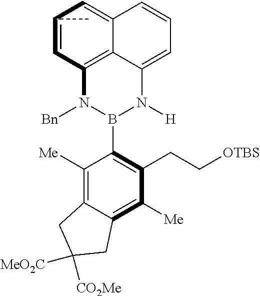

Following the general procedure, 4i is prepared from 1a (47.3 mg, 0.2 mmol) and 2g (132.2 mg, 0.3 mmol). Purified by silica gel column chromatography (n-Hexane/EA=20/1-10/1), 4i is obtained as a white solid (112.0 mg, 83% yield).

### (R)-dimethyl 5-(1-benzyl-1H-naphtho[1,8-de][1,3,2]diazaborinin-2(3H)-yl)-4,7-dimethyl-6-(2-(tosyloxy)ethyl)-1,3-dihydro-2H-indene-2,2-dicarboxylate (4j)

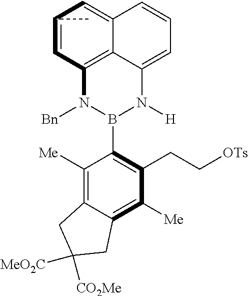

Following the general procedure, 4j is prepared from 1a (47.3 mg, 0.2 mmol) and 2h (144.1 mg, 0.3 mmol). Purified by silica gel column chromatography (n-Hexane/EA=5/1-3/1), 4j is obtained as a white solid (143.0 mg, 99% yield).

### (R)-dimethyl 5-(1-benzyl-1H-naphtho[1,8-de][1,3,2]diazaborinin-2(3H)-yl)-4,7-dimethyl-6-(3-(tosyloxy)propyl)-1,3-dihydro-2H-indene-2,2-dicarboxylate (4k)

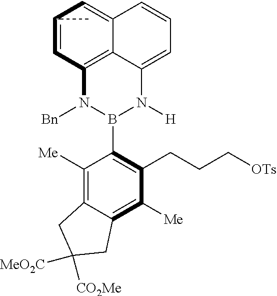

Following the general procedure, 4k is prepared from 1a (47.3 mg, 0.2 mmol) and 2i (148.3 mg, 0.3 mmol). Purified by silica gel column chromatography (n-Hexane/EA=5/1-3/1), 4k is obtained as a white solid (135.6 mg, 93% yield).

### (R)-dimethyl 5-(1-benzyl-1H-naphtho[1,8-de][1,3,2]diazaborinin-2(3H)-yl)-4,7-dimethyl-6-(4-(tosyloxy)butyl)-1,3-dihydro-2H-indene-2,2-dicarboxylate (4l)

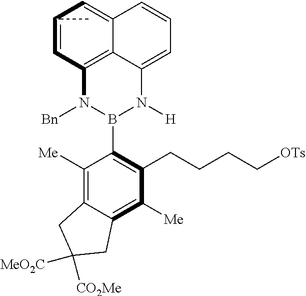

Following the general procedure, 4l is prepared from 1a (47.3 mg, 0.2 mmol) and 2j (152.5 mg, 0.3 mmol). Purified by silica gel column chromatography (n-Hexane/EA=6/1-4/1), 4l is obtained as a white solid (137.9 mg, 93% yield).

### (R)-dimethyl 5-(2-(benzoyloxy)ethyl)-6-(1-benzyl-1H-naphtho[1,8-de][1,3,2]diazaborinin-2(3H)-yl)-4,7-dimethyl-1,3-dihydro-2H-indene-2,2-dicarboxylate (4m)

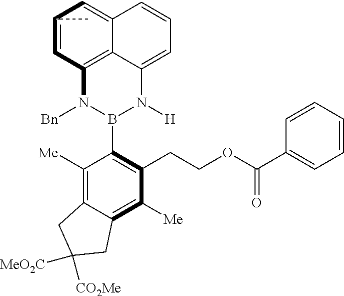

Following the general procedure, 4m is prepared from 1a (47.3 mg, 0.2 mmol) and 2s (129.1 mg, 0.3 mmol). Purified by silica gel column chromatography (n-Hexane/EA=10/1-6/1), 4m is obtained as a white solid (132.4 mg, 99% yield).

### (R)-dimethyl 5-(1-benzyl-1H-naphtho[1,8-de][1,3,2]diazaborinin-2(3H)-yl)-6-(methoxymethyl)-4,7-dimethyl-1,3-dihydro-2H-indene-2,2-dicarboxylate (4n)

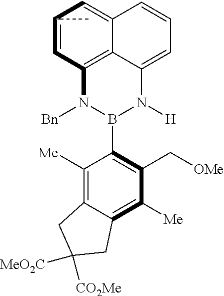

Following the general procedure, 4n is prepared from 1a (47.3 mg, 0.2 mmol) and 2k (97.9 mg, 0.3 mmol). Purified by silica gel column chromatography (n-Hexane/EA=20/1-10/1), 4m is obtained as a white solid (112.2 mg, 99% yield).

### (R)-dimethyl 5-(1-benzyl-1H-naphtho[1,8-de][1,3,2]diazaborinin-2(3H)-yl)-4,7-dimethyl-6-((trimethylsilyl)methyl)-1,3-dihydro-2H-indene-2,2-dicarboxylate (4o)

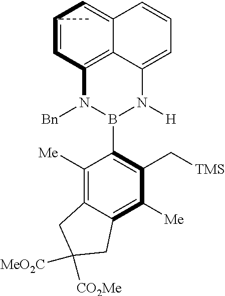

Following the general procedure, 4o is prepared from 1a (47.3 mg, 0.2 mmol) and 2l (110.5 mg, 0.3 mmol). Purified by silica gel column chromatography (n-Hexane/EA=20/1-10/1), 4o is obtained as a white solid (105.4 mg, 87% yield).

### (R)-dimethyl 5-(1-benzyl-1H-naphtho[1,8-de][1,3,2]diazaborinin-2(3H)-yl)-6-isopropyl-4,7-dimethyl-1,3-dihydro-2H-indene-2,2-dicarboxylate (4p)

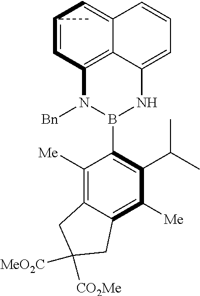

Following the general procedure, 4p is prepared from 1a (47.3 mg, 0.2 mmol) and 2m (97.3 mg, 0.3 mmol). Purified by silica gel column chromatography (n-Hexane/EA=20/1-10/1), 4p is obtained as a white solid (60.1 mg, 54% yield).

### (R)-dimethyl 5-(1-benzyl-1H-naphtho[1,8-de][1,3,2]diazaborinin-2(3H)-yl)-6-cyclopropyl-4,7-dimethyl-1,3-dihydro-2H-indene-2,2-dicarboxylate (4q)

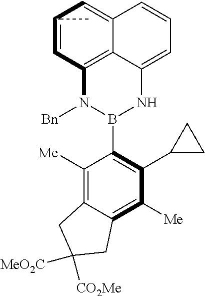

Following the general procedure, 4q is prepared from 1a (47.3 mg, 0.2 mmol) and 2n (96.7 mg, 0.3 mmol). Purified by silica gel column chromatography (n-Hexane/EA=15/1-10/1), 4q is obtained as a white solid (102.1 mg, 91% yield).

### (R)-dimethyl 5-(1-benzyl-1H-naphtho[1,8-de][1,3,2]diazaborinin-2(3H)-yl)-6-cyclohexyl-4,7-dimethyl-1,3-dihydro-2H-indene-2,2-dicarboxylate (4r)

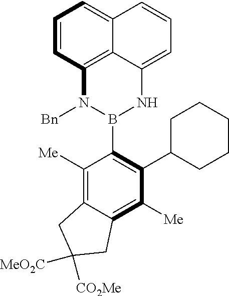

Following the general procedure, 4r is prepared from 1a (47.3 mg, 0.2 mmol) and 20 (109.3 mg, 0.3 mmol). Purified by silica gel column chromatography (n-Hexane/EA=20/1-10/1), 4r is obtained as a white solid (48.7 mg, 41% yield).

### (R)-dimethyl (E)-5-(1-benzyl-1H-naphtho[1,8-de][1,3,2]diazaborinin-2(3H)-yl)-4,7-dimethyl-6-styryl-1,3-dihydro-2H-indene-2,2-dicarboxylate (4s)

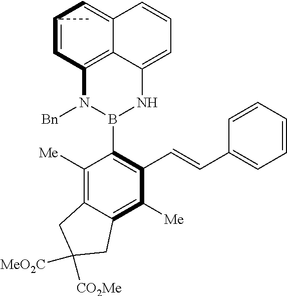

Following the general procedure, 4s is prepared from 1a (47.3 mg, 0.2 mmol) and 2p (115.3 mg, 0.3 mmol). Purified by silica gel column chromatography (n-Hexane/EA=15/1-5/1), 4s is obtained as a white solid (123.1 mg, 99% yield).

### (R)-dimethyl 5-(1-benzyl-1H-naphtho[1,8-de][1,3,2]diazaborinin-2(3H)-yl)-6-(cyclohex-1-en-1-yl)-4,7-dimethyl-1,3-dihydro-2H-indene-2,2-dicarboxylate (4t)

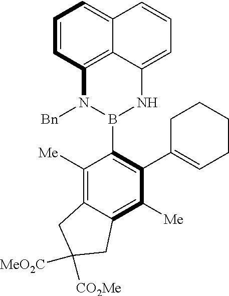

Following the general procedure, 4t is prepared from 1a (47.3 mg, 0.2 mmol) and 2q (108.7 mg, 0.3 mmol). Purified by silica gel column chromatography (n-Hexane/EA=20/1-10/1), 4t is obtained as a white solid (51.6 mg, 43% yield).

### (R)-dimethyl 5-(1-benzyl-1H-naphtho[1,8-de][1,3,2]diazaborinin-2(3H)-yl)-4,7-dimethyl-6-phenyl-1,3-dihydro-2H-indene-2,2-dicarboxylate (4u)

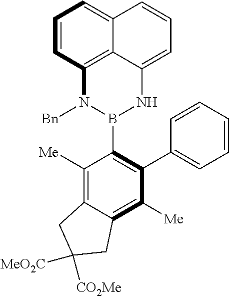

Following the general procedure, 4u is prepared from 1a (47.3 mg, 0.2 mmol) and 2r (107.5 mg, 0.3 mmol). Purified by silica gel column chromatography (n-Hexane/EA=20/1-10/1), 4u is obtained as a white solid (63.4 mg, 53% yield).

### (S)-dimethyl 4,5,7-trimethyl-6-(1-(4-methylbenzyl)-1H-naphtho[1,8-de][1,3,2]diazaborinin-2(3H)-yl)-1,3-dihydro-2H-indene-2,2-dicarboxylate (5a)

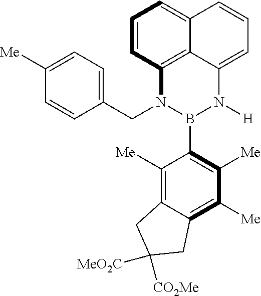

Following the general procedure, 5a is prepared from 1a (47.3 mg, 0.2 mmol) and 2aa (93.1 mg, 0.3 mmol). Purified by silica gel column chromatography (n-Hexane/EA=15/1-10/1), 5a is obtained as a white solid (109.3 mg, 99% yield).

### (S)-dimethyl 4,5,7-trimethyl-6-(1-(4-(trifluoromethoxy)benzyl)-1H-naphtho[1,8-de][1,3,2]diazaborinin-2(3H)-yl)-1,3-dihydro-2H-indene-2,2-dicarboxylate (5b)

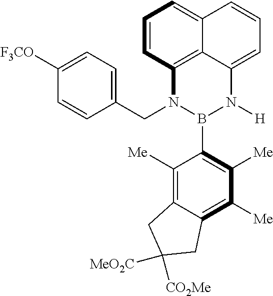

Following the general procedure, 5b is prepared from 1a (47.3 mg, 0.2 mmol) and 2ab (114.1 mg, 0.3 mmol). Purified by silica gel column chromatography (n-Hexane/EA=15/1-10/1), 5b is obtained as a white solid (123.1 mg, 99% yield).

### (S)-dimethyl 5-(1-(4-fluorobenzyl)-1H-naphtho[1,8-de][1,3,2]diazaborinin-2(3H)-yl)-4,6,7-trimethyl-1,3-dihydro-2H-indene-2,2-dicarboxylate (5c)

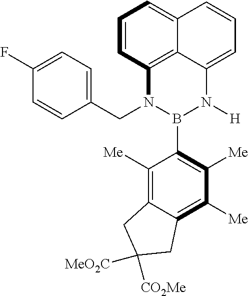

Following the general procedure, 5c is prepared from 1a (47.3 mg, 0.2 mmol) and 2ac (94.3 mg, 0.3 mmol). Purified by silica gel column chromatography (n-Hexane/EA=15/1-10/1), 5c is obtained as a white solid (109.7 mg, 99% yield).

### (S)-dimethyl 5-(1-(4-chlorobenzyl)-1H-naphtho[1,8-de][1,3,2]diazaborinin-2(3H)-yl)-4,6,7-trimethyl-1,3-dihydro-2H-indene-2,2-dicarboxylate (5d)

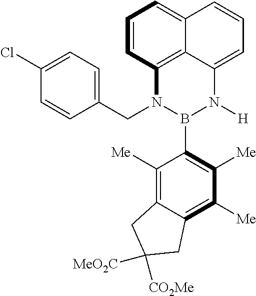

Following the general procedure, 5d is prepared from 1a (47.3 mg, 0.2 mmol) and 2ad (99.2 mg, 0.3 mmol). Purified by silica gel column chromatography (n-Hexane/EA=15/1-10/1), 5d is obtained as a white solid (113.1 mg, 99% yield).

### (S)-dimethyl 5-(1-(4-bromobenzyl)-1H-naphtho[1,8-de][1,3,2]diazaborinin-2(3H)-yl)-4,6,7-trimethyl-1,3-dihydro-2H-indene-2,2-dicarboxylate (5e)

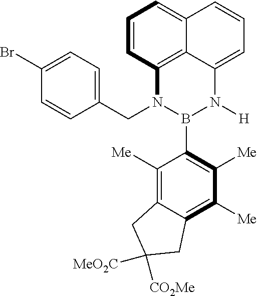

Following the general procedure, 5e is prepared from 1a (47.3 mg, 0.2 mmol) and 2ae (112.5 mg, 0.3 mmol). Purified by silica gel column chromatography (n-Hexane/EA=15/1-10/1), 5e is obtained as a white solid (121.4 mg, 99% yield).

### (S)-dimethyl 5-(1-(4-iodobenzyl)-1H-naphtho[1,8-de][1,3,2]diazaborinin-2(3H)-yl)-4,6,7-trimethyl-1,3-dihydro-2H-indene-2,2-dicarboxylate (5f)

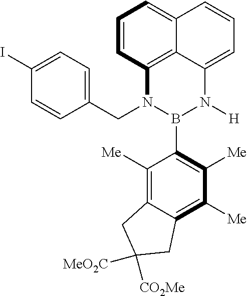

Following the general procedure, 5f is prepared from 1a (47.3 mg, 0.2 mmol) and 2af (126.6 mg, 0.3 mmol). Purified by silica gel column chromatography (n-Hexane/EA=15/1-9/1), 5f is obtained as a white solid (101.0 mg, 77% yield).

### (S)-dimethyl 4,5,7-trimethyl-6-(1-(4-(4,4,5,5-tetramethyl-1,3,2-dioxaborolan-2-yl)benzyl)-1H-naphtho[1,8-de][1,3,2]diazaborinin-2(3H)-yl)-1,3-dihydro-2H-indene-2,2-dicarboxylate (5g)

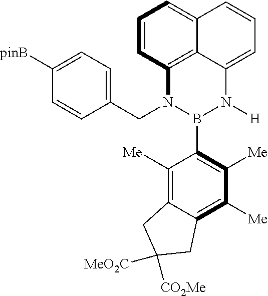

Following the general procedure, 5g is prepared from 1a (47.3 mg, 0.2 mmol) and 2ag (126.6 mg, 0.3 mmol). Purified by silica gel column chromatography (n-Hexane/EA=15/1-9/1), 5g is obtained as a white solid (117.2 mg, 89% yield).

### (S)-dimethyl 5-(1-(4-(methoxycarbonyl)benzyl)-1H-naphtho[1,8-de][1,3,2]diazaborinin-2(3H)-yl)-4,6,7-trimethyl-1,3-dihydro-2H-indene-2,2-dicarboxylate (5h)

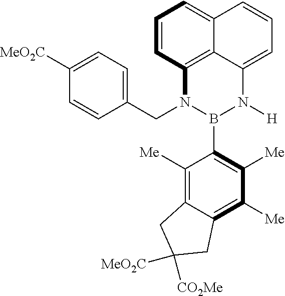

Following the general procedure, 5h is prepared from 1a (47.3 mg, 0.2 mmol) and 2ah (106.3 mg, 0.3 mmol). Purified by silica gel column chromatography (n-Hexane/EA=10/1-5/1), 5h is obtained as a white solid (117.7 mg, 99% yield).

### (S)-dimethyl 4,5,7-trimethyl-6-(1-(3-methylbenzyl)-1H-naphtho[1,8-de][1,3,2]diazaborinin-2(3H)-yl)-1,3-dihydro-2H-indene-2,2-dicarboxylate (5i)

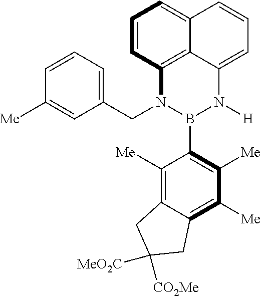

Following the general procedure, 5i is prepared from 1a (47.3 mg, 0.2 mmol) and 2ai (93.1 mg, 0.3 mmol). Purified by silica gel column chromatography (n-Hexane/EA=15/1-10/1), 5i is obtained as a white solid (108.7 mg, 99% yield).

### (S)-dimethyl 4,5,7-trimethyl-6-(1-(2-methylbenzyl)-1H-naphtho[1,8-de][1,3,2]diazaborinin-2(3H)-yl)-1,3-dihydro-2H-indene-2,2-dicarboxylate (5j)

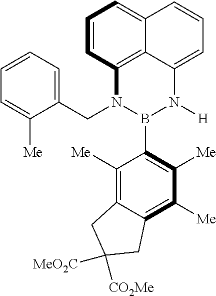

Following the general procedure, 5j is prepared from 1a (47.3 mg, 0.2 mmol) and 2aj (93.1 mg, 0.3 mmol). Purified by silica gel column chromatography (n-Hexane/EA=15/1-10/1), 5j is obtained as a white solid (108.9 mg, 99% yield).

### (S)-dimethyl 4,5,7-trimethyl-6-(1-(naphthalen-1-ylmethyl)-1H-naphtho[1,8-de][1,3,2]diazaborinin-2(3H)-yl)-1,3-dihydro-2H-indene-2,2-dicarboxylate (5k)

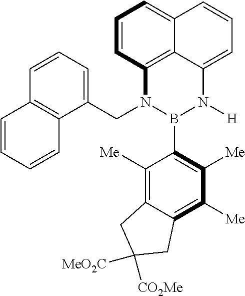

Following the general procedure, 5k is prepared from 1a (47.3 mg, 0.2 mmol) and 2ak (103.9 mg, 0.3 mmol). Purified by silica gel column chromatography (n-Hexane/EA=15/1-9/1), 5k is obtained as a white solid (116.1 mg, 99% yield).

### (S)-dimethyl 4,5,7-trimethyl-6-(1-(naphthalen-2-ylmethyl)-1H-naphtho[1,8-de][1,3,2]diazaborinin-2(3H)-yl)-1,3-dihydro-2H-indene-2,2-dicarboxylate (5l)

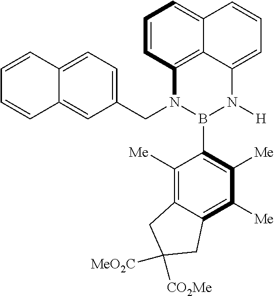

Following the general procedure, 5l is prepared from 1a (47.3 mg, 0.2 mmol) and 2al (103.9 mg, 0.3 mmol). Purified by silica gel column chromatography (n-Hexane/EA=15/1-9/1), 5l is obtained as a white solid (116.8 mg, 99% yield).

### (S)-dimethyl 5-(1-ethyl-1H-naphtho[1,8-de][1,3,2]diazaborinin-2(3H)-yl)-4,6,7-trimethyl-1,3-dihydro-2H-indene-2,2-dicarboxylate (5m)

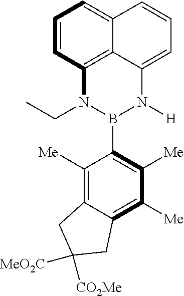

Following the general procedure, 5m is prepared from 1a (47.3 mg, 0.2 mmol) and 2am (70.2 mg, 0.3 mmol). Purified by silica gel column chromatography (n-Hexane/EA=15/1-10/1), 5m is obtained as a white solid (93.7 mg, 99% yield).

### (S)-dimethyl 5-(1-butyl-1H-naphtho[1,8-de][1,3,2]diazaborinin-2(3H)-yl)-4,6,7-trimethyl-1,3-dihydro-2H-indene-2,2-dicarboxylate (5n)

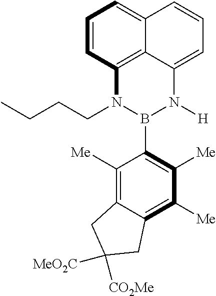

Following the general procedure, 5n is prepared from 1a (47.3 mg, 0.2 mmol) and 2an (78.7 mg, 0.3 mmol). Purified by silica gel column chromatography (n-Hexane/EA=15/1-10/1), 5n is obtained as a white solid (99.3 mg, 99% yield).

### (S)-dimethyl 4,5,7-trimethyl-6-(1-(3-methylbut-2-en-1-yl)-1H-naphtho[1,8-de][1,3,2]diazaborinin-2(3H)-yl)-1,3-dihydro-2H-indene-2,2-dicarboxylate (5o)

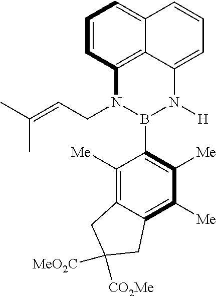

Following the general procedure, 5o is prepared from 1a (47.3 mg, 0.2 mmol) and 2ao (82.3 mg, 0.3 mmol). Purified by silica gel column chromatography (n-Hexane/EA=15/1-10/1), 5o is obtained as a white solid (101.7 mg, 99% yield).

### (S)-dimethyl 4,5,7-trimethyl-6-(1-(3-(trimethylsilyl)prop-2-yn-1-yl)-1H-naphtho[1,8-de][1,3,2]diazaborinin-2(3H)-yl)-1,3-dihydro-2H-indene-2,2-dicarboxylate (5p)

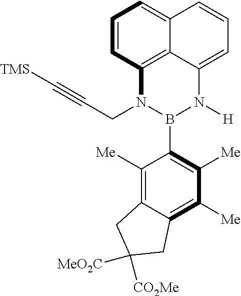

Following the general procedure, 5p is prepared from 1a (47.3 mg, 0.2 mmol) and 2ap (94.9 mg, 0.3 mmol). Purified by silica gel column chromatography (n-Hexane/EA=15/1-10/1), 5p is obtained as a white solid (110.3 mg, 99% yield).
2.5 Products from Reactions with Diyne 1 and a Series of Alkynyl Baams 2

### (R)-dimethyl 4,7-dimethyl-5-(3-methyl-4-oxo-3,4-dihydrobenzo[d][1,3,2]diazaborinin-2(1H)-yl)-6-pentyl-1,3-dihydro-2H-indene-2,2-dicarboxylate (6a)

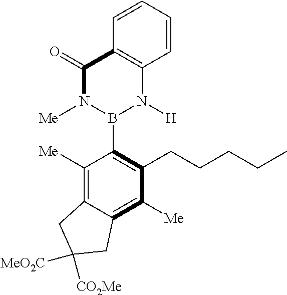

Following the general procedure, 6a is prepared from 1a (47.3 mg, 0.2 mmol) and 2ba (76.2 mg, 0.3 mmol). Purified by silica gel column chromatography (n-Hexane/EA=13/1-5/1), 6a is obtained as a white solid (60.0 mg, 61% yield).

### (S)-dimethyl 4,5,7-trimethyl-6-(3-methyl-4-oxo-3,4-dihydrobenzo[d][1,3,2]diazaborinin-2(1H)-yl)-1,3-dihydro-2H-indene-2,2-dicarboxylate (6b)

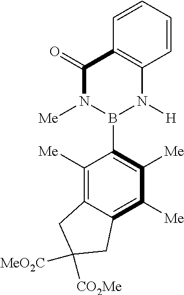

Following the general procedure, 6b is prepared from 1a (47.3 mg, 0.2 mmol) and 2bm (59.4 mg, 0.3 mmol). Purified by silica gel column chromatography (n-Hexane/EA=5/1-4/1), 6b is obtained as a white solid (77.9 mg, 90% yield).

### (R)-dimethyl-5-(3-chloropropyl)-4,7-dimethyl-6-(3-methyl-4-oxo-3,4-dihydrobenzo[d][1,3,2]diazaborinin-2(1H)-yl)-1,3-dihydro-2H-indene-2,2-dicarboxylate (6c)

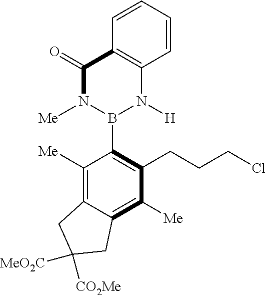

Following the general procedure, 6c is prepared from 1a (47.3 mg, 0.2 mmol) and 2bb (78.2 mg, 0.3 mmol). Purified by silica gel column chromatography (n-Hexane/EA=5/1-4/1), 6c is obtained as a white solid (88.3 mg, 89% yield).

### (R)-dimethyl 5-(3-butyl-4-oxo-3,4-dihydrobenzo[d][1,3,2]diazaborinin-2(1H)-yl)-6-(3-chloropropyl)-4,7-dimethyl-1,3-dihydro-2H-indene-2,2-dicarboxylate (6d)

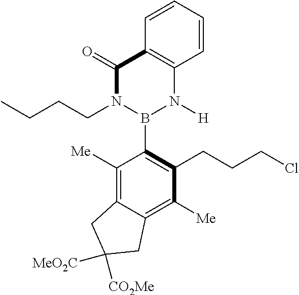

Following the general procedure, 6d is prepared from 1a (47.3 mg, 0.2 mmol) and 2bc (90.8 mg, 0.3 mmol). Purified by silica gel column chromatography (n-Hexane/EA=8/1-5/1), 6d is obtained as a white solid (95.0 mg, 88% yield).

### (R)-dimethyl 5-(3-chloropropyl)-6-(3-cyclopropyl-4-oxo-3,4-dihydrobenzo[d][1,3,2]diazaborinin-2(1H)-yl)-4,7-dimethyl-1,3-dihydro-2H-indene-2,2-dicarboxylate (6e)

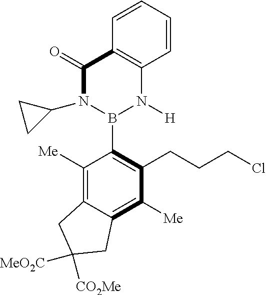

Following the general procedure, 6e is prepared from 1a (47.3 mg, 0.2 mmol) and 2bd (86.0 mg, 0.3 mmol). Purified by silica gel column chromatography (n-Hexane/EA=6/1-4/1), 6e is obtained as a white solid (83.6 mg, 80% yield).

### (R)-dimethyl 5-butyl-4,7-dimethyl-6-(4-oxo-3-phenyl-3,4-dihydrobenzo[d][1,3,2]diazaborinin-2(1H)-yl)-1,3-dihydro-2H-indene-2,2-dicarboxylate (6f)

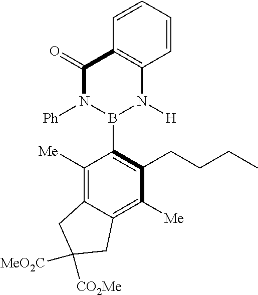

Following the general procedure, 6f is prepared from 1a (47.3 mg, 0.2 mmol) and 2be (90.7 mg, 0.3 mmol). Purified by silica gel column chromatography (n-Hexane/EA=8/1-4/1), 6f is obtained as a white solid (53.0 mg, 49% yield).

### (R)-dimethyl 4,7-dimethyl-5-(4-oxo-3-(2,2,2-trifluoroethyl)-3,4-dihydrobenzo[d][1,3,2]diazaborinin-2(1H)-yl)-6-phenethyl-1,3-dihydro-2H-indene-2,2-dicarboxylate (6g)

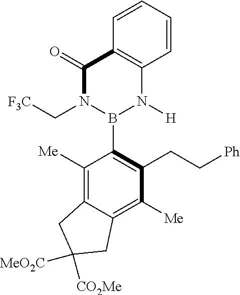

Following the general procedure, 6g is prepared from 1a (47.3 mg, 0.2 mmol) and 2bf (106.9 mg, 0.3 mmol). Purified by silica gel column chromatography (n-Hexane/EA=8/1-5/1), 6g is obtained as a white solid (93.9 mg, 79% yield).

### (R)-3-benzyl-2-(6-(2-((tert-butyldimethylsilyl)oxy)ethyl)-2,2-bis(methoxymethyl)-4,7-dimethyl-2,3-dihydro-1H-inden-5-yl)-2,3-dihydrobenzo[d][1,3,2]diazaborinin-4(1H)-one (6h)

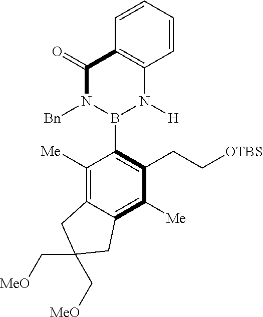

Following the general procedure, 6h is prepared from 1g (41.7 mg, 0.2 mmol) and 2bg (125.5 mg, 0.3 mmol). Purified by silica gel column chromatography (n-Hexane/EA=30/1-15/1), 6h is obtained as a white solid (64.1 mg, 51% yield).

### (R)-1,1′-(5-(3-cyclohexyl-4-oxo-3,4-dihydrobenzo[d][1,3,2]diazaborinin-2(1H)-yl)-4,7-dimethyl-6-phenethyl-2,3-dihydro-1H-indene-2,2-diyl)bis(ethan-1-one) (6i)

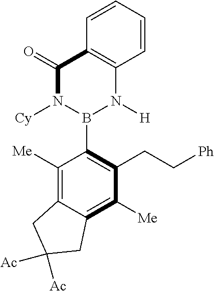

Following the general procedure, 6i is prepared from 1d (40.8 mg, 0.2 mmol) and 2bh (106.9 mg, 0.3 mmol). Purified by silica gel column chromatography (n-Hexane/EA=9/1-5/1), 6h is obtained as a white solid (62.8 mg, 56% yield).

### (R)-dimethyl (R)-5-(3-chloropropyl)-4,7-dimethyl-6-(4-oxo-3-(1-phenylethyl)-3,4-dihydrobenzo[d][1,3,2]diazaborinin-2(1H)-yl)-1,3-dihydro-2H-indene-2,2-dicarboxylate (6j)

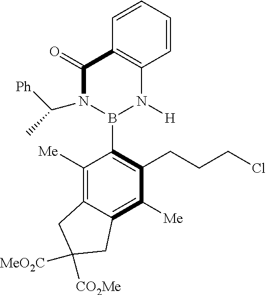

Following the general procedure, 6j is prepared from 1a (47.3 mg, 0.2 mmol) and 2bi (105.2 mg, 0.3 mmol). Purified by silica gel column chromatography (n-Hexane/EA=8/1-5/1), 6j is obtained as a white solid (67.2 mg, 57% yield). ¹H-NMR analysis showed that diastereomeric ratio is 13/1.

### (R)-dimethyl (S)-5-(3-chloropropyl)-4,7-dimethyl-6-(4-oxo-3-(1-phenylethyl)-3,4-dihydrobenzo[d][1,3,2]diazaborinin-2(1H)-yl)-1,3-dihydro-2H-indene-2,2-dicarboxylate (6k)

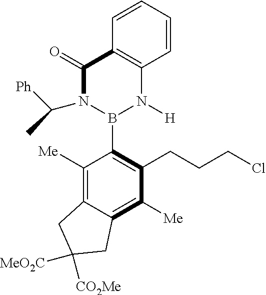

Following the general procedure, 6k is prepared from 1a (47.3 mg, 0.2 mmol) and 2bj (105.2 mg, 0.3 mmol). Purified by silica gel column chromatography (n-Hexane/EA=10/1-4/1), 6k is obtained as a white solid (46.8 mg, 40% yield). ¹H-NMR analysis showed that diastereomeric ratio is 7/1.

### (R)-dimethyl 4,7-dimethyl-5-(1-methyl-4-oxo-3,4-dihydrobenzo[d][1,3,2]diazaborinin-2(1H)-yl)-6-pentyl-1,3-dihydro-2H-indene-2,2-dicarboxylate (6l)

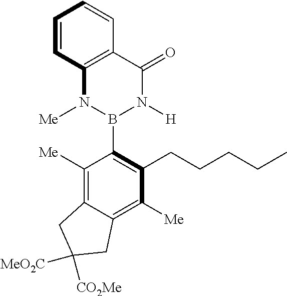

Following the general procedure, 6l is prepared from 1a (47.3 mg, 0.2 mmol) and 2bk (76.2 mg, 0.3 mmol). Purified by silica gel column chromatography (n-Hexane/EA=5/1-4/1), 6l is obtained as a white solid (63.0 mg, 64% yield).

### (R)-1-benzyl-2-(2,2-bis(methoxymethyl)-4,7-dimethyl-6-phenethyl-2,3-dihydro-1H-inden-5-yl)-2,3-dihydrobenzo[d][1,3,2]diazaborinin-4(1H)-one (6m)

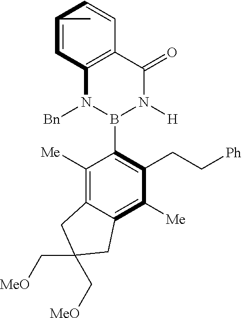

Following the general procedure, 6m is prepared from 1g (41.7 mg, 0.2 mmol) and 2bl (109.3 mg, 0.3 mmol). Purified by silica gel column chromatography (DCM/EA=9/1), 6m is obtained as a white solid (48.7 mg, 43% yield).

### 2.6 Late-Stage Modification of Drugs

The rhodium-catalyzed [2+2+2] cycloaddition can also be applied to the late-stage modification of drugs. In the following examples, the rhodium-catalyzed [2+2+2] cycloaddition has been tested on two specific drugs, Probenecid and Gemfibrozil. It is anticipated that more drugs be compatible to this modification scheme.

### (R)-dimethyl-5-(1-benzyl-1H-naphtho[1,8-de][1,3,2]diazaborinin-2(3H)-yl)-6-(2-((4-(N,N-dipropylsulfamoyl)benzoyl)oxy)ethyl)-4,7-dimethyl-1,3-dihydro-2H-indene-2,2-dicarboxylate (7a)

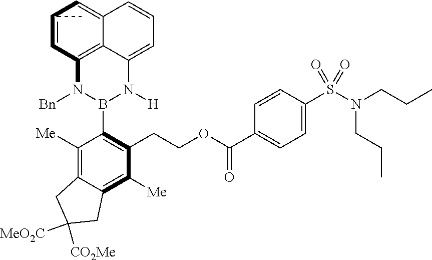

Following the general procedure, 7a is prepared from 1a (47.3 mg, 0.2 mmol) and 2t (178.1 mg, 0.3 mmol). Purified by silica gel column chromatography (n-Hexane/EA=6/1-4/1), 7a is obtained as a white solid (152.0 mg, 92% yield).

### (R)-3-(6-(1-benzyl-1H-naphtho[1,8-de][1,3,2]diazaborinin-2(3H)-yl)-4,7-dimethyl-2-tosylisoindolin-5-yl)propyl 5-(2,5-dimethylphenoxy)-2,2-dimethylpentanoate (7b)

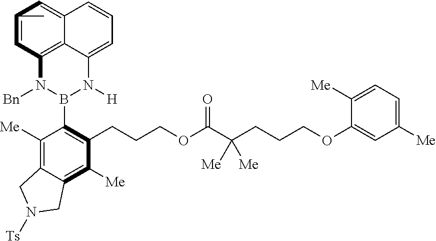

Following the general procedure, 7b is prepared from 1m (55.1 mg, 0.2 mmol) and 2u (171.8 mg, 0.3 mmol). Purified by silica gel column chromatography (n-Hexane/EA=10/1-6/1), 7b is obtained as a white solid (89.3 mg, 53% yield).

### 3. Transformation of C—B Atropisomers

### 3.1 Basic Functional Group Transformations

An oven-dried 25 mL Schlenk flask equipped with a magnetic stir bar is charged with 4h (357 mg, 0.6 mmol) and NaSPh (158.6 mg, 1.2 mmol). The flask is sealed with a rubber stopper, evacuated and filled with nitrogen gas three times. Then, DMF (6 mL, 0.1 M) is added by syringe. The reaction is stirred at room temperature for 2 hours and crude NMR showed full conversion of 4h. After that, brine (10 mL) and EA (10 mL) are added and the layers are separated. The organic phase is washed with brine (3×10 mL) three times, and the combined aqueous phase is extracted with EA (10 mL) once. The combined organic phase is dried over Na₂SO₄, concentrated under reduce pressure, and purified by silica gel column chromatography (n-Hexane/EA=10/1-5/1) to afford 8a as a white solid (324 mg, 81% yield).

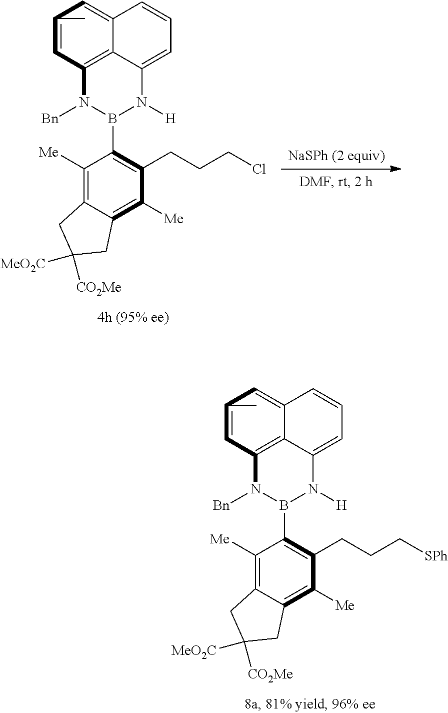

### (R)-dimethyl 5-(1-benzyl-1H-naphtho[1,8-de][1,3,2]diazaborinin-2(3H)-yl)-4,7-dimethyl-6-(3-(phenylthio)propyl)-1,3-dihydro-2H-indene-2,2-dicarboxylate (8a)

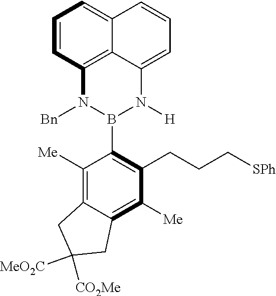

An oven-dried 25 mL Schlenk flask equipped with a magnetic stir bar is charged with 4k (730.7 mg, 1 mmol) and NaI (300 mg, 2 mmol). The flask is sealed with a rubber stopper, evacuated and filled with nitrogen gas three times. Then, acetone (5 mL, 0.2 M) is added by syringe. The reaction is stirred at 60° C. for 24 hours and TLC showed full conversion of 4k. After that, the mixture is filtered through a short pad of silica gel and rinsed with EA. The filtrate is concentrated under reduced pressure to afford a crude product, which is purified by silica gel column chromatography (n-Hexane/EA=10/1-5/1) to afford 8b as a white solid (629.6 mg, 92% yield).

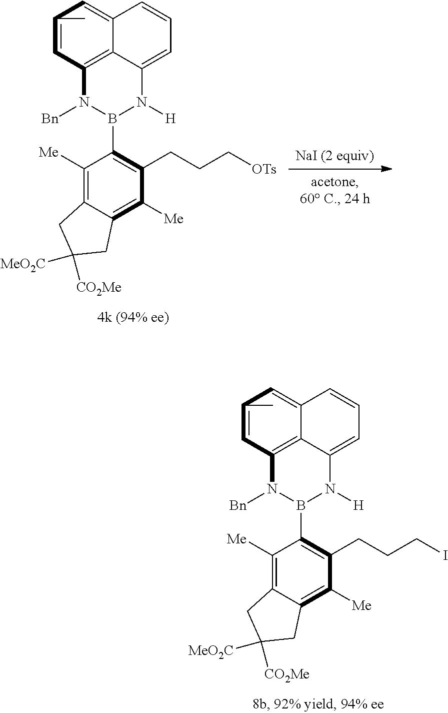

### (R)-dimethyl 5-(1-benzyl-1H-naphtho[1,8-de][1,3,2]diazaborinin-2(3H)-yl)-6-(3-iodopropyl)-4,7-dimethyl-1,3-dihydro-2H-indene-2,2-dicarboxylate (8b)

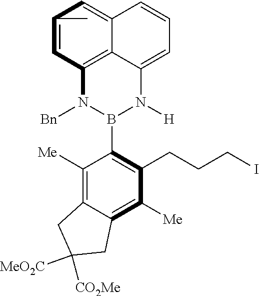

An oven-dried 25 mL Schlenk flask equipped with a magnetic stir bar is charged with 8b (343.2 mg, 0.5 mmol) TBAI (36.9 mg, 0.1 mmol), diphenylphosphine oxide (202.2 mg, 1 mmol), and K₂CO₃ (138.2 mg, 1 mmol). The flask is sealed with a rubber stopper, evacuated and filled with nitrogen gas three times. Then, DMF (5 mL, 0.1 M) is added by syringe. The reaction is stirred at 70° C. for 15 hours and TLC showed full conversion of 8b. After that, brine (10 mL) and EA (10 mL) are added and the layers are separated. The organic phase is washed with brine (3×10 mL) three times, and the combined aqueous phase is extracted with EA (10 mL) once. The combined organic phase is dried over Na₂SO₄, concentrated under reduce pressure, and purified by silica gel column chromatography (toluene/EA=1/1) to afford 8c as a white solid (209.3 mg, 55% yield).

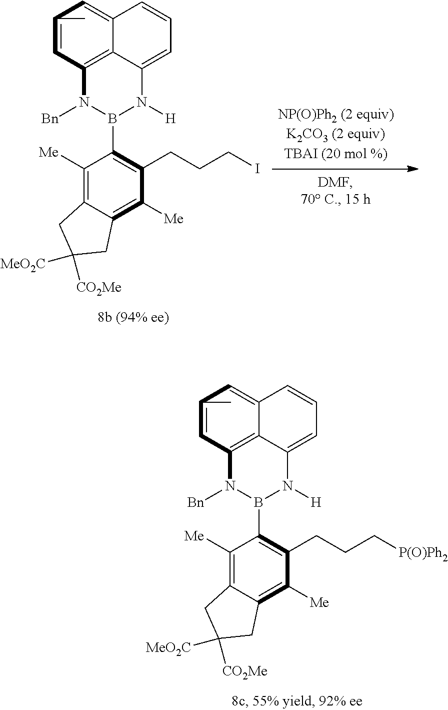

### (R)-dimethyl-5-(1-benzyl-1H-naphtho[1,8-de][1,3,2]diazaborinin-2(3H)-yl)-6-(3-(diphenylphosphoryl)propyl)-4,7-dimethyl-1,3-dihydro-2H-indene-2,2-dicarboxylate (8c)

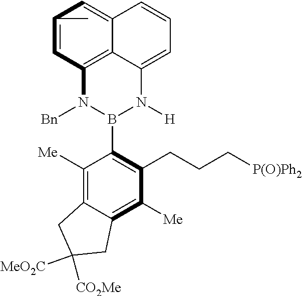

An oven-dried 25 mL Schlenk flask equipped with a magnetic stir bar is charged with 8b (686 mg, 1 mmol) and NaN₃ (130 mg, 2 mmol). The flask is sealed with a rubber stopper, evacuated and filled with nitrogen gas three times. Then, DMF (10 mL, 0.1 M) is added by syringe. The reaction is stirred at 60° C. for 3 hours and crude NMR showed full conversion of 8b. After that, brine (10 mL) and EA (10 mL) are added and the layers are separated. The organic phase is washed with brine (3×10 mL) three times, and the combined aqueous phase is extracted with EA (10 mL) once. The combined organic phase is dried over Na₂SO₄, concentrated under reduce pressure, and purified by silica gel column chromatography (n-Hexane/EA=10/1-5/1) to afford 8d as a white solid (520 mg, 86% yield).

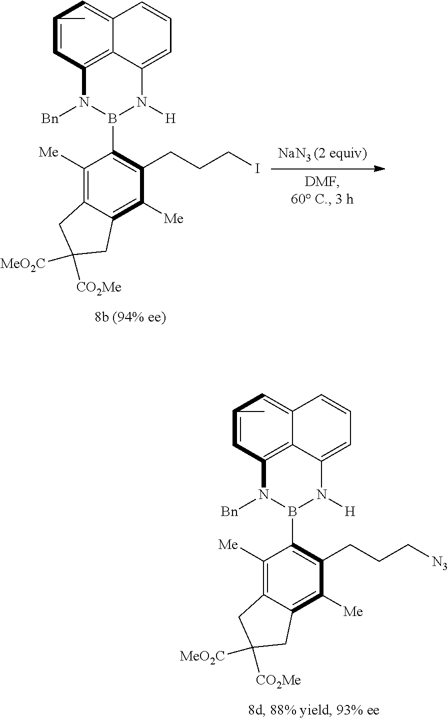

### (R)-dimethyl 5-(3-azidopropyl)-6-(1-benzyl-1H-naphtho[1,8-de][1,3,2]diazaborinin-2(3H)-yl)-4,7-dimethyl-1,3-dihydro-2H-indene-2,2-dicarboxylate (8d)

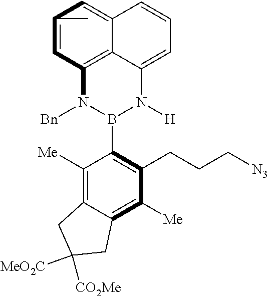

A 10 mL reaction tube equipped with a magnetic stir bar is charged with 8d (120.3 mg, 0.2 mmol), CuSO₄ (1.6 mg, 0.01 mmol) and sodium ascorbate (7.9 mg, 0.04 mmol). Then, ^{t}BuOH (1 mL), H₂O (1 mL) and phenylacetylene (44 μL, 0.4 mmol) are added by syringe successively. The tube is sealed with a rubber stopper and the reaction is stirred at 60° C. for 15 hours. After that, TLC showed full conversion of 8d. Brine (10 mL) and EA (10 mL) are added and the layers are separated (Note: use ultrasonics to ensure everything dissolved in the solution). The organic phase is washed with brine (3×10 mL) three times, and the combined aqueous phase is extracted with EA (10 mL) once. The combined organic phase is dried over Na₂SO₄, concentrated under reduce pressure, and purified by silica gel column chromatography (n-Hexane/EA=3/1-2/1) to afford 8e as a white solid (136.5 mg, 97% yield).

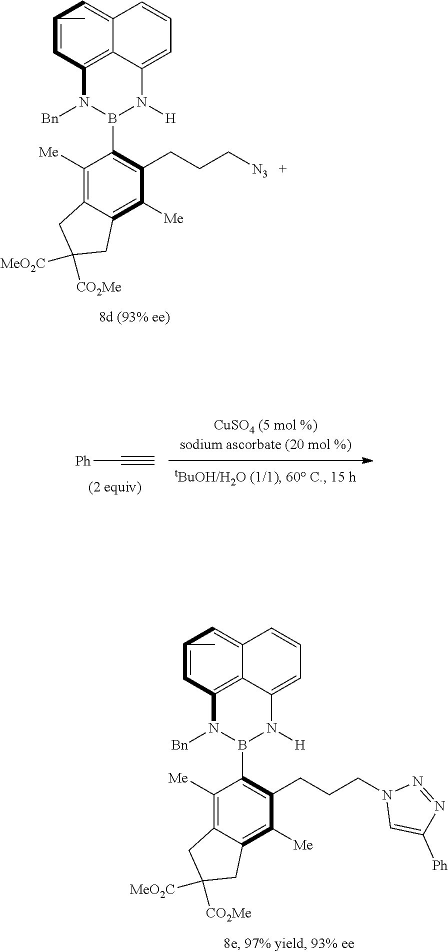

### (R)-dimethyl 5-(1-benzyl-1H-naphtho[1,8-de][1,3,2]diazaborinin-2(3H)-yl)-4,7-dimethyl-6-(3-(4-phenyl-1H-1,2,3-triazol-1-yl)propyl)-1,3-dihydro-2H-indene-2,2-dicarboxylate (8e)

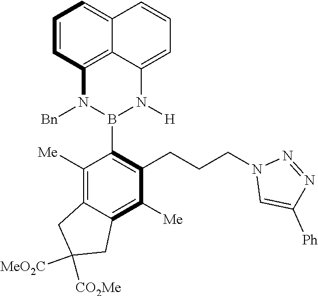

### 3.2 Synthesis of Tetra-Ortho-Substituted Axially Chiral Arylboron Compounds

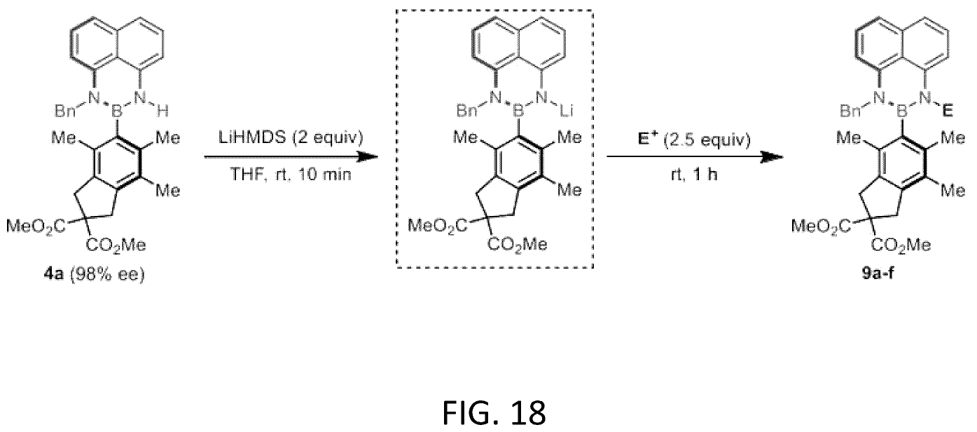

Procedure: An oven-dried 10 mL Schlenk tube equipped with a magnetic stir bar is charged with 4a (106.5 mg, 0.2 mmol, 98% ee). The tube is sealed with a rubber stopper, evacuated and filled with nitrogen gas three times, followed by the addition of dry THF (2 mL). Then, LiHMDS (0.4 mL, 1 M in THF) is slowly added via syringe to the mixture. The reaction is stirred at room temperature for 10 minutes and the solution turned to yellow. After that, electrophile (0.5 mmol) is added to the mixture and the reaction is further stirred at room temperature for 1 hour. TLC or crude NMR showed full conversion of 4a. The mixture is filtered through a short pad of silica gel and rinsed with EA. The filtrate is concentrated under reduced pressure to afford a crude product, which is purified by silica gel column chromatography to afford 9a-f. See FIG. 18.

### (S)-dimethyl 5-(1-benzyl-3-methyl-1H-naphtho[1,8-de][1,3,2]diazaborinin-2(3H)-yl)-4,6,7-trimethyl-1,3-dihydro-2H-indene-2,2-dicarboxylate (9a)

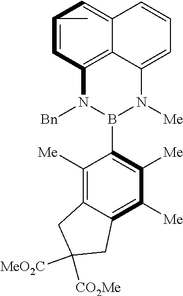

Following the above procedure, 9a is prepared by employing iodomethane (31 ┘L, 0.5 mmol) as the electrophile. Purified by silica gel column chromatography (n-Hexane/EA=15/1-10/1), 9a is obtained as a white solid (90.4 mg, 83% yield).

### (S)-dimethyl 5-(1-benzyl-3-(trimethylsilyl)-1H-naphtho[1,8-de][1,3,2]diazaborinin-2(3H)-yl)-4,6,7-trimethyl-1,3-dihydro-2H-indene-2,2-dicarboxylate (9b)

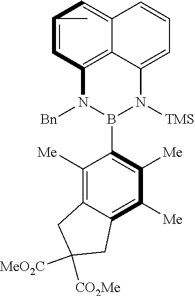

Following the above procedure, 9b is prepared by employing chlorotrimethylsilane (63.4 ┘L, 0.5 mmol) as the electrophile. Purified by silica gel column chromatography (n-Hexane/EA=20/1-15/1), 9b is obtained as a white solid (109.7 mg, 91% yield).

### (S)-dimethyl 5-(4-benzoyl-1-benzyl-1H-naphtho[1,8-de][1,3,2]diazaborinin-2(3H)-yl)-4,6,7-trimethyl-1,3-dihydro-2H-indene-2,2-dicarboxylate (9c)

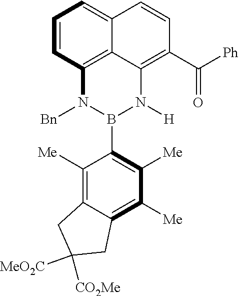

Following the above procedure, 9c is prepared by employing benzoyl chloride (58 ┘L, 0.5 mmol) as the electrophile. Purified by silica gel column chromatography (n-Hexane/EA=10/1-5/1), 9c is obtained as a yellow solid (119.3 mg, 94% yield). ¹H-NMR and ¹³C-DEPT 135 NMR analysis clearly showed that benzoylation occurred at the naphthalene position, not N position. In ¹H-NMR spectrum, a low-field proton chemical shift (δ=11.03) is observed, resulting from the presence of an intramolecular hydrogen bonding between N—H and benzoyl O atom. ¹³C-DEPT 135 NMR spectrum showed that totally 11 CH is observed in the aromatic region.

### (R)-dimethyl 5-(1-benzyl-3-(diphenylphosphaneyl)-1H-naphtho[1,8-de][1,3,2]diazaborinin-2(3H)-yl)-4,6,7-trimethyl-1,3-dihydro-2H-indene-2,2-dicarboxylate (9d)

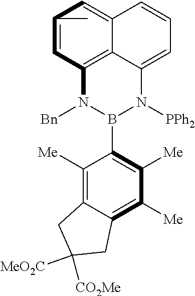

Following the above procedure, 9d is prepared by employing chlorodiphenylphosphine (90 ┘L, 0.5 mmol) as the electrophile. Purified by silica gel column chromatography (n-Hexane/EA=8/1-6/1), 9d is obtained as a white solid (126.1 mg, 88% yield).

### (R)-dimethyl 5-(1-benzyl-3-(dicyclohexylphosphaneyl)-1H-naphtho[1,8-de][1,3,2]diazaborinin-2(3H)-yl)-4,6,7-trimethyl-1,3-dihydro-2H-indene-2,2-dicarboxylate (9e)

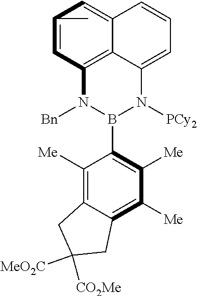

Following the above procedure, 9e is prepared by employing chlorodicyclohexylphosphine (110.4_L, 0.5 mmol) as the electrophile. Purified by silica gel column chromatography (n-Hexane/EA=20/1-16/1), 9e is obtained as a white solid (128.8 mg, 88% yield).

### (R)-dimethyl 5-(1-benzyl-3-(diisopropylphosphaneyl)-1H-naphtho[1,8-de][1,3,2]diazaborinin-2(3H)-yl)-4,6,7-trimethyl-1,3-dihydro-2H-indene-2,2-dicarboxylate (9f)

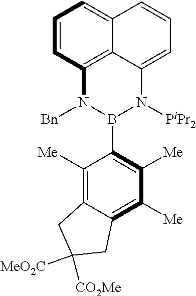

Following the above procedure, 9f is prepared by employing chlorodiisopropylphosphine (80 ┘L, 0.5 mmol) as the electrophile. Purified by silica gel column chromatography (n-Hexane/EA=15/1-10/1), 9f is obtained as a white solid (94.4 mg, 73% yield).

### 3.3 Construction of a Novel Chiral Phosphine Ligand Library

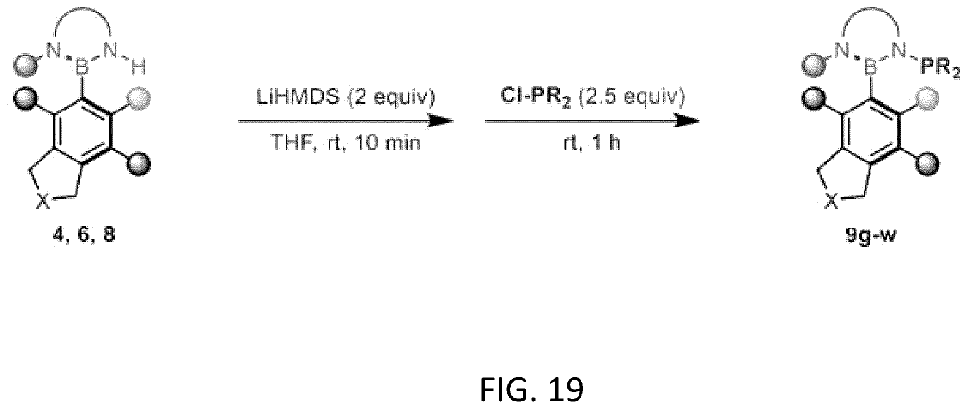

Procedure: An oven-dried 10 mL Schlenk tube equipped with a magnetic stir bar is charged with axially chiral arylboron scaffold 4 or 6 or 8 (0.2 mmol). The tube is sealed with a rubber stopper, evacuated and filled with nitrogen gas three times, followed by the addition of dry THF (2 mL). Then, LiHMDS (0.4 mL, 1 M in THF) is slowly added via syringe to the mixture. The reaction is stirred at room temperature for 10 minutes and the solution turned to yellow. After that, phosphine electrophile Cl-PR₂ (0.5 mmol) is added to the mixture and the reaction is further stirred at room temperature for 1 hour. TLC or crude NMR showed full conversion of substrate. The mixture is filtered through a short pad of silica gel and rinsed with EA. The filtrate is concentrated under reduced pressure to afford a crude product, which is purified by silica gel column chromatography to afford chiral phosphine ligand 9g-w. See FIG. 19.

### (S)-dimethyl 5-(1-benzyl-3-(diphenylphosphaneyl)-1H-naphtho[1,8-de][1,3,2]diazaborinin-2(3H)-yl)-4,7-dimethyl-6-((trimethylsilyl)methyl)-1,3-dihydro-2H-indene-2,2-dicarboxylate (9g)

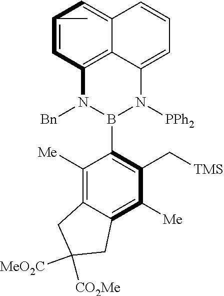

Following the above procedure, 9g was prepared from 4o (90.7 mg, 0.15 mmol, 98% ee) and chlorodiphenylphosphine (67.3 ┘L, 0.375 mmol). Purified by silica gel column chromatography (n-Hexane/EA=10/1-8/1), 9g was obtained as a white solid (104.0 mg, 88% yield).

### (S)-dimethyl 5-(1-benzyl-3-(dicyclohexylphosphaneyl)-1H-naphtho[1,8-de][1,3,2]diazaborinin-2(3H)-yl)-4,7-dimethyl-6-((trimethylsilyl)methyl)-1,3-dihydro-2H-indene-2,2-dicarboxylate (9h)

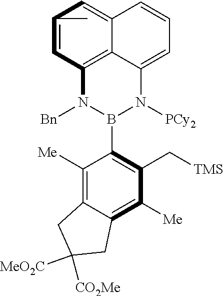

Following the above procedure, 9h is prepared from 4o (90.7 mg, 0.15 mmol, 98% ee) and chlorodicyclohexylphosphine (83 ┘L, 0.375 mmol). Purified by silica gel column chromatography (n-Hexane/EA=20/1-16/1), 9h is obtained as a white solid (69.0 mg, 57% yield).

### (S)-dimethyl 5-(1-benzyl-3-(diphenylphosphaneyl)-1H-naphtho[1,8-de][1,3,2]diazaborinin-2(3H)-yl)-4,7-dimethyl-6-phenethyl-1,3-dihydro-2H-indene-2,2-dicarboxylate (9i)

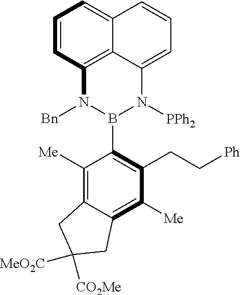

Following the above procedure, 9i is prepared from 4g (105.8 mg, 0.17 mmol, 94% ee) and chlorodiphenylphosphine (76 ┘L, 0.425 mmol). Purified by silica gel column chromatography (n-Hexane/EA=15/1-8/1), 9i is obtained as a white solid (124.7 mg, 91% yield).

### (S)-dimethyl 5-(1-benzyl-3-(dicyclohexylphosphaneyl)-1H-naphtho[1,8-de][1,3,2]diazaborinin-2(3H)-yl)-4,7-dimethyl-6-phenethyl-1,3-dihydro-2H-indene-2,2-dicarboxylate (9j)

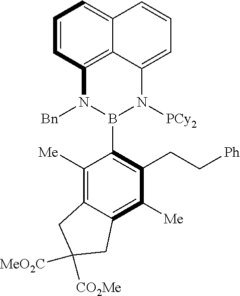

Following the above procedure, 9j is prepared from 4g (105.8 mg, 0.17 mmol, 94% ee) and chlorodicyclohexylphosphine (94 ┘L, 0.425 mmol). Purified by silica gel column chromatography (n-Hexane/EA=20/1-10/1), 9j is obtained as a white solid (111.5 mg, 80% yield).

### (S)-dimethyl 5-(1-benzyl-3-(diphenylphosphaneyl)-1H-naphtho[1,8-de][1,3,2]diazaborinin-2(3H)-yl)-6-(3-chloropropyl)-4,7-dimethyl-1,3-dihydro-2H-indene-2,2-dicarboxylate (9k)

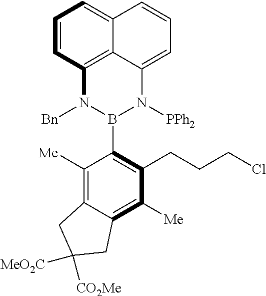

Following the above procedure, 9k is prepared from 4h (119 mg, 0.2 mmol, 96% ee) and chlorodiphenylphosphine (90 ┘L, 0.5 mmol). Purified by silica gel column chromatography (n-Hexane/EA=6/1-5/1), 9k is obtained as a white solid (141.9 mg, 91% yield).

### (S)-dimethyl 5-(1-benzyl-3-(dicyclohexylphosphaneyl)-1H-naphtho[1,8-de][1,3,2]diazaborinin-2(3H)-yl)-6-(3-chloropropyl)-4,7-dimethyl-1,3-dihydro-2H-indene-2,2-dicarboxylate (9l)

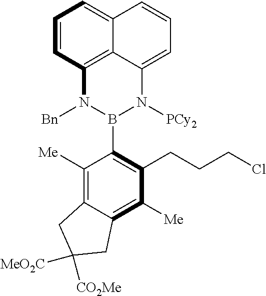

Following the above procedure, 9l is prepared from 4h (119 mg, 0.2 mmol, 96% ee) and chlorodicyclohexylphosphine (110.4 μL, 0.5 mmol). Purified by silica gel column chromatography (n-Hexane/EA=9/1), 9l is obtained as a white solid (139.2 mg, 88% yield).

### (S)-dimethyl 5-(1-benzyl-3-(diphenylphosphaneyl)-1H-naphtho[1,8-de][1,3,2]diazaborinin-2(3H)-yl)-6-(2-((tert-butyldimethylsilyl)oxy)ethyl)-4,7-dimethyl-1,3-dihydro-2H-indene-2,2-dicarboxylate (9m)

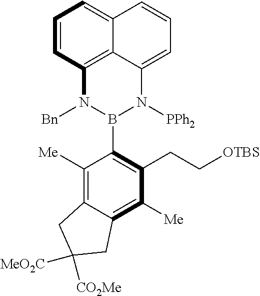

Following the above procedure, 9m is prepared from 4i (270.7 mg, 0.4 mmol, 95% ee) and chlorodiphenylphosphine (180 μL, 1 mmol). Purified by silica gel column chromatography (n-Hexane/EA=10/1-5/1), 9m is obtained as a white solid (321.5 mg, 99% yield).

### (S)-dimethyl 5-(1-benzyl-3-(diphenylphosphaneyl)-1H-naphtho[1,8-de][1,3,2]diazaborinin-2(3H)-yl)-4,7-dimethyl-6-(3-(phenylthio)propyl)-1,3-dihydro-2H-indene-2,2-dicarboxylate (9n)

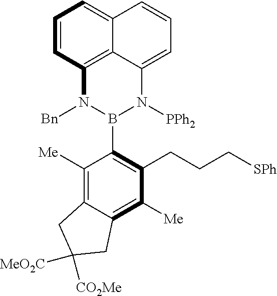

Following the above procedure, 9n is prepared from 8a (133.7 mg, 0.2 mmol, 96% ee) and chlorodiphenylphosphine (90 μL, 0.5 mmol). Purified by silica gel column chromatography (n-Hexane/EA=9/1-5/1), 9n is obtained as a white solid (152.2 mg, 89% yield).

### (S)-dimethyl 5-(1-benzyl-3-(dicyclohexylphosphaneyl)-1H-naphtho[1,8-de][1,3,2]diazaborinin-2(3H)-yl)-4,7-dimethyl-6-(3-(phenylthio)propyl)-1,3-dihydro-2H-indene-2,2-dicarboxylate (9o)

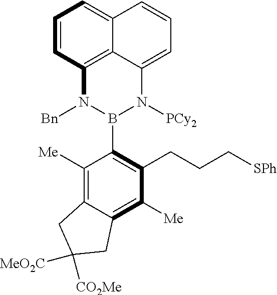

Following the above procedure, 9o is prepared from 8a (120.4 mg, 0.18 mmol, 96% ee) and chlorodicyclohexylphosphine (100 μL, 0.45 mmol). Purified by silica gel column chromatography (n-Hexane/EA=10/1), 9o is obtained as a white solid (139.1 mg, 89% yield).

### (S)-dimethyl 5-(1-benzyl-3-(diphenylphosphaneyl)-1H-naphtho[1,8-de][1,3,2]diazaborinin-2(3H)-yl)-6-(3-(diphenylphosphoryl)propyl)-4,7-dimethyl-1,3-dihydro-2H-indene-2,2-dicarboxylate (9p)

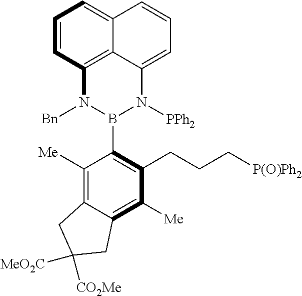

### 5-(1-benzyl-3-(diphenylphosphaneyl)-1H-naphtho[1,8-de][1,3,2]diazaborinin-2(3H)-yl)-4,7-dimethyl-6-phenyl-1,3-dihydro-2H-indene-2,2-dicarboxylate (9q)

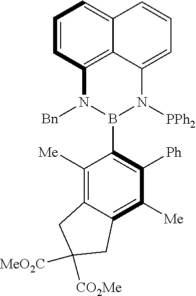

### (S)-dimethyl (E)-5-(1-benzyl-3-(diphenylphosphaneyl)-1H-naphtho[1,8-de][1,3,2]diazaborinin-2(3H)-yl)-4,7-dimethyl-6-styryl-1,3-dihydro-2H-indene-2,2-dicarboxylate (9r)

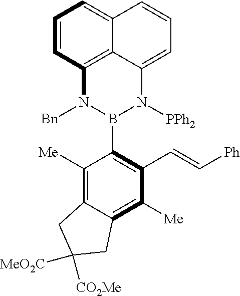

Following the above procedure, 9r is prepared from 4s (124.1 mg, 0.2 mmol, 93% ee) and chlorodiphenylphosphine (90 μL, 0.5 mmol). Purified by silica gel column chromatography (n-Hexane/EA=10/1-5/1), 9r is obtained as a white solid (145.3 mg, 90% yield).

### (S)-dimethyl (E)-5-(1-benzyl-3-(dicyclohexylphosphaneyl)-1H-naphtho[1,8-de][1,3,2]diazaborinin-2(3H)-yl)-4,7-dimethyl-6-styryl-1,3-dihydro-2H-indene-2,2-dicarboxylate (9s)

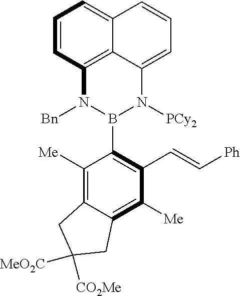

Following the above procedure, 9s is prepared from 4s (124.1 mg, 0.2 mmol, 93% ee) and chlorodicyclohexylphosphine (110.4 μL, 0.5 mmol). Purified by silica gel column chromatography (n-Hexane/EA=15/1), 9s is obtained as a white solid (129.8 mg, 79% yield).

### (R)-1-benzyl-3-(diphenylphosphaneyl)-2-(4,6,7-trimethyl-2-tosylisoindolin-5-yl)-2,3-dihydro-1H-naphtho[1,8-de][1,3,2]diazaborinine (9t)

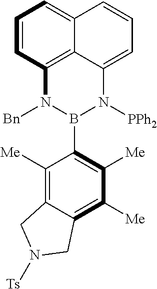

Following the above procedure, 9t is prepared from 4b (114.3 mg, 0.2 mmol, 99% ee) and chlorodiphenylphosphine (90 μL, 0.5 mmol). Purified by silica gel column chromatography (n-Hexane/EA=10/1-5/1), 9t is obtained as a white solid (144.2 mg, 95% yield).

### (R)-1-benzyl-3-(dicyclohexylphosphaneyl)-2-(4,6,7-trimethyl-2-tosylisoindolin-5-yl)-2,3-dihydro-1H-naphtho[1,8-de][1,3,2]diazaborinine (9u)

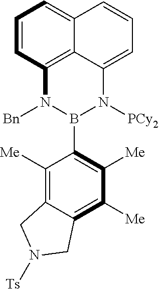

Following the above procedure, 9u is prepared from 4b (114.3 mg, 0.2 mmol, 99% ee) and chlorodicyclohexylphosphine (110.4 μL, 0.5 mmol). Purified by silica gel column chromatography (n-Hexane/EA=15/1), 9u is obtained as a white solid (132.8 mg, 86% yield).

### (S)-dimethyl 5-(3-chloropropyl)-6-(1-(diphenylphosphaneyl)-3-methyl-4-oxo-3,4-dihydrobenzo[d][1,3,2]diazaborinin-2(1H)-yl)-4,7-dimethyl-1,3-dihydro-2H-indene-2,2-dicarboxylate (9v)

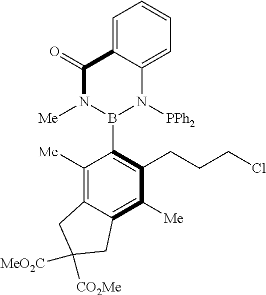

Following the above procedure, 9v is prepared from 6c (99.4 mg, 0.2 mmol, 96% ee) and chlorodiphenylphosphine (90 μL, 0.5 mmol). Purified by silica gel column chromatography (n-Hexane/EA=4/1-3/1), 9v is obtained as a white solid (95.3 mg, 70% yield).

### (S)-dimethyl 5-(3-chloropropyl)-6-(1-(dicyclohexylphosphaneyl)-3-methyl-4-oxo-3,4-dihydrobenzo[d][1,3,2]diazaborinin-2(1H)-yl)-4,7-dimethyl-1,3-dihydro-2H-indene-2,2-dicarboxylate (9w)

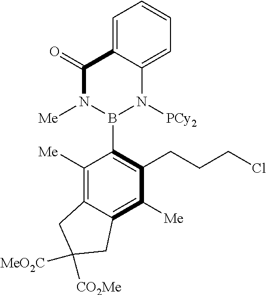

Following the above procedure, 9w is prepared from 6c (99.4 mg, 0.2 mmol, 96% ee) and chlorodicyclohexylphosphine (110.4 μL, 0.5 mmol). Purified by silica gel column chromatography (n-Hexane/EA=5/1-4/1), 9w is obtained as a white solid (125.4 mg, 90% yield).

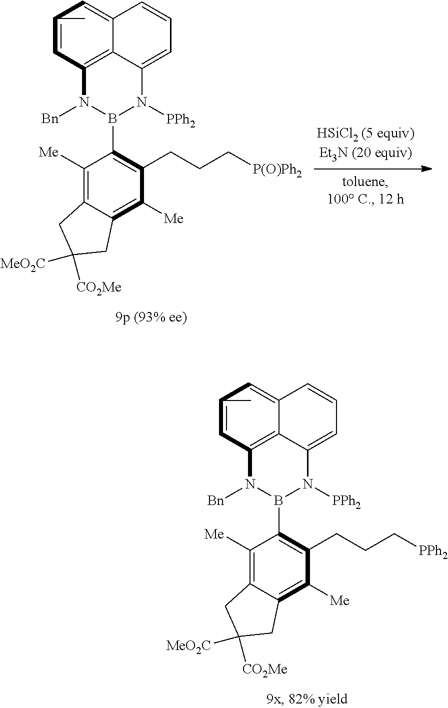

An oven-dried 10 mL Schlenk tube equipped with a magnetic stir bar is charged with 9p (283.5 mg, 0.3 mmol). The tube is sealed with a rubber stopper, evacuated and filled with nitrogen gas three times, followed by the addition of dry toluene (3 mL, 0.1 M) and triethylamine (0.83 mL, 6 mmol). Then, the mixture is cooled down to 0° C. and trichlorosilane (0.15 mL, 1.5 mmol) is added dropwise by syringe. After the addition is completed, the reaction is heated to 100° C. and stirred for 12 hours. TLC showed full conversion of 9p. The mixture is poured into 10 mL water at 0° C. and EA (10 mL) is added. The layers are separated and the aqueous phase is extracted with EA three times (3×10 mL). The combined organic phase is washed with brine (10 mL) once, dried over Na₂SO₄, filtered, and concentrated under reduced pressure to afford a crude product, which is purified by silica gel column chromatography (n-Hexane/EA=10/1-5/1) to afford 9x as a white solid (227.4 mg, 82% yield).

### (S)-dimethyl 5-(1-benzyl-3-(diphenylphosphaneyl)-1H-naphtho[1,8-de][1,3,2]diazaborinin-2(3H)-yl)-6-(3-(diphenylphosphaneyl)propyl)-4,7-dimethyl-1,3-dihydro-2H-indene-2,2-dicarboxylate (9x)

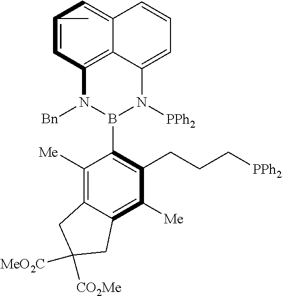

### 3.4 Synthesis of Bridged C—B Atropisomers

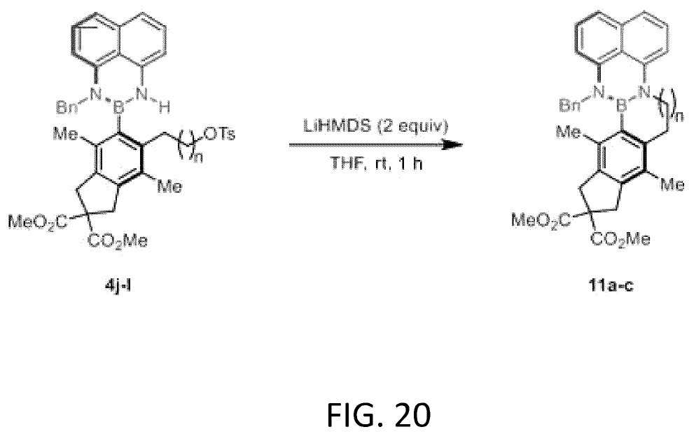

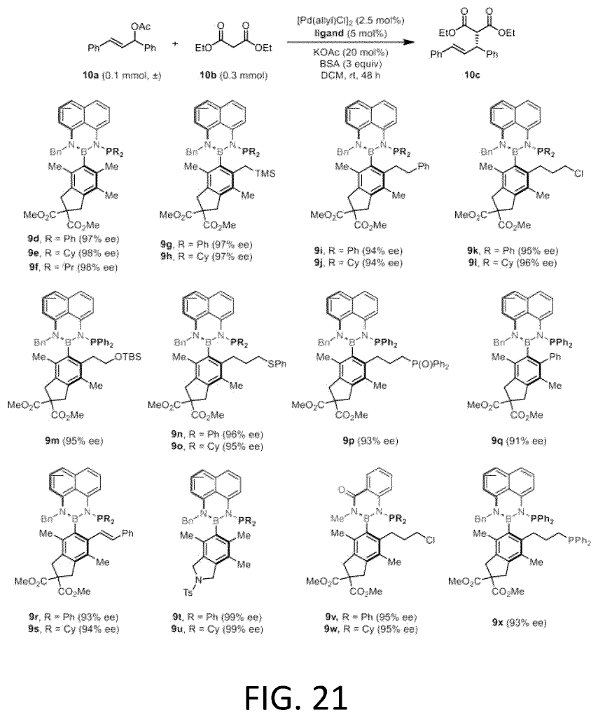

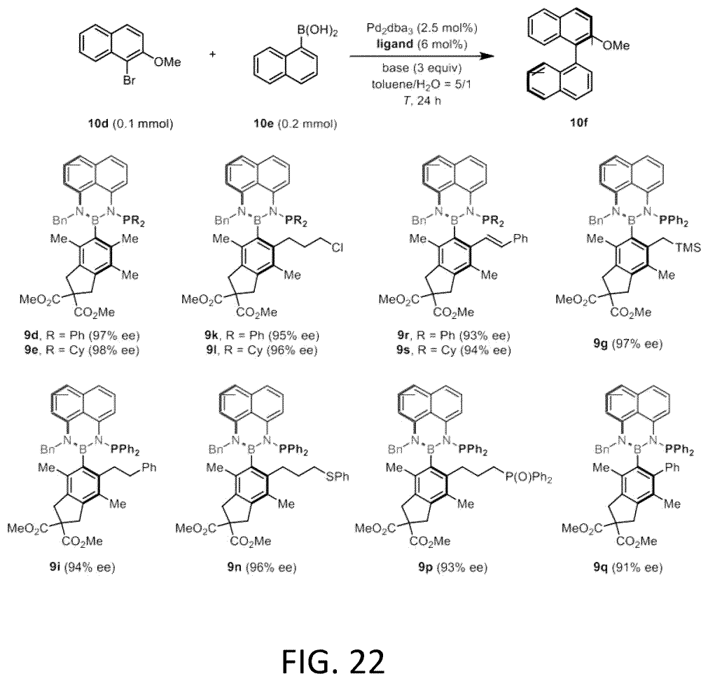

Procedure: An oven-dried 25 mL Schlenk flask equipped with a magnetic stir bar is charged with OTs-substituted axially chiral arylboron scaffold 4j-l (0.45 mmol). The flask is sealed with a rubber stopper, evacuated and filled with nitrogen gas three times, followed by the addition of dry THF (4.5 mL, 0.1 M). Then, LiHMDS (0.9 mL, 0.1 M in THF) is slowly added via syringe to the mixture. The reaction is stirred at room temperature for 1 hour and TLC showed full conversion of substrate 4j-l. The mixture is filtered through a short pad of silica gel and rinsed with EA. The filtrate is concentrated under reduced pressure to afford a crude product, which is purified by silica gel column chromatography to afford bridged C—B atropisomer 11a-c. See FIG. 20.

### Dimethyl 13-benzyl-7,11-dimethyl-5,6,8,10-tetrahydro-9H,13H-indeno[5′,6′:3,4][1,2]azaborinino[1,2-a]naphtho[1,8-de][1,3,2]diazaborinine-9,9-dicarboxylate (11a)

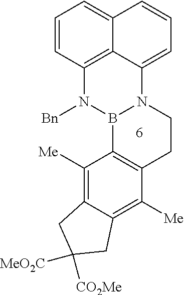 [SMILES: COC(=O)C1(C(=O)OC)Cc2c(C)c3c(c(C)c2C1)B1N(CC3)c2cccc3cccc(c23)N1Cc1ccccc1]

Following the above procedure, 11a is prepared from 4j (322.5 mg, 0.45 mmol, 94% ee). Purified by silica gel column chromatography (n-Hexane/EA=5/1), 11a is obtained as a white solid (159.8 mg, 65% yield). HPLC trace showed that 11a are configurationally unstable that could undergo racemization at room temperature.

### (R)-dimethyl 14-benzyl-8,12-dimethyl-6,7,9,11-tetrahydro-14H-indeno[5,6-c]naphtho[1′,8′:4,5,6][1,3,2]diazaborinino[1,2-a][1,2]azaborepine-10,10(5H)-dicarboxylate (11b)

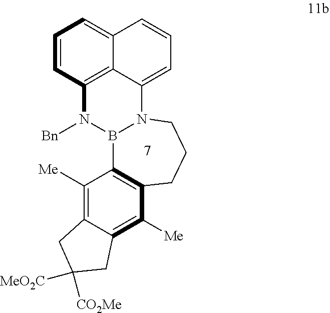

Following the above procedure, 11b is prepared from 4k (321.5 mg, 0.44 mmol, 94% ee). Purified by silica gel column chromatography (n-Hexane/EA=10/1-5/1), 11b is obtained as a white solid (133.3 mg, 54% yield).

### (R)-dimethyl 15-benzyl-9,13-dimethyl-5,6,7,8,10,12-hexahydro-11H,15H-indeno[5,6-c]naphtho[1′,8′: 4,5,6][1,3,2]diazaborinino[1,2-a][1,2]azaborocine-11,11-dicarboxylate (11c)

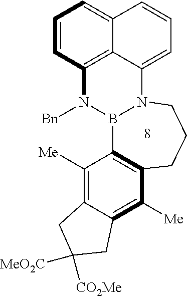

Following the above procedure, 11c is prepared from 4l (327.7 mg, 0.44 mmol, 93% ee). Purified by silica gel column chromatography (n-Hexane/EA=10/1-5/1), 11c is obtained as a white solid (140.2 mg, 56% yield).

### 4. Applications in New Synthesized Chiral Ligands in Asymmetric Catalysis

### 4.1 Applications in Pd-Catalyzed Asymmetric Allylic Alkylation

Procedure: An oven-dried 10 mL Schlenk tube equipped with a magnetic stir bar is charged with [Pd(allyl)Cl]₂ (0.9 mg, 2.5 mol %), chiral ligand (5 mol %) and KOAc (2.0 mg, 0.02 mmol). The tube is sealed with a rubber stopper, evacuated and filled with nitrogen gas three times. Then, dry DCM (1 mL), BSA (73 ┘L, 0.3 mmol), 10b (46 μL, 0.3 mmol) and 10a (24 μL, 0.1 mmol) is added by syringe successively. The reaction is stirred at room temperature for 48 hours. After that, the mixture is filtered through a short pad of silica gel and rinsed with EA. The filtrate is concentrated under reduced pressure. The residue is dissolved in CDCl₃ and CH₂Br₂ (7 ┘L, 0.1 mmol) is added as the internal standard. ¹H-NMR analysis gave the yield of 10c. The crude product is purified by preparative thin-layer chromatography to afford pure 10c. The ee value of 10c is determined by chiral HPLC. Conditions: IA-3, n-Hexane/IPA=92/8, 1.0 mL/min, 220 nm, tᵣ=7.922 min (major), 9.822 min (minor). The absolute configuration of major enantiomer is assigned as R configuration by comparison of HPLC trace reported in literature.

Table 1 below shows the yield and enantiomeric excess of the Pd-catalyzed asymmetric allylic alkylation aided by the novel chiral phosphine ligands in the present invention.

TABLE 1

| entry | ligand | yield (%)^{a} | ee (%)^{b} |
|---|---|---|---|
| 1 | 9d | 92 | 2 |
| 2 | 9e | 75 | 13 |
| 3 | 9f | 68 | 15 |
| 4 | 9g | 99 | 19 |
| 5 | 9h | 33 | 16 |
| 6 | 9i | 90 | 25 |
| 7 | 9j | 31 | 16 |
| 8 | 9k | 99 | 45 |
| 9 | 9l | 77 | 19 |
| 10 | 9m | 99 | 31 |
| 11 | 9n | 50 | 45 |
| 12 | 9o | 45 | 25 |
| 13 | 9p | 99 | 43 |
| 14 | 9q | 99 | 20 |
| 15 | 9r | 99 | −33 |
| 16 | 9s | 86 | 15 |
| 17 | 9t | 69 | 0 |
| 18 | 9u | 82 | 10 |
| 19 | 9v | 64 | 43 |
| 20 | 9w | 99 | 3 |
| 21 | 9x | 99 | 4 |

^{a}Yield was determined by ¹H-NMR using CH₂Br₂ as the internal standard
^{b}ee was determined by chiral HPLC

### 4.2 Applications in Pd-Catalyzed Asymmetric Suzuki Coupling

Procedure: An oven-dried 10 mL Schlenk tube equipped with a magnetic stir bar is charged with Pd₂(dba)₃ (2.3 mg, 2.5 mol %), chiral ligand (6 mol %), K₂CO₃ (41.5 mg, 0.3 mmol), 10d (23.7 mg, 0.1 mmol), 10e (34.4 mg, 0.2 mmol). The tube is sealed with a rubber stopper, evacuated and filled with nitrogen gas three times. Then, toluene (1 mL) and H₂O (0.2 mL) are added by syringe successively. The reaction is stirred at 60° C. for 24 hours. After that, the reaction is cooled down to room temperature and brine (5 mL) and EA (5 mL) is added. The layers are separated and the aqueous phase is extracted with EA three times (3×5 mL). The combined organic phase is washed with brine once, dried over Na₂SO₄, filtered, and concentrated under reduced pressure. The residue is dissolved in CDCl₃ and CH₂Br₂ (7 _L, 0.1 mmol) is added as the internal standard. ¹H-NMR analysis gave the yield of 10f. The crude product is purified by preparative thin-layer chromatography to afford pure 10f. The ee value of 10f is determined by chiral HPLC. Conditions: IA-3, n-Hexane/IPA=99/1, 1.0 mL/min, 220 nm, tᵣ=4.903 min (minor), 5.837 min (major). The absolute configuration of major enantiomer is assigned as S configuration by comparison of HPLC trace reported in literature.

Table 2 below shows the yield and enantiomeric excess of the Pd-catalyzed asymmetric Suzuki coupling aided by the novel chiral phosphine ligands in the present invention.

TABLE 2

| entry | ligand | base | T (° C.) | yield (%)^{a} | ee (%)^{b} |
|---|---|---|---|---|---|
| 1 | 9d | K₃PO₄ | 80 | 65 | 0 |
| 2 | 9e | K₃PO₄ | 80 | trace | — |
| 3 | 9k | K₃PO₄ | 80 | 70 | 0 |
| 4 | 9l | K₃PO₄ | 80 | trace | — |
| 5 | 9r | K₃PO₄ | 80 | 80 | 15 |
| 6 | 9s | K₃PO₄ | 80 | trace | — |
| 7 | 9r | K₃PO₄ | 60 | 82 | 19 |
| 8 | 9r | K₃PO₄ | 40 | trace | — |
| 9 | 9r | K₂CO₃ | 60 | 99 | 18 |
| 10 | 9g | K₂CO₃ | 60 | 60 | 13 |
| 11 | 9i | K₂CO₃ | 60 | 84 | 16 |
| 12 | 9n | K₂CO₃ | 60 | 44 | 5 |
| 13 | 9p | K₂CO₃ | 60 | 63 | 10 |
| 14 | 9q | K₂CO₃ | 60 | 83 | 0 |

^{a}Yield was determined by ¹H-NMR using CH₂Br₂ as the internal standard
^{b}ee was determined by chiral HPLC

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

1. A compound represented by the following formula: 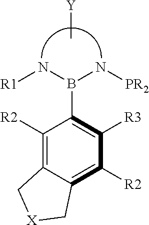
wherein R is selected from phenyl or cyclohexyl;
wherein X is selected from N-tosyl, 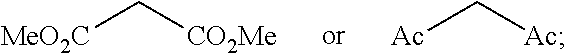
wherein R1 is selected from substituted or unsubstituted (C₁₋₄)alkyl, benzyl, 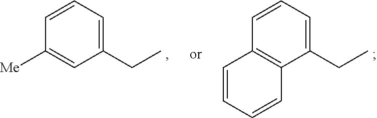
wherein R2 is selected from methyl or ethyl;
wherein R3 is selected from substituted or unsubstituted (C₁₋₅)alkyl, substituted or unsubstituted (C₁₋₅)alkenyl, phenyl, or cyclopropane; and
wherein Y is selected from

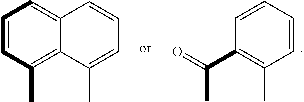

2. The compounds of claim 1, represented by the following formula: 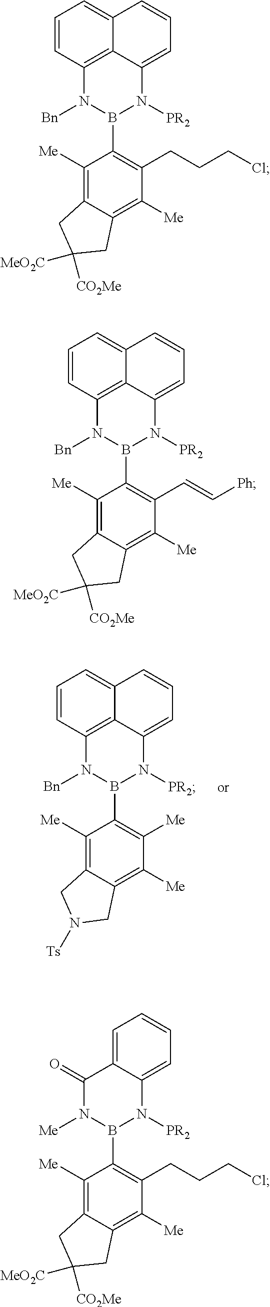
wherein R is selected from phenyl or cyclohexyl.

3. A method of preparing the compounds of claim 1, comprising:
preparing an axially chiral organoboron compound represented by the following formula: 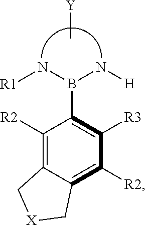
wherein R1 is selected from substituted or unsubstituted (C₁₋₄)alkyl, benzyl, 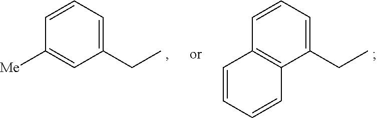
R2 is selected from methyl or ethyl; R3 is selected from substituted or unsubstituted (C₁₋₅)alkyl, substituted or unsubstituted (C₁₋₅)alkenyl, phenyl, or cyclopropane; and Y is selected from 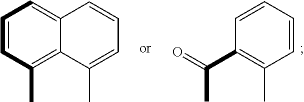
reacting the axially chiral organoboron compound with lithium bis(trimethylsilyl)amide (LiHDMS) in the presence of tetrahydrofuran for 8-12 minutes under room temperature to obtain an intermediate;
reacting the intermediate ide with a formula of Cl-PR₂ for 1 hour under room temperature, wherein R is selected from phenyl or cyclohexyl.

4. The method of claim 3, wherein the method has a yield of at least 70%.

5. The method of claim 3, wherein the enantiomeric excess of the compounds of claim 1 obtained is at least 90%.

6. In a method for synthesizing axially chiral aromatic organoboron compounds, the improvement comprising reacting a boron-containing organic precursor material and a branched linear organic precursor material in the presence of a rhodium catalyst and a chiral ligand.

7. The improvement of claim 6, wherein the reacting the boron-containing organic precursor material and a branched linear organic precursor material in the presence of a rhodium catalyst and a chiral ligand is conducted in an organic solvent at 55° C. to 65° C. for approximately 20 hours.

8. The improvement of claim 6, wherein the branched linear organic precursor material is a diyne represented by the following formula: 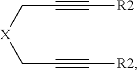
wherein R2 is selected from methyl or ethyl.

9. The improvement of claim 6, wherein the linear boron-containing organic precursor material is an alkynylboron compound represented by the following formula: 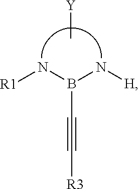
wherein R1 is selected from substituted or unsubstituted (C₁₋₄)alkyl, benzyl, 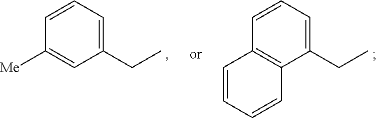
wherein R3 is selected from substituted or unsubstituted (C₁₋₅)alkyl, substituted or unsubstituted (C₁₋₅)alkenyl, phenyl, or cyclopropane; and
wherein Y is selected from

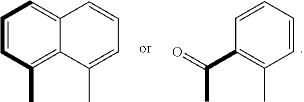

10. The improvement of claim 6, wherein the improved method has a yield of at least 50%.

11. The improvement of claim 6, wherein the enantiomeric excess of the axially chiral aromatic organoboron compounds is at least 85%.
